(19) United States
(12) Patent Application Publication
(10) Pub. No.: US 2025/0239613 A1
(43) Pub. Date: Jul. 24, 2025

(54) BINDER MATERIAL AND METHODS THEREOF

(71) Applicant: Sila Nanotechnologies, Inc., Alameda, CA (US)

(72) Inventors: Atsushi KUME, Tokyo (JP); Wataru YAMAGUCHI, Tokyo (JP); Kunio SHIMIZU, Tokyo (JP); Toshihiko NIJYUKEN, Tokyo (JP); Mayu SHIRAI, Tokyo (JP); Samik JHULKI, Emeryville, CA (US); Gleb Nikolayevich YUSHIN, Atlanta, GA (US)

(21) Appl. No.: 19/030,048

(22) Filed: Jan. 17, 2025

Related U.S. Application Data
(60) Provisional application No. 63/622,434, filed on Jan. 18, 2024.

(51) Int. Cl. H01M 4/62; C08F 212/08; C08F 220/18; C09D 5/24; C09D 7/40; C09D 7/61; C09D 7/65; C09D 125/14; C09D 133/06; H01M 4/02; H01M 4/133; H01M 4/587; H01M 10/0525

(52) U.S. Cl. CPC H01M 4/622; C08F 212/08; C08F 220/1802; C09D 5/24; C09D 7/61; C09D 7/65; C09D 7/70; C09D 125/14; C09D 133/062; H01M 4/133; H01M 4/587; H01M 4/625; H01M 10/0525; C08F 2800/20; H01M 2004/027

(57) ABSTRACT

Disclosed herein is a binder material including (1) a copolymer of styrene and (meth)acrylate and (2) one or more surfactants. In some aspects, a supernatant is obtained from a sample of an emulsion of the binder material, and a supernatant extract is obtained by filtering and drying the supernatant. Estimated masses of CH₂CH₂O— (PEG) units and C₆H₅-(aromatic) units in the supernatant extract are quantified by proton nuclear magnetic resonance (¹H NMR) measurements. In some embodiments, a mass ratio of the CH₂CH₂O— (PEG) units to the C₆H₅— (aromatic) units is about 6.0 or less and about 0.1 or greater. Also disclosed are battery electrodes and lithium-ion batteries that employ such binder materials. Related methods of making binder materials, battery electrodes, and lithium-ion batteries are also disclosed.

### CROSS-REFERENCE TO RELATED APPLICATIONS

The present Application for Patent claims the benefit of U.S. Provisional Application No. 63/622,434, entitled “BINDER MATERIAL FOR HIGH-SILICON CONTENT ANODES IN LITHIUM-ION BATTERIES,” filed Jan. 18, 2024, assigned to the assignee hereof, and expressly incorporated herein by reference in its entirety.

### BACKGROUND

### Field

Aspects of the present disclosure relate generally to energy storage devices and, more particularly, to battery technology and the like.

### Background

Owing in part to their relatively high energy densities, relatively high specific energy, light weight, and potential for long lifetimes, advanced rechargeable batteries are desirable for a wide range of consumer electronics, electric vehicles, grid storage and other important applications. However, despite the increasing commercial prevalence of batteries, further development of these batteries is needed, particularly for applications in low- or zero-emission, hybrid-electric or fully electric vehicles, consumer electronics, wearable devices, energy-efficient cargo ships and locomotives, drones, aerospace applications, and power grids. Further improvements are desired for various rechargeable batteries, such as rechargeable Li and Li-ion batteries, Na and Na-ion batteries, K and K-ion batteries, and dual ion batteries, to name a few.

In certain types of rechargeable batteries, at least some of the charge-storing active materials in either the anode or the cathode or both may be produced as high-capacity nanocomposite powders, which exhibit moderately high volume changes (e.g., about 8-180 vol. %) during the first charge-discharge cycle and moderate volume changes (e.g., about 4-50 vol. %) during the subsequent charge-discharge cycles. A subset of such charge-storing particles includes particles with an average size (e.g., diameter or thickness) in the range of about 0.2 to about 40 microns (micrometers, or μm), as measured using laser particle size distribution analysis (LPSA), laser image analysis, electron microscopy, optical microscopy, or other suitable techniques.

In certain types of Li metal and Li-ion rechargeable batteries, charge-storing anodes may comprise silicon (Si)-comprising anode particles with gravimetric capacities in the range from about 800 mAh/g to about 3000 mAh/g (per mass of Si-comprising anode particles in a Li-free state). A subset of such Si-comprising anode particles includes anode particles that are Si-comprising and C-comprising nanocomposite particles (referred to herein as Si—C composite or Si—C nanocomposite particles, even if such particles comprise elements other than Si and C in relatively small quantities of less than about 10-25 at. %). Such a class of charge-storing particles offers great promises for scalable manufacturing and achieving high cell-level energy density and other performance characteristics. A subset of such anodes includes anodes with the electrode layer exhibiting capacity in the range from about 400 mAh/g to about 2800 mAh/g (per mass of the electrode layer, not counting the mass of the current collector, in a Li-free state). Such a class of charge-storing anodes offers great potential for increasing the gravimetric and volumetric energy of rechargeable batteries.

Conventional batteries, such as conventional Li-ion batteries, comprise anodes and cathodes that are produced from solvent-comprising slurries coated on metal current collectors, which are then dried and calendared (densified). Herein, the term “solvent,” in the context of a slurry used to form battery electrodes, is used to refer to a liquid substance in which solid components of the slurry (e.g., electrochemically active particles, conductive additive particles, etc.) are dispersed (e.g., suspended). After the slurry is coated on a substrate (e.g., current collector), most or substantially all of the solvents are removed in a drying process. Unfortunately, such conventional battery electrodes typically suffer from poor mechanical properties or slow ion transport or both, particularly when produced at relatively high areal capacity loadings (e.g., above around 4 mAh/cm², more so above around 6 mAh/cm² and even more so above around 8 mAh/cm²). Recently, Li-ion batteries that achieve such relatively high areal capacity loadings on the anode have been realized by incorporating Si—C nanocomposite particles. Although a variety of commercially available binders may be employed in making anode electrodes such as anodes incorporating Si—C nanocomposite particles, further improvements in binder materials are desired for improving electrode or battery performance (e.g., lower resistance, higher volumetric capacity, higher resistance stability during cycling, higher charge and/or discharge rate capability, longer cycle life, etc.)

Accordingly, there remains a need for improved binders and other related materials and manufacturing processes.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a binder material includes a copolymer of styrene and (meth)acrylate; and one or more surfactants, wherein: a mass ratio of CH₂CH₂O— (PEG) units in a supernatant extract to C₆H₅— (aromatic) units in the supernatant extract is about 6.0 or less and about 0.1 or greater; the supernatant extract is obtained by filtering and drying a supernatant; the supernatant is obtained from a sample of an emulsion of the binder material by (a) adding sufficient ethanol to the sample to induce precipitation of at least a portion of the sample and (b) centrifugation of the sample after the precipitation; and the mass ratio is calculated from (1) an estimated mass of the PEG units in the supernatant extract as quantified by proton nuclear magnetic resonance (¹H NMR) measurements and (2) an estimated mass of the aromatic units in the supernatant extract as quantified by the 1H NMR measurements.

In an aspect, a method of making a binder material includes emulsion polymerizing a reactive composition in the presence of a surfactant composition to form the binder material, wherein the reactive composition comprises: (a) styrene; a monofunctional (meth)acrylate with an average molecular weight of at most about 200, comprising no silicon, no epoxide group, no hydroxyl group, and no isocyanate group; and a macromolecule, comprising oxyethylene groups, and comprising one or more (meth)acrylate groups; wherein: the styrene and the monofunctional (meth)acrylate together are present in the reactive composition in a range of about 74 to about 98.9 wt. %; the styrene is present in the reactive composition in a range of about 33 to about 75 wt. %; an average molecular weight of the macromolecule is in a range of about 400 to about 1250; an average number of the oxyethylene groups in the macromolecule is in a range of about 6 to about 24; and the macromolecule is present in the reactive composition in a range of about 1.1 to about 2.0 wt. %.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw a contrast between different components, elements, features, etc., and are not meant to convey the use of particular materials, colors, or other properties that may be defined outside of the present disclosure for the specific pattern employed.

FIG. 1 illustrates an exemplary Li-ion battery in which the components, materials, processes, and other techniques described herein may be implemented.

FIG. 2 illustrates exemplary method steps of making a binder composition according to one aspect.

FIG. 3 illustrates exemplary method steps of making batteries in one aspect.

FIGS. 4A, 4B, 4C, and 4D illustrate exemplary compounds used in a reactive composition in the emulsion polymerization of a binder in some aspects.

FIGS. 5 and 6 illustrate chemical units that can be present in exemplary nonreactive surfactants in some aspects.

FIG. 7 illustrates additional surfactants used to form an exemplary binder composition in some aspects.

FIGS. 8A and 8B (Table 1) illustrate exemplary compositions (reactive compositions, surfactant compositions) employed in emulsion polymerization processes according to some aspects of the disclosure.

FIG. 9 shows a graphical plot illustrating a typical relationship between stress and strain (stress-strain curve) in a ductile material (e.g., steel).

FIGS. 10A and 10B (Table 2) illustrate certain selected properties (e.g., binder emulsion properties, binder film properties, electrode slurry properties, electrode properties, and battery electrochemical testing performance properties) of exemplary binders in some aspects.

FIG. 11 illustrates the Young's modulus (elastic modulus) values of several exemplary binders after soaking in an electrolyte.

FIG. 12 (Table 3) illustrates selected battery performance parameters and observations about the processability of the anode slurry and coating, for battery test cells in which the respective cell's anode comprises (1) a polyacrylic acid (PAA)-based binder, (2) an SBR binder in combination with carboxymethyl cellulose (CMC), or (3) exemplary binders prepared according to some aspects of the disclosure, in combination with CMC. In the test cells reported in Table 3, Si—C nanocomposite particles were the sole active material in the anode coating.

FIG. 13 illustrates a relationship between the DC resistance (DCR) of battery test cells comprising (1) an SBR binder in combination with CMC, (2) a PAA-based binder, and (3) exemplary binders prepared according to the aspects of the disclosure (in combination with CMC), and the state-of-charge (SOC) of the respective test cell. In the test cells reported in FIG. 13, Si—C nanocomposite particles were the sole active material in the anode coating.

FIG. 14 illustrates a relationship between DC resistance (DCR) and a number of charge/discharge cycles of battery test cells (1) an SBR binder in combination with CMC, (2) a PAA-based binder, and (3) exemplary binders prepared according to the aspects of the disclosure (in combination with CMC). In the test cells reported in FIG. 14, Si—C nanocomposite particles were the sole active material in the anode coating.

FIG. 15 is a graphical plot of the DC resistance (DCR) of battery test cells, measured at the fourth cycle, comprising: (1) a styrene-butadiene rubber (SBR) binder in combination with carboxymethyl cellulose (CMC) or (2) one of the binders prepared according to the aspects of the disclosure (NT476-1-37) in combination with CMC, at respective CMC:binder mass ratios. In the test cells reported in FIG. 15, a mixture of Si—C nanocomposite particles and graphite particles (the mixture contained about 50 wt. % of Si—C nanocomposite particles and about 50 wt. % of graphite particles) was the active material in the anode coating.

FIG. 16 (Table 4) illustrates selected battery performance parameters and observations about the processability of the anode slurry and coating, for battery test cells in which the respective cell's anode comprises (1) an SBR binder in combination with CMC, (2) a PAA-based binder, or (3) exemplary binders prepared according to some aspects of the disclosure, in combination with CMC. In the test cells reported in Table 4, a mixture of Si—C nanocomposite particles and graphite particles (the mixture contained about 50 wt. % of Si—C nanocomposite particles and about 50 wt. % of graphite particles) was the active material in the anode coating.

FIG. 17 illustrates the relative discharge capacity of battery test cells as a function of normalized discharge C-rate, for battery test cells in which the respective cell's anode comprises exemplary binders prepared according to some aspects of the disclosure. In the test cells reported in FIG. 17, a mixture of Si—C nanocomposite particles and graphite particles (the mixture contained about 50 wt. % of Si—C nanocomposite particles and about 50 wt. % of graphite particles) was the active material in the anode coating.

FIG. 18 shows a graphical plot of a dependence of a shear viscosity on shear rate for anode slurries prepared with (1) a styrene-butadiene rubber (SBR) binder in combination with carboxymethyl cellulose (CMC) and (2) binders prepared according to the aspects of the disclosure in combination with CMC.

FIGS. 19 and 20 illustrate scanning electron microscope (SEM) images of anode coatings comprising (1) a styrene-butadiene rubber (SBR) binder in combination with carboxymethyl cellulose (CMC) and (2) a binder prepared according to the aspects of the disclosure in combination with CMC, respectively.

FIGS. 21 and 22 are graphical plots of Fourier Transform Infrared (FTIR) spectra obtained from films of binders prepared according to the aspects of the disclosure, measured in attenuated total reflectance.

FIGS. 23A and 23B (Table 5) illustrate exemplary compositions (reactive compositions, surfactant compositions) employed in emulsion polymerization processes according to some aspects of the disclosure. In addition, Table 5 lists (1) selected binder emulsion properties of the respective binder materials, (2) selected binder film properties of the respective binder materials, (3) certain characterization results obtained by carrying out proton nuclear magnetic resonance (¹H NMR) measurements on supernatant extracts derived from the respective binder materials, (4) viscosity data of slurries comprising the respective binder materials, and (5) assessments of the quality of coatings obtained using the respective binder materials.

FIG. 24A shows images of anode coatings comprising respective binder materials, illustrating an “excellent” anode coating and a “poor” anode coating.

FIG. 24B shows photographs of electrode slurries of selected binders.

FIG. 25 shows the DC resistance (DCR) of battery test cells comprising (1) a PAA-based binder, and (2) a mixture of a PAA-based binder and an example nonreactive nonionic surfactant NEWCOL® 740. In the test cells reported in FIG. 25, Si—C nanocomposite particles were the sole active material in the anode coating.

### DETAILED DESCRIPTION

The present invention can be understood more readily by reference to the following detailed description, examples, drawings, and claims, and their previous and following description. However, before the present compositions, articles, systems, and/or methods are disclosed and described, it is to be understood that this invention is not limited to the specific or exemplary aspects of compositions, articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

Aspects of the present invention are disclosed in the following description and related drawings directed to specific embodiments of the invention. The term “embodiments of the invention” does not require that all embodiments of the invention include the discussed feature, advantage, process, or mode of operation, and alternate embodiments may be devised without departing from the scope of the invention. Additionally, well-known elements of the invention may not be described in detail or may be omitted so as not to obscure other, more relevant details.

### Definitions

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a monomer” includes two or more monomers, reference to “a battery” includes two or more such batteries and the like.

Any numerical range described herein with respect to any embodiment of the present invention is intended not only to define the upper and lower bounds of the associated numerical range but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about—120° C. to about—60° C. encompasses (in ° C.) a set of temperature ranges from about—120° C. to about—119° C., from about—119° C. to about—118° C., . . . from about—61° C. to about −60° C., as if the intervening numbers (in ° C.) between—120° C. and—60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about,” “approximately,” “around,” “≈” or “˜” 80%, which encompasses “exactly” 80% (e.g., 80.0000 . . . %) plus some range around 80%. In some designs, the range encompassed around a measurement or threshold via the “about,” “approximately,” “around,” or “˜” qualifier may encompass the level of precision for which the respective measurement or threshold is capable of being measured by the most accurate commercially available instrumentation as of the priority date of the subject application.

“Z¹,” “Z²,” “Z³,” and “Z⁴” are used herein as generic symbols to represent various specific substituents. In certain aspects, the generic symbols to represent various specific substituents can be marked as “R¹,” “R²,” “R³,” or “Rⁿ,” wherein n is a subsequent number of substituents. These symbols can be any substituent, not limited to those disclosed herein, and when they are defined to be certain substituents in one instance, they can, in another instance, be defined as some other substituents.

The expressions “ambient temperature” and “room temperature” as used herein are understood in the art and refer generally to a temperature, e.g., a reaction temperature, that is about the temperature of the room in which the reaction is carried out, for example, a temperature from about 20° C. to about 30° C.

A dash (“—”) that is not between two letters or symbols is used to indicate a point of attachment for a substituent. For example, —(C═O)NH₂ is attached through carbon of the keto (C═O) group.

The term “alkyl” is generally used to refer to both unsubstituted alkyl groups and substituted alkyl groups; however, substituted alkyl groups are also specifically referred to herein by identifying the specific substituent(s) on the alkyl group. An alkyl group may be straight chain or branched. The term “alkyl” can also be referred to as a linking group of saturated hydrocarbons that are divalent radicals. In other words, in a broader description, the term “alkyls” also encompasses alkylenes. It is further understood that the term “alkyl” covers saturated hydrocarbons that are multivalent radicals.

The term “carboxylic acid,” as used herein, is represented by the formula —C(O)OH. A “carboxylate” or “carboxyl” group, as used herein, is represented by the formula —C(O)O—.

The term “ester” as used herein is represented by the formula —OC(O)R¹ or —C(O)OR¹, where R¹ can be an alkyl, halogenated alkyl, alkenyl, alkynyl, aryl, heteroaryl, cycloalkyl, cycloalkenyl, heterocycloalkyl, or heterocycloalkenyl group.

The term “ether” as used herein is represented by the formula R¹OR², where R¹ and R² can be, independently, an alkyl, halogenated alkyl, alkenyl, alkynyl, aryl, heteroaryl, cycloalkyl, cycloalkenyl, heterocycloalkyl, or heterocycloalkenyl group.

The term “epoxy” or “epoxide” as used herein refers to a cyclic ether with a three-atom ring and can be represented by the formula:

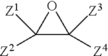

where Z¹, Z², Z³, and Z can be, independently, H, an alkyl, alkenyl, alkynyl, aryl, heteroaryl, cycloalkyl, cycloalkenyl, heterocycloalkyl, or heterocycloalkenyl group.

The term “ketone” as used herein is represented by the formula R¹C(O)R², where R¹ and R² can be, independently, an alkyl, halogenated alkyl, alkenyl, alkynyl, aryl, heteroaryl, cycloalkyl, cycloalkenyl, heterocycloalkyl, or heterocycloalkenyl group.

The term “halide,” or “halogen,” or “halo,” as used herein, refers to fluorine, chlorine, bromine, and iodine.

The term “hydroxyl,” as used herein, is represented by the formula —OH.

The term “silyl” as used herein is represented by the formula —SiZ¹Z²Z³, where Z¹, Z², and Z³ can be, independently, hydrogen, alkyl, alkoxy, alkenyl, alkynyl, aryl, heteroaryl, cycloalkyl, cycloalkenyl, heterocycloalkyl, or heterocycloalkenyl group.

As used herein, the term “carboxy” refers to a group of formula —C(O)OH.

The term “olefinically unsaturated group” or “ethylenically unsaturated group” is employed herein in a broad sense and is intended to encompass any groups containing a carbon-carbon double-bonded group (>C═C<group). Exemplary ethylenically unsaturated groups include, but are not limited to, (meth)acrylate, (meth)acrylamide, (meth)acryloyl, allyl, vinyl, styrenyl, or other >C═C<containing groups.

“Polymer” means a material formed by polymerizing one or more monomers and/or one or more oligomers.

The term “(co)polymer” includes homopolymers, copolymers, or mixtures thereof.

The term “(meth)acryl . . . ” includes “acryl . . . ,” “methacryl . . . ,” or mixtures thereof.

“Molecular weight” of a polymeric material (including monomeric or macro-monomeric materials), as used herein, refers to the number-average molecular weight as measured by ¹H NMR spectroscopy unless otherwise specifically noted or unless testing conditions indicate otherwise.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is less than about 1% by weight, e.g., less than about 0.5% by weight, less than about 0.1% by weight, less than about 0.05% by weight, or less than about 0.01% by weight of the stated material, based on the total weight of the composition.

In the following description, various material properties are described so as to characterize materials (e.g., binders, molecules, particles, powders, slurries, electrodes, separators, electrolytes, battery cells, etc.) in various states. Note that one of ordinary skill in the art is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types, such as precursor particles (e.g., carbon particles, etc.). Hence, unless otherwise indicated, the following Table provides examples of how such material properties may be readily measured by one of ordinary skill in the art using commercially available instrumentation:

Table of Techniques and Instrumentation for Material
Property Measurements

| Material | Property | Measurement | |
|---|---|---|---|
| Type | Type | Instrumentation | Measurement Technique |
| Active | Coulombic | Potentiostat | Charge (current) is passed |
| Material | Efficiency | | to an electrode containing |
| | | | the active material of |
| | | | interest until a given |
| | | | voltage limit is reached. |
| | | | Then, the current is |
| | | | reversed (discharge |
| | | | current) until a second |
| | | | voltage limit is reached. |
| | | | The ratio of the two |
| | | | charges passed |
| | | | determines the Coulombic |
| | | | Efficiency (CE). In the |
| | | | simplest case, the charge |
| | | | and discharge currents |
| | | | may be constant and often |
| | | | have absolute values that |
| | | | are the same or close to |
| | | | each other. It should be |
| | | | understood though that in |
| | | | some experiments, either |
| | | | charge current or |
| | | | discharge current or both |
| | | | may be changing during |
| | | | such experiments (e.g., be |
| | | | initially constant and |
| | | | when the voltage limit is |
| | | | reached, diminishing to a |
| | | | predetermined value). In |
| | | | addition, the absolute |
| | | | value of the charge and |
| | | | discharge currents may |
| | | | differ. |
| Active | Partial | Manometer | The partial vapor pressure |
| Material | Vapor | | of an active material in a |
| | Pressure | | mixture (e.g., composite |
| | (e.g., Torr.) | | particle) at a particular |
| | at a | | temperature is given by |
| | Temperature | | the known vapor pressure |
| | (e.g., K) | | of the active material |
| | | | multiplied by its mole |
| | | | fraction in the mixture. |
| Active | Volume | Gas pycnometer | Gas pycnometer measures |
| Material | | | the skeletal volume of a |
| Particle | | | material by gas |
| | | | displacement using the |
| | | | volume-pressure |
| | | | relationship of Boyle's |
| | | | Law. A sample of known |
| | | | mass is placed into the |
| | | | sample chamber and |
| | | | maintained at a constant |
| | | | temperature. An inert gas, |
| | | | typically helium, is used as |
| | | | the displacement medium. |
| | | | Note: A vol. % change may |
| | | | be calculated from two |
| | | | volume measurements of |
| | | | the active material |
| | | | particle. |
| Active | Open | nitrogen | Nitrogen |
| Material | Internal | sorption/ | sorption/desorption |
| Particle | Pore | desorption | isotherm (typically at 77K) |
| | Volume | isotherm | is collected and analyzed |
| | (e.g., cc/g or | | to estimate the total |
| | cm³/g) | | amount of gas |
| | | | adsorbed/desorbed and |
| | | | internal pore volume of |
| | | | the sample with known |
| | | | mass is estimated from |
| | | | such measurements. Pore |
| | | | size distribution (PSD) |
| | | | may be further estimated |
| | | | from the |
| | | | sorption/desorption |
| | | | isotherm using various |
| | | | analyses, such as Non- |
| | | | Local Density Functional |
| | | | Theory (NLDFT) |
| Active | Volume- | PSA, scanning | PSA using laser scattering, |
| Material | Average | electron | electron microscopy (SEM, |
| Particle | Pore Size | microscope | TEM, STEM) in |
| | and Pore | (SEM), | combination with image |
| | Size | transmission | analyses, laser microscopy |
| | Distributions | electron | (for larger particles and |
| | (e.g., nm) | microscope | larger pores) in |
| | | (TEM), | combination with image |
| | | scanning | analyses, optical |
| | | transmission | microscopy (for larger |
| | | microscope | particles and larger |
| | | (STEM), laser | pores), neutron scattering, |
| | | microscope, | X-ray scattering, X-ray |
| | | Synchrotron | microscopy imaging may |
| | | X-ray, | be employed to measure |
| | | X-ray | pore sizes (average pore |
| | | microscope | size or pore size |
| | | | distribution) in different |
| | | | size ranges (in addition to |
| | | | the analysis of the |
| | | | sorption/desorption |
| | | | isotherms). |
| Active | Closed | Gas pycnometer | Closed porosity may be |
| Material | Internal | | measured by analyzing |
| Particle | Pore | | true density values |
| | Volume | | measured by using an |
| | (e.g., cc/g or | | argon gas pycnometer and |
| | cm³/g) | | comparing them to the |
| | | | theoretical density of the |
| | | | individual material |
| | | | components present in Si- |
| | | | comprising particles. In |
| | | | addition, closed internal |
| | | | pore volume may be |
| | | | estimated by comparing |
| | | | the total pore volume |
| | | | estimated from neutron |
| | | | scattering and the |
| | | | nitrogen-accessible pore |
| | | | volume estimated from |
| | | | nitrogen sorption |
| | | | isotherms. |
| Active | Closed | Gas pycnometer | With a pycnometer, the |
| Material | Internal | | amount of a certain |
| Particle | Volume- | | medium (liquid or Helium |
| | Average Size | | or other analytical gases) |
| | (e.g., nm) | | displaced by a solid can be |
| | | | determined. |
| Active | Size | TEM, STEM, | Laser particle size |
| Material | (e.g., nm, | SEM, X- | distribution analysis |
| Particle | μm, etc.) | Ray, PSA, etc. | (LPSA), laser image |
| | | | analysis, electron |
| | | | microscopy, optical |
| | | | microscopy or other |
| | | | suitable techniques |
| | | | transmission electron |
| | | | microscopy (TEM), |
| | | | scanning transmission |
| | | | electron microscopy |
| | | | (STEM), scanning electron |
| | | | microscopy (SEM)), X-ray |
| | | | microscopy, X-ray |
| | | | diffraction, neutron |
| | | | scattering and other |
| | | | suitable techniques |
| Active | Composition | Balance | Note #1: A wt. % change |
| Material | (e.g., mass | | may be calculated by |
| Particle | fraction or | | comparing the mass |
| | wt. %, mg, | | fraction of a material in |
| | number of | | the particle relative to the |
| | atoms, etc.) | | total particle mass. |
| | | | Note #2: The capacity |
| | | | attributable to particular |
| | | | active material(s) in the |
| | | | particle may be derived |
| | | | from the composition, |
| | | | based on the known (e.g., |
| | | | theoretical or practically |
| | | | attainable) capacity(ies) of |
| | | | each active material. |
| | | | Note #3: The composition |
| | | | of the particle may be |
| | | | characterized in terms of |
| | | | weight (e.g., mg). The |
| | | | composition of may |
| | | | alternatively be |
| | | | characterized by a number |
| | | | of atoms of a particular |
| | | | element (e.g., Si, C, etc.). In |
| | | | case of atoms, the number |
| | | | of atoms may be estimated |
| | | | from the weight of that |
| | | | atom in the particle (e.g., |
| | | | based on gas |
| | | | chromatography) |
| Active | Composition | X-ray | |
| Material | (e.g., mass | Fluorescence | |
| Particle | fraction or | (XRF), | |
| | wt. % of | Inductively | |
| | various | Coupled Plasma | |
| | atomic | Optical Emission | |
| | elements or | Spectroscopy | |
| | molecules, | (ICP- | |
| | atomic | OES); Energy | |
| | fraction or | Dispersive | |
| | at. % of | Spectroscopy | |
| | various | (EDS), | |
| | elements, | Wavelength | |
| | etc.) | Dispersive | |
| | | Spectroscopy | |
| | | (WDS), Electron | |
| | | Energy Loss | |
| | | Spectroscopy | |
| | | (EELS), Nuclear | |
| | | Magnetic | |
| | | Resonance | |
| | | (NMR); | |
| | | Secondary Ion | |
| | | Mass | |
| | | Spectrometry | |
| | | (SIMS); X-Ray | |
| | | Photoelectron | |
| | | Spectroscopy | |
| | | (XPS); Fourier | |
| | | Transform | |
| | | Infrared | |
| | | Spectroscopy | |
| | | (FTIR) and | |
| | | Raman | |
| | | Spectroscopy | |
| | | (Raman) | |
| Active | Specific | Potentiostat | An electrode containing an |
| Material | Capacity | | active anode or cathode |
| Particle, | | | material of interest is |
| Battery | | | charged or discharged (by |
| Half-Cell | | | passing electrical current |
| | | | to the electrode) within |
| | | | certain potential limits |
| | | | using an electrochemical |
| | | | cell with a suitable |
| | | | reference electrode, |
| | | | typically lithium metal. |
| | | | The total charge passed |
| | | | (e.g., in mAh) divided by |
| | | | the active material mass |
| | | | (e.g., in g) gives this |
| | | | quantity (e.g., in mAh/g). |
| | | | The active mass is |
| | | | computed by multiplying |
| | | | the total mass of the |
| | | | electrode by the active |
| | | | material mass fraction. |
| | | | Both reversible and |
| | | | irreversible capacity |
| | | | during charge or discharge |
| | | | may be calculated in this |
| | | | way. |
| Active | BET SSA | BET instrument | A sample is placed into a |
| Material | (e.g., m²/g) | | sealed chamber at 77K, |
| Particle | | | where nitrogen is |
| | | | introduced at increasing |
| | | | pressure. The change in |
| | | | pressure of the nitrogen is |
| | | | used to calculate the |
| | | | surface area of the sample. |
| Active | Aspect Ratio | SEM, TEM | The dimensions and shape |
| Material | | | of the particles are |
| Particle | | | typically measured by |
| | | | using SEM or TEM or (for |
| | | | large particles) by using |
| | | | optical microscopy. |
| Active | True | Argon Gas | True density values may |
| Material | Density of | Pycnometer | be measured by using an |
| Particle | Particle | | argon gas pycnometer and |
| | (e.g., g/cc or | | comparing to the |
| | g/cm³) | | theoretical density of the |
| | | | individual material |
| | | | components present in the |
| | | | particle. |
| Active | Particle Size | Dynamic light | laser particle size |
| Material | Distribution | scattering | distribution analysis |
| Particle | (e.g., nm or | particle | (LPSA) on well-dispersed |
| Pop- | μm) | size analyzer, | particle suspensions in |
| ulation | | scanning | one example or by image |
| | | electron | analysis of electron |
| | | microscope | microscopy images, or by |
| | | | other suitable techniques. |
| | | | While there are diverse |
| | | | processes of measuring |
| | | | PSDs, laser particle size |
| | | | distribution analysis |
| | | | (LPSA) is quite efficient for |
| | | | some applications. Note |
| | | | that other types of particle |
| | | | size distribution (e.g., by |
| | | | SEM image analysis) could |
| | | | also be utilized (and may |
| | | | even lead to more precise |
| | | | measurements, in some |
| | | | experiments). Using LPSA, |
| | | | particle size parameters of |
| | | | a population's PSD may be |
| | | | measured, such as: a tenth- |
| | | | percentile volume- |
| | | | weighted particle size |
| | | | parameter (e.g., |
| | | | abbreviated as D₁₀), a |
| | | | fiftieth-percentile volume- |
| | | | weighted particle size |
| | | | parameter (e.g., |
| | | | abbreviated as D₅₀), a |
| | | | ninetieth-percentile |
| | | | volume-weighted particle |
| | | | size parameter (e.g., |
| | | | abbreviated as D₉₀), and a |
| | | | ninety-ninth-percentile |
| | | | volume-weighted particle |
| | | | size parameter (e.g., |
| | | | abbreviated as D₉₉). |
| Active | Width (e.g., | PSA | Parameters relating to |
| Material | nm) | | characteristic widths of |
| | | | the PSD may be derived |
| Particle | | | from these particle size |
| Pop- | | | parameters, such as D₅₀- |
| ulation | | | D₁₀ (sometimes referred to |
| | | | herein as a left width), D₉₀- |
| | | | D₅₀ (sometimes referred |
| | | | to herein as a right width), |
| | | | and D₉₀-D₁₀ (sometimes |
| | | | referred to herein as a full |
| | | | width). |
| Active | Cumulative | Computed | A cumulative volume |
| Material | Volume | via LPSA | fraction, defined as a |
| Particle | Fraction | data | cumulative volume of the |
| Pop- | | | composite particles with |
| ulation | | | particle sizes of a |
| | | | threshold particle size or |
| | | | less, divided by a total |
| | | | volume of all of the |
| | | | composite particles, may |
| | | | be estimated by LPSA. |
| Active | Composition | Balance | The mass of active |
| Material | (e.g., wt. %) | | materials added to the |
| Particle | | | electrode divided by the |
| Pop- | | | total mass of the electrode. |
| ulation | | | |
| Active | BET SSA | BET Isotherm | obtained from the data of |
| Material | (e.g., m²/g) | | nitrogen sorption- |
| Particle | | | desorption at cryogenic |
| Pop- | | | temperatures, such as |
| ulation | | | about 77K |
| Elec- | Salt | balance, | Total volume of the |
| trolyte | Concentrati | volumetric | solution is computed |
| | on (e.g., M | pipette | either via the sum of the |
| | or mol. %) | | volume of the constituents |
| | | | (measured by a volumetric |
| | | | pipette), or by the mass of |
| | | | the constituents divided |
| | | | by the density. The molar |
| | | | mass of the salt is then |
| | | | used to calculate the total |
| | | | number of moles of salt in |
| | | | the solution. The moles of |
| | | | salt is then divided by the |
| | | | total volume to obtain the |
| | | | solvent concentration in M |
| | | | (mol/L). |
| Elec- | Solvent | balance, | Total volume of the |
| trolyte | Con- | volumetric | solution is computed |
| | centration | pipette | either via the sum of the |
| | (e.g., M | | volume of the constituents |
| | or mol. %) | | (measured by a volumetric |
| | | | pipette), or by the mass of |
| | | | the constituents divided |
| | | | by the density. The molar |
| | | | volume of each solvent is |
| | | | then used to calculate the |
| | | | total number of moles of |
| | | | solvent in the solution. The |
| | | | moles of solvent is then |
| | | | divided by the total |
| | | | volume to obtain the |
| | | | solvent concentration in M |
| | | | (mol/L). |
| Electrode | Composition | Balance | The mass fraction of a |
| | (e.g., mass | | material (e.g., active |
| | fraction or | | material, active material |
| | wt. %) | | particle, binder, etc.) in the |
| | | | electrode is calculated |
| | | | based on a measured or |
| | | | estimated mass of the |
| | | | material and a measured |
| | | | or estimated mass of the |
| | | | electrode, excluding the |
| | | | electrode current |
| | | | collector. |
| | | | Note: The mass of |
| | | | individual components |
| | | | (e.g., composite active |
| | | | material particles, |
| | | | graphite particles, binder, |
| | | | function additive(s), etc.) |
| | | | of the battery electrode |
| | | | composition may be |
| | | | measured before being |
| | | | mixed into a slurry to |
| | | | estimate their mass in a |
| | | | casted electrode. The mass |
| | | | of materials deposited |
| | | | onto the casted electrode |
| | | | may be measured by |
| | | | comparing the weight of |
| | | | the casted electrode |
| | | | before/after the material |
| | | | deposition. |
| Electrode | Areal | balance | A mass fraction of the |
| | Binder | | binder in the battery |
| | Loading | | electrode, divided by a |
| | (e.g., | | product of (1) a mass |
| | mg/m²) | | fraction of the active |
| | | | material (e.g., Si-C |
| | | | nanocomposite, etc.) |
| | | | particles in the battery |
| | | | electrode, and (2) a |
| | | | Brunauer-Emmett-Teller |
| | | | (BET) specific surface area |
| | | | of the active material |
| | | | particle population. |
| Electrode | Capacity | Calculated | Measure the mass (wt.) of |
| | Attributable | | active material in the |
| | to Active | | electrode, and calculate |
| | Material | | electrode capacity based |
| | (active | | on the known theoretical |
| | material | | capacity of the active |
| | capacity | | material. For example, the |
| | fraction) | | average wt. % of active |
| | | | material in each active |
| | | | material particle may be |
| | | | measured and used to |
| | | | calculate the mass of the |
| | | | active material based on |
| | | | the mass of the active |
| | | | material particles before |
| | | | being mixed in the slurry. |
| | | | This process may be |
| | | | repeated if the electrode |
| | | | includes two or more |
| | | | active materials to |
| | | | calculate the relative |
| | | | capacity attribution for |
| | | | each active material in the |
| | | | electrode. |
| Electrode | Capacity | Potentiostat and | Determine the average |
| | Attributable | balance | specific capacity (mAh/g) |
| | to Active | | of active material |
| | Material | | particles. For example, the |
| | Particles | | average specific capacity |
| | (active | | may be estimated from the |
| | material | | average wt. % of active |
| | particle | | material(s) in each |
| | capacity | | particle and its associated |
| | fraction) | | known theoretical |
| | | | capacity(ies). Then, |
| | | | measure the mass (wt.) of |
| | | | active material particles in |
| | | | the electrode before being |
| | | | mixed in slurry, which may |
| | | | be used to calculate the |
| | | | capacity attributable to |
| | | | that active material. This |
| | | | process may be repeated if |
| | | | the electrode includes two |
| | | | or more active material |
| | | | particle types to calculate |
| | | | the relative capacity |
| | | | attribution for each active |
| | | | material particle type in |
| | | | the electrode. |
| Electrode | Mass of | balance | The average wt. % of |
| | Active | | active material in each |
| | Material in | | active material particle |
| | Electrode | | may be measured, and |
| | | | used to calculate the mass |
| | | | of the active material |
| | | | based on the mass of the |
| | | | active material particles |
| | | | before being mixed in |
| | | | slurry. |
| Electrode | Mass of | balance | Measure the active |
| | Active | | material particle before |
| | Material | | the active material particle |
| | Particle in | | type is mixed in the slurry. |
| | Electrode | | |
| Electrode | Areal | Potentiostat and | Areal capacity loading is |
| | Capacity | balance | the weight of the coated |
| | Loading | | active material per unit |
| | (e.g., | | area (g/cm²) multiplied by |
| | mAh/cm²) | | the gravimetric capacity of |
| | | | the active material (not |
| | | | the electrode, but the |
| | | | active material itself with |
| | | | zero binder and zero |
| | | | electrolyte; mAh/g). |
| Electrode | Coulombic | Potentiostat | The change in charge |
| | Efficiency | | inserted (or extracted) to |
| | | | an electrode divided by |
| | | | the charge extracted (or |
| | | | inserted) from the |
| | | | electrode during a |
| | | | complete electrochemical |
| | | | cycle within given voltage |
| | | | limits. Because the |
| | | | direction of charge flow is |
| | | | opposite for cathodes and |
| | | | anodes, the definition is |
| | | | dependent on the |
| | | | electrode. |
| | | | Coulombic Efficiency is |
| | | | measured for both |
| | | | materials by constructing |
| | | | a so-called half-cell, which |
| | | | is an electrochemical cell |
| | | | consisting of a cathode or |
| | | | anode material of interest |
| | | | as the working electrode |
| | | | and a lithium metal foil |
| | | | which functions as both |
| | | | the counter and reference |
| | | | electrode. Then, charge is |
| | | | either inserted or |
| | | | removed from the |
| | | | material of interest until |
| | | | the cell voltage reaches an |
| | | | appropriate limit. Then, |
| | | | the process is reversed |
| | | | until a second voltage limit |
| | | | is reached, and the charge |
| | | | passed in both steps is |
| | | | used to calculate the |
| | | | Coulombic Efficiency, as |
| | | | described above. |
| Battery | Rate | Potentiostat | This is the time it takes to |
| Cell | Performance | | charge or discharge a |
| | | | battery between a given |
| | | | state of charge. It is |
| | | | measured by charging or |
| | | | discharging a battery and |
| | | | measuring the time until a |
| | | | specified amount of charge |
| | | | is passed, or until the |
| | | | battery operating voltage |
| | | | reaches a specified value. |
| Battery | Cell | Potentiostat | A battery consisting of a |
| Cell | Discharge | | relevant anode and |
| | Voltage | | cathode is charged and |
| | (e.g., V) | | discharged within certain |
| | | | voltage limits and the |
| | | | charge-weighted cell |
| | | | voltage during discharge is |
| | | | computed. |
| Battery | Operating | Potentiostat and | Average temperature of |
| Cell | Temperature | thermocouples | battery cell as measured at |
| | | | the positive/negative |
| | | | terminal/cell shaft/etc. |
| | | | while |
| | | | charging/discharging, or |
| | | | at a certain voltage level, |
| | | | or while a load is applied, |
| | | | etc. |
| Battery | Anode | Potentiostat | An electrode containing an |
| Half-Cell | Discharge | | active anode material (or a |
| | (de- | | mixture of active |
| | lithiation) | | materials) of interest is |
| | Potential | | charged and discharged |
| | (e.g., V) | | (by passing electrical |
| | | | current to the electrode) |
| | | | within certain potential |
| | | | limits using an |
| | | | electrochemical cell with a |
| | | | suitable reference |
| | | | electrode, typically lithium |
| | | | metal. The charge- |
| | | | averaged cell potential |
| | | | upon discharge |
| | | | (corresponding to de- |
| | | | lithiation of the anode) is |
| | | | computed. |
| Battery | Cathode | Potentiostat | An electrode containing an |
| Half-Cell | Discharge | | active cathode material |
| | (lithiation) | | (or a mixture of active |
| | Potential | | materials) of interest is |
| | (e.g., V) | | charged and discharged |
| | | | (by passing electrical |
| | | | current to the electrode) |
| | | | within certain potential |
| | | | limits using an |
| | | | electrochemical cell with a |
| | | | suitable reference |
| | | | electrode, typically lithium |
| | | | metal. The charge- |
| | | | averaged cell potential |
| | | | upon discharge |
| | | | (corresponding to |
| | | | lithiation of the cathode) is |
| | | | computed. |
| Battery | Volumetric | Potentiostat | The VED is calculated by |
| Cell | Energy | | first calculating the energy |
| | Density | | per unit area of the |
| | (VED) | | battery, and then dividing |
| | | | the energy per unit area by |
| | | | the sum of the illustrative |
| | | | anode, cathode, separator, |
| | | | and current collector |
| | | | thicknesses |
| Battery | Internal | Potentiostat | The internal resistance |
| Cell | Resistance | | (also known as impedance |
| | (impedance) | | in many contexts) is |
| | | | measured by applying |
| | | | small pulses of current to |
| | | | the battery cell and |
| | | | recording the |
| | | | instantaneous change in |
| | | | cell voltage. |

In certain aspects, the disclosure relates to batteries. While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, dual ion batteries, alkaline or alkaline ion batteries, flow batteries, etc.) as well as electrochemical capacitors and hybrid energy storage devices.

While the description below may describe certain examples in the context of composites comprising specific (e.g., alloying-type or conversion-type) active anode materials (such as Si, among others) or specific (e.g., intercalation-type or conversion-type) active cathode materials, it will be appreciated that various aspects may be applicable to many other types and chemistries of conversion-type anode and cathode active materials, intercalation-type anode and cathode active materials, pseudocapacitive anode and cathode active materials, and materials that may exhibit mixed electrochemical energy storage mechanisms.

While the description below may also describe certain examples of the material formulations in a Li-free state (for example, as in silicon-comprising nanocomposite anodes or metal fluoride cathodes or sulfur cathodes, etc.), it will be appreciated that various aspects may be applicable to Li-comprising electrodes and active materials (for example, partially or fully lithiated Si-comprising anodes or partially or fully lithiated Si-comprising anode particles, partially or fully lithiated cathodes. Unless stated or implied otherwise, reference to such Li-dependent anode material properties (e.g., at particle level, at inter-particle level, at electrode level, etc.) may be assumed to be provided as if the active material particles are in the Li-free state. Further, some examples below are characterized at the electrode level (e.g., as opposed to particle level or interparticle level or cell level, etc.). Below, unless stated or implied otherwise, reference to such electrode level properties (e.g., electrode porosity or areal capacity loading or gravimetric/volumetric capacity, etc.) may be assumed to refer to the electrode components (e.g., active material particles, binder, conductive additives, etc.), excluding the current collector.

While the description below may describe certain examples in the context of some specific alloying-type, conversion-type and intercalation-type chemistries for anode active materials and conversion-type and intercalation-type chemistries for cathode active materials for Li-ion batteries, it will be appreciated that various aspects may be applicable to other chemistries for Li-ion batteries (other conversion-type and alloying-type electrodes as well as various intercalation-type anodes and cathodes) as well as to other battery chemistries. During battery (such as a Li-ion battery) operation, conversion materials change (convert) from one crystal structure to another (hence the name “conversion”-type), where a material structure and composition may chemically and structurally change to one or multiple structures. This process is also accompanied by breaking chemical bonds and forming new ones. During battery (e.g., Li-ion battery) operation, Li ions are inserted into alloying-type materials forming lithium alloys (hence the name “alloying”-type). Sometimes, “alloying”-type electrode materials are considered to be a subclass of “conversion”-type electrode materials.

While the description below may describe certain examples in the context of Si—C composite (e.g., nanocomposite) anode active materials (e.g., nanocomposite particles which comprise silicon (Si) and carbon (C) and may comprise other elements, such as nitrogen (N), phosphorus (P), boron (B), oxygen (O), hydrogen (H), sulfur (S), fluorine (F), to name a few and where a total mass of the Si and the C atoms may contribute from about 75 wt. % to about 100 wt. % of the total mass of the composite particles), it will be appreciated that various aspects may be applicable to other types of the high-capacity silicon-comprising anode active materials (including but not limited to, for example, various silicon-comprising or silicon oxide-comprising or silicon nitride-comprising or silicon oxy-nitride-comprising or silicon phosphide-comprising particles or particles comprising a mixture or alloy or other combinations of such active materials, various other types of Si-comprising composites including, but not limited to core-shell or hierarchical or nanocomposite particles, etc.).

An aspect is directed to a battery anode and/or a battery anode precursor composition comprising a population of Si-comprising particles (e.g., nanocomposite particles, among others), in which some or all of the Si-comprising particles comprise silicon (Si) and carbon (C) elements and may comprise other elements, such as nitrogen (N), phosphorus (P), boron (B), oxygen (O), hydrogen (H), sulfur (S), fluorine (F), to name a few. In some embodiments, the total mass of the Si and the C (on average) in the Si-comprising particles may contribute from about 75 wt. % to about 100 wt. % of the total mass of the Si-comprising particles. Such composite particles are sometimes referred to herein as Si—C composites (or nanocomposites, if Si and/or C are nanostructures, for example).

In some embodiments, the total mass of O may contribute (on average) from about 0 wt. % to about 10 wt. % of the total mass of the Si-comprising particles (e.g., about 0-1 wt. %; about 1-2.5 wt. %; about 2.5-5 wt. %; or about 5-10 wt. %;). In some embodiments, the total mass of N may contribute (on average) from about 0 wt. % to about 10 wt. % of the total mass of the Si-comprising particles (e.g., about 0-0.1 wt. %; about 0.1-2 wt. %; about 2-5 wt. %; or about 5-10 wt. %). In some embodiments, the total mass of P may contribute (on average) from about 0 wt. % to about 10 wt. % of the total mass of the Si-comprising particles (e.g., about 0-0.1 wt. %; about 0.1-1 wt. %; about 1-5 wt. %; or about 5-10 wt. %). In some embodiments, the total mass of B may contribute (on average) from about 0 wt. % to about 5 wt. % of the total mass of the Si-comprising particles (e.g., about 0-0.1 wt. %; about 0.1-2.5 wt. %; or about 2.5-5 wt. %). In some embodiments, the total mass of H may contribute (on average) from about 0 wt. % to about 2 wt. % of the total mass of the Si-comprising particles (e.g., about 0-0.5 wt. %; about 0.5-1 wt. %; or about 1-2 wt. %). In some embodiments, the total mass of S may contribute (on average) from about 0 wt. % to about 2.5 wt. % of the total mass of the Si-comprising particles (e.g., about 0-0.1 wt. %; about 0.1-0.5 wt. %; or about 0.5-2.5 wt. %). In some embodiments, the total mass of F may contribute (on average) from about 0 wt. % to about 2.5 wt. % of the total mass of the Si-comprising particles (e.g., about 0-0.1 wt. %; about 0.1-0.5 wt. %; or about 0.5-2.5 wt. %).

In some embodiments, a total atomic fraction of the Si and the C may contribute from about 75 at. % to about 100 at. % of the overall composite particles. Such composite particles are sometimes referred to herein as Si—C composites. In some embodiments, such composite particles comprise nano-sized or nanostructured elements (e.g., nano-sized or nanostructured Si, nano-sized or nanostructured C, or both), which may be referred to as nanocomposite particles. In some implementations, the Si or Si-comprising active material present in such nanocomposites may be in the form of nanoparticles. In some implementations, the mass-average size of Si or Si-comprising active material nanoparticles (or nanocrystals) may range from about 1 nm to about 200 nm (e.g., about 1.0-10.0 nm; about 10.0-30.0 nm; or about 30.0-100.0 nm; or about 100-200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques. X-ray diffraction may be particularly convenient and easy for identifying the average size of Si nanocrystals. Too small (e.g., smaller than about 1.0 nm in some designs or, e.g., about 2 nm in other designs) Si nanocrystals may exhibit too high reactivity during synthesis and become less active or induce too high first cycle capacity losses, while too large (e.g., larger than about 200 nm in some designs or, e.g., about 100 nm in other designs) Si crystals may reduce cycle stability of such Si—C composites (nanocomposites) or, broadly, nanocomposite silicon. As used here, a “nano”-material (e.g., nanostructure or nanoparticle or nanocomposite, etc.) may refer to any material that exhibits at least one dimension that is less than about 200 nm.

An aspect is directed to a battery anode and/or a battery anode precursor composition comprising a population of Si-comprising particles (e.g., nanocomposite particles, among others), in which each of the particles comprises Si and C, and the Si-comprising particles have certain characteristics. In some embodiments, a mass fraction of the silicon in the Si-comprising particles (e.g., composite particles) is in a range of about 3 wt. % to about 80 wt. % (e.g., about 3-20 wt. %; about 20-35 wt. %; about 35-50 wt. %; or about 50-80 wt. %). In some embodiments, a Brunauer-Emmett-Teller (BET) specific surface area (SSA) of the Si-comprising particles (e.g., nanocomposite particles, among others) is in a range of about 0.5 m²/g to about 170 m²/g (e.g., about 0.5-3 m²/g; about 3-12 m²/g; about 12-20 m²/g; about 20-170 m²/g). In some embodiments, about 90% or more of the Si-comprising particles (e.g., nanocomposite particles, among others) in the population are characterized by aspect ratios of about 2.3 or less, or aspect ratios of about 2.1 or less. In some embodiments, about 50% or more of the composite particles in the population are characterized by aspect ratios of about 1.25 or more, or aspect ratios of about 1.35 or more.

An aspect is directed to a battery anode and/or a battery anode precursor composition comprising a population of Si-comprising particles (e.g., nanocomposite particles, among others), in which each of the particles comprises Si and C, and the Si-comprising particles exhibit, on average, specific reversible capacity (as measured in half cells using a proper charge-discharge protocol such as, for example, by lithiation of the anode at the constant current density of 0.1 C to 0.01 V vs. Li/Li⁺ followed by taper till the current density decreases to 0.01 C and then followed by delithiation at the constant current density of 0.1 C to 1.5 V vs. Li/Li⁺; note that the capacity of the Si-comprising particles may be estimated from the anodes comprising known wt. % blends with known graphite that have known specific capacity of its own) in the range of about 1400 mAh/g to about 2800 mAh/g (e.g., about 1400-1600 mAh/g; about 1600-1800 mAh/g; about 1800-2000 mAh/g; about 2000-2200 mAh/g; about 2200-2400 mAh/g; about 2400-2600 mAh/g; or about 2600-2800 mAh/g). Similarly, the irreversible (first cycle) specific capacity of the particles that comprise Si and C may preferably range from about 1500 mAh/g to about 2900 mAh/g (e.g., about 1500-1700 mAh/g; about 1700-1900 mAh/g; about 1900-2100 mAh/g; about 2100-2300 mAh/g; about 2300-2500 mAh/g; about 2500-2700 mAh/g; or about 2700-2900 mAh/g).

An aspect is directed to a battery electrode and/or a battery electrode precursor composition comprising a population of Si-comprising particles (e.g., nanocomposite particles, among others). The particle size distribution (PSD) that characterizes a particle population may be determined by laser particle size distribution analysis (LPSA) on well-dispersed particle suspensions in one example or by image analysis of electron microscopy images, or by other suitable techniques. While there are diverse processes of measuring PSDs, laser particle size distribution analysis (LPSA) is quite efficient for some applications. Using LPSA, particle size parameters of a population's PSD can be measured, such as: a tenth-percentile volume-weighted particle size parameter (e.g., abbreviated as D₁₀), a fiftieth-percentile volume-weighted particle size parameter (e.g., abbreviated as D₅₀), a ninetieth-percentile volume-weighted particle size parameter (e.g., abbreviated as D₉₀), and a ninety-ninth-percentile volume-weighted particle size parameter (e.g., abbreviated as D₉₉). A cumulative volume fraction, defined as a cumulative volume of the composite particles with particle sizes of a threshold particle size or less, divided by a total volume of all of the composite particles, may be estimated by LPSA. In some embodiments, a fiftieth-percentile volume-weighted particle size parameter (D₅₀) of the PSD of Si-comprising particles may advantageously be in a range of about 0.5 to about 25.0 μm (e.g., about 4.0-12.0 μm, about 0.5-4.0 μm, about 4.0-6.0 μm, about 6.0-8.0 μm, about 8.0-12.0 μm, about 12.0-16.0 μm, or about 16.0-25.0 μm).

Note that in some designs, the presence of excessively large particles comprising Si (e.g., in the form of nanocomposite particles, among others) may reduce cell performance characteristics (e.g., reduce cell stability, increase its impedance, reduce rate performance, reduce packing density, reduce electrode smoothness or uniformity, reduce electrode mechanical properties, reduce volumetric capacity, increase (e.g., localized) volume expansion, etc.). In some embodiments (e.g., when the D₅₀ is in a range from about 0.5 μm to about 4.0 μm), the cumulative volume fraction, with the threshold particle size at about 10 μm, may advantageously be about 80 vol. % (D₈₀) or more, or about 85 vol. % (D₈₅) or more, or (in some designs) even about 90 vol. % (D₉₀) or more. In other embodiments (e.g., when the D₅₀ is in a range from about 4.0 μm to about 8.0 μm), the cumulative volume fraction, with the threshold particle size at about 18 μm, may advantageously be about 80 vol. % or more, or about 85 vol. % or more, or (in some designs) even about 90 vol. % or more. In other embodiments (e.g., when the D₅₀ is in a range from about 8.0 μm to about 12.0 μm), the cumulative volume fraction, with the threshold particle size at about 22 μm, may advantageously be about 80 vol. % or more, or about 85 vol. % or more, or (in some designs) even about 90 vol. % or more. In one or more embodiments of the present disclosure, Si-comprising active material particles may exhibit true density (e.g., as measured by using an argon gas pycnometer) in the range from about 1.1 g/cc to about 2.8 g/cc (about 1.1-1.5 g/cc; about 1.5-1.8 g/cc; about 1.8-2.1 g/cc; about 2.1-2.4 g/cc; or about 2.4-2.8 g/cc).

In one or more embodiments of the present disclosure, Si-comprising active material particles may comprise internal pores. In some designs, the open (e.g., to nitrogen gas at 77K) pore volume (e.g., as measured by nitrogen sorption/desorption isotherm measurement technique and including the pores in the range from about 0.4 nm to about 100 nm) may range from about 0.00 cc/g to about 0.50 cc/g (assuming a theoretical density of the individual material components present in Si-comprising particles)—e.g., about 0.00-0.10 cc/g; about 0.10-0.20 cc/g; about 0.20-0.30 cc/g; about 0.30-0.40 cc/g; about 0.40-0.50 cc/g. In some designs, the closed (e.g., to nitrogen gas at 77K) pore volume (e.g., measured by analyzing true density values measured by using an argon gas pycnometer and comparing to the theoretical density of the individual material components present in Si-comprising particles) may range from about 0.00 cc/g to about 1.00 cc/g—e.g., about 0.00-0.10 cc/g; about 0.10-0.20 cc/g; about 0.20-0.30 cc/g; about 0.30-0.40 cc/g; about 0.40-0.50 cc/g; about 0.50-0.60 cc/g; about 0.60-0.70 cc/g; about 0.70-0.80 cc/g; about 0.80-0.90 cc/g; about 0.90-1.00 cc/g. In some designs, the volume-average size of the open (e.g., to nitrogen gas at 77K) pores may range from about 0.5 nm to about 100 nm—e.g., about 0.5-5 nm; about 5-20 nm; about 20-50 nm; or about 50-100 nm. In some designs, the volume-average size of the closed (e.g., to nitrogen gas at 77K) pores (e.g., measured by image analysis of cross-sectional electron microscopy images such as SEM or TEM or measured by the neutron scattering or other suitable technique) may range from about 0.5 nm to about 200 nm—e.g., about 0.5-5 nm; about 5-20 nm; about 20-50 nm; about 50-100 nm; or about 100-200 nm.

In one or more embodiments of the present disclosure, Si-comprising active material particles may exhibit moderate (e.g., about 7-120 vol. %) or high (e.g., about 120-240 vol. %) volume changes during initial lithiation (e.g., down to around 0.01 V vs. Li/Li⁺). In some designs, Si-comprising active material particles may exhibit volume changes in the range from about 8 vol. % to about 180 vol. % during one or more charge-discharge cycles of the battery cell. In one or more embodiments of the present disclosure, Si-comprising active material particles may exhibit moderately small (e.g., about 3-7 vol. %) or moderate (e.g., about 7-120 vol. %) volume changes during electrochemical battery cycling from about 0-5% state of charge (SOC) to about 90-100% SOC and back during battery operation.

In one or more embodiments of the present disclosure, a preferred anode for a battery cell may comprise a mixture of Si-comprising active material particles (e.g., nanocomposite Si—C particles, nanocomposite Si particles, among others) and graphite active material particles (or, more broadly, carbon active material particles) as the anode active material, a so-called blended anode. In addition to the anode active material particles, an anode may comprise inactive material, such as binder(s) (e.g., polymer binder) and other functional additives (e.g., surfactants, electrically conductive additives, etc.). In some implementations, the anode active material may be in a range of about 85 wt. % to about 98 wt. % of the total weight of the anode (not counting the weight of the current collector)—e.g., about 85-89 wt. %; about 89-91 wt. %; about 91-93 wt. %; about 93-95 wt. %; or about 95-98 wt. %.

In some implementations, blended anodes may comprise Si-comprising particles (e.g., Si—C nanocomposite particles, among others) ranging from about 7 wt. % to about 98 wt. % (e.g., about 7-15 wt. %, about 15-25 wt. %, about 25-40 wt. %, about 40-60 wt. %, about 60-80 wt. %, or about 80-98 wt. %) of all the anode active material particles and the graphite (e.g., particles) making up the remainder of the mass (the weight) of the anode active material particles (from about 2 wt. % to about 93 wt. %).

While the descriptions below may also describe certain examples of the blended anode formulations expressed as mass (wt. %) of Si-comprising particles (e.g., Si—C nanocomposite particles, among others) among the anode active materials or as mass (wt. %) of Si-comprising particles (e.g., Si—C nanocomposite particles, etc.) in the total anode (not counting the weight of the current collector), it will be appreciated that various aspects of this disclosure may be applicable to blended anode formulations expressed as wt. % of Si in the anode (counting the weight of all the active materials, binder, conductive and other additives, but not counting the weight of the current collector). While the descriptions below may also describe certain examples of the blended anode formulations expressed as mass (wt. %) of Si-comprising particles (e.g., Si—C nanocomposite particles, etc.) in the active material blends, it will be appreciated that various aspects of this disclosure may be applicable to blended anode formulations attributing a fraction (e.g., %) of the total capacity of the blended anode to the capacity of the Si-comprising particles.

In some embodiments, the battery electrode (e.g., anode) and/or battery electrode (e.g., anode) precursor composition may advantageously comprise one or more carbon-comprising functional additives (e.g., additives that enhance electrical conductivity or rate performance of mechanical properties of the electrode). In some embodiments, the carbon-comprising functional additive is selected from: carbon nanotubes (e.g., single-walled carbon nanotubes (SWCNTs), multi-walled carbon nanotubes (MWCNTs), carbon nanofibers, carbon black, graphite, exfoliated graphite, graphene oxide and graphene. In some embodiments, the battery electrode (e.g., anode) precursor composition comprises a polymerizable binder precursor (e.g., polymerizable monomers, oligomers, and/or polymers). In addition, the battery electrode (e.g., anode) precursor composition may comprise one or more binder components. In some embodiments, the battery electrode (e.g., anode) may comprise a binder formed by polymerization of the polymerizable binder precursor present in the battery electrode (e.g., anode) precursor composition. In addition, the battery electrode (e.g., anode) may comprise one or more binder components (in some designs, two or more binder components).

An aspect is directed to a battery anode. In some embodiments, the battery anode is formed from any of the foregoing battery anode electrode precursor compositions, disposed on and/or in a current collector (e.g., Cu-based or Cu-containing current collector, such as a dense or porous foil or a mesh or a foam or a nanowire-comprising or nanoflake-comprising current collector, etc.). In some embodiments, a coating density of the battery electrode (anode) is in a range of about 0.8 to about 1.7 g/cm³ (e.g., about 0.8-0.9 g/cm³; about 0.9-1.0 g/cm³; about 1.0-1.2 g/cm³; about 1.2-1.4 g/cm³, or about 1.4-1.7 g/cm³). Higher fraction of suitable graphite material in a blended anode may benefit from higher anode density for better performance (e.g., better stability, better rate performance, higher volumetric capacity, lower swell during cycling, etc.), although excessive density may also be detrimental for the same or other characteristics. Higher fractions of graphite in Si-comprising blended anodes typically allow for higher density to be attained without a detrimental impact of such compaction. Such aspects may be adapted for a particular battery design, electrode thickness, areal capacity loading, Si wt. %, type and properties of Si-comprising particles (e.g., nanocomposite Si—C particles), battery cycling environment and regime, among other factors.

An aspect is also directed to a blended battery anode, wherein both the Si-comprising active anode particles (e.g., nanocomposite Si—C particles, among others) and graphite (or, broadly, carbon-based) active anode material may be present. The anode may preferably comprise a binder amount optimized for the properties of both the Si-comprising active material particles and the graphite particles. For example, the anode may be characterized by an areal binder loading, defined as a mass of the binder in the battery anode (e.g., measured in mg) normalized by the surface area of the active material particles (e.g., Si-comprising (e.g., nanocomposite, etc.) active anode material particles and (if present) graphite active material particles in the same battery anode (e.g., measured in m² and defined by the mass of active material particles (in g) multiplied Brunauer-Emmett-Teller (BET) specific surface area (SSA, in m²/g)). Since a BET SSA of both the Si-comprising active material particle population and the graphite active material particle population may vary from slurry to slurry, in some designs, the binder loading may preferably be adjusted based on the desired areal binder loading. Higher BET SSA of the active anode materials (measured in m²/g) typically require a higher mass fraction of the binder in the anode electrode. For example, the anode electrode comprising active material particle population (e.g., Si-comprising (e.g., nanocomposite, etc.) active anode material particle population or a blend of Si-comprising active material(s) and a graphite active material(s)) with BET SSA of about 10 m²/g would typically require from about 20 mg to about 150 mg of the binder per 1 g of active material particles (approximately 2-13 wt. % relative to the sum of the weight of the binder and the active material composition, not counting the weight of conductive or other additives or the weight of the current collector), while another anode electrode comprising another active material particle population (e.g., Si-comprising (e.g., nanocomposite, etc.) active anode material particle population or a blend of Si-comprising active material(s) and a graphite active material(s)) with BET SSA of only 1 m²/g would typically require from about 2 mg to about 40 mg of the binder per 1 g of active material particles (approximately 0.2-4 wt. % relative to the total weight of the binder+active material composition, not counting the weight of conductive or other additives or the weight of the current collector). However, in some designs, an aerial binder loading of the battery anode in both cases is in the range from about 2.0 mg/m² to about 40.0 mg/m² (e.g., about 2.0-5.0 mg/m²; about 5.0-9.0 mg/m²; about 9.0-15.0 mg/m²; or about 15.0-40.0 mg/m²). In some designs, a higher fraction of Si-comprising (e.g., nanocomposite, etc.) active anode material particle population in the anode (relative to the total weight of all active materials) may preferably require a higher aerial binder loading. In some designs, a larger average size of Si-comprising (e.g., nanocomposite, etc.) active anode material particle population in the anode may preferably require a slightly higher aerial binder loading. In some designs, a larger BET SSA of Si-comprising (e.g., nanocomposite, etc.) active anode material particle population in the anode may preferably require a slightly smaller aerial binder loading. In some designs, the areal binder loading may also depend on the binder composition and properties (e.g., adhesion, chemical composition, hardness, elastic modulus when exposed to electrolyte, maximum elongation at break, among others). Thus, in some designs, the optimal areal binder loading content within a relatively a range of about 2.0 mg/m² to about 40.0 mg/m² depending on the anode formulation. So, the optimal areal binder loading content in some designs may range from about 2.0-5.0 mg/m²; about 5.0-9.0 mg/m²; about 9.0-15.0 mg/m²; or about 15.0-40.0 mg/m²).

An aspect is directed to a battery and an anode comprising Si-comprising particles that also comprise carbon (C) (e.g., Si—C nanocomposite particles, C-coated particles, etc.), wherein the ratio of intensities of the carbon D band and carbon G band (I_{D}/I_{G}) in the Raman spectra of the majority of Si- and C-comprising particles (measured, for example, using the laser wavelength of about 532 nm; and analyzed, for example, in the spectral (wavenumber) range from about 1000 to about 2000 cm⁻¹ by fitting two Gaussian peaks after a linear background subtraction in this range) to range from I_{D}/I_{G} of about 0.7 to I_{D}/I_{G} of about 2.7 (about 0.7-0.9; about 0.9-1.2; about 1.2-1.5; about 1.5-1.8; about 1.8-2.1; about 2.1-2.4; or about 2.4-2.7).

An aspect is also directed to a Li-ion battery comprising: (i) a suitable battery anode, wherein the suitable anode may comprise one or more of the following, in some designs: (ia) Si-comprising anode comprising Si-comprising anode particles (e.g., nanocomposite Si—C particles, silicon oxide particles, silicon nitride particles, among others), which, in some design may also be a blended battery anode (wherein both the Si-comprising active anode particles (e.g., nanocomposite Si—C particles or silicon oxide particles or silicon nitride particles, among others) and suitable graphite (or, broadly, carbon-based) active anode particles are present in the anode), (ib) intercalation-type carbon (C)—comprising anode comprising natural graphite, synthetic graphite, hard carbon or soft carbon or their various combinations or (ic) metal oxide-comprising anode (e.g., Li, Ti, Nb, Mo, V and/or W-comprising metal oxides, such as, for example, lithium titanium oxide, niobium titanium oxide, niobium molybdenum oxide, niobium molybdenum titanium oxide, niobium tungsten oxide, niobium tungsten molybdenum oxide, niobium tungsten molybdenum titanium oxide, vanadium oxide, their various combinations and mixtures, etc.) or (id) their various combinations and (ii) a suitable battery cathode, wherein the suitable cathode may comprise one or more of the following, in some designs: (iia) intercalation-type cathode (e.g., lithium cobalt oxide (LCO), lithium cobalt aluminum oxides (LCAO), lithium nickel cobalt aluminum oxide (NCA), lithium nickel cobalt manganese oxide (NCM), lithium nickel cobalt manganese aluminum oxide (NCMA), lithium manganese oxide (LMO), lithium nickel oxide (LNO), lithium iron phosphate (LFP), lithium manganese iron phosphate (LMFP), their various mixtures and dopped versions, among others), lithium nickel phosphate (LiNiPO4), lithium vanadium fluoro phosphate (LiVFPO4), lithium iron fluoro sulfate (LiFeSO4F), various Li excess materials (e.g., lithium excess (rocksalt) transition metal oxides and oxy-fluorides such as those comprising Mn, Mo, Cr, Ti, and/or Nb) and many other types of Li-comprising disordered, layered, tavorite, olivine, or spinel type active materials or their mixtures comprising at least oxygen or fluorine or sulfur and at least one transition metal and other lithium transition metal (TM) oxides or phosphates or sulfates (or mixed) cathode active materials that rely on the intercalation of lithium (Li) and changes in the TM oxidation state) or (iib) conversion-type cathode (which may include a displacement-type cathode, a chemical transformation type cathode or a true conversion-type cathode) or (iic) a mixed intercalation/conversion type cathode (either a physical mixture of (iia) and (iib) or a cathode that exhibits both intercalation-type or conversion-type Li-ion storage).

In some designs, a suitable cathode may advantageously comprise one, two or more of the following additives (e.g., in the form of particles, nanoparticles, nanofibers, flakes or nanoflakes): natural graphite, synthetic graphite, graphene, exfoliated graphite, hard carbon, soft carbon, carbon black, carbon fibers, carbon nanofibers, carbon nanotubes in the total amount from around 0.1 wt. % to about 15 wt. % relative to the total weight of the cathode layer but not counting the weight of the cathode current collector (e.g., about 0.1-0.5 wt. %; about 0.5-2 wt. %; about 2-5 wt. %; or about 5-15 wt. %).

In some of the preferred examples, a surface of cathode active materials. or anode active materials may be coated with a layer of ceramic (e.g., oxide) material (e.g., comprising one, two or more of Li, Mg, Al, Ti, Zr, W and/or Nb, among other metals). In some of the preferred examples, a surface of cathode active materials may be coated with a layer of a polymeric material. An aspect is directed to a Li-ion battery with a Si-comprising anode or with a blended anode (e.g., comprising Si-comprising active material and graphite active material, etc.) that exhibits a relatively high areal capacity loading and properly matched (by areal capacity) cathode (with slightly smaller areal capacity loadings, selected according to the desired negative (N) to positive (P) ratio, N/P in the range of around 0.95 to around 1.35 (e.g., around 0.95-1.10; around 1.01-1.05; around 1.05-1.10; around 1.10-1.15; around 1.15-1.20; around 1.20-1.25; around 1.25-1.35); wherein the N/P ratio corresponds to the ratio of the reversible areal capacities of the anode to cathode). One or more embodiments of the present disclosure are directed to fabrication processes, compositions and various physical and chemical properties of anodes and cathodes that enable satisfactory performance for electrode area loadings in the range from around 2 mAh/cm² to around 4 mAh/cm² and more so for loadings in the range from around 4 mAh/cm² to around 8 mAh/cm² and even more so for loadings in the range from around 8 mAh/cm² to around 16 mAh/cm² (e.g., in some designs, an areal capacity loading of an electrode may range from around 2 mAh/cm² to around 16 mAh/cm²).

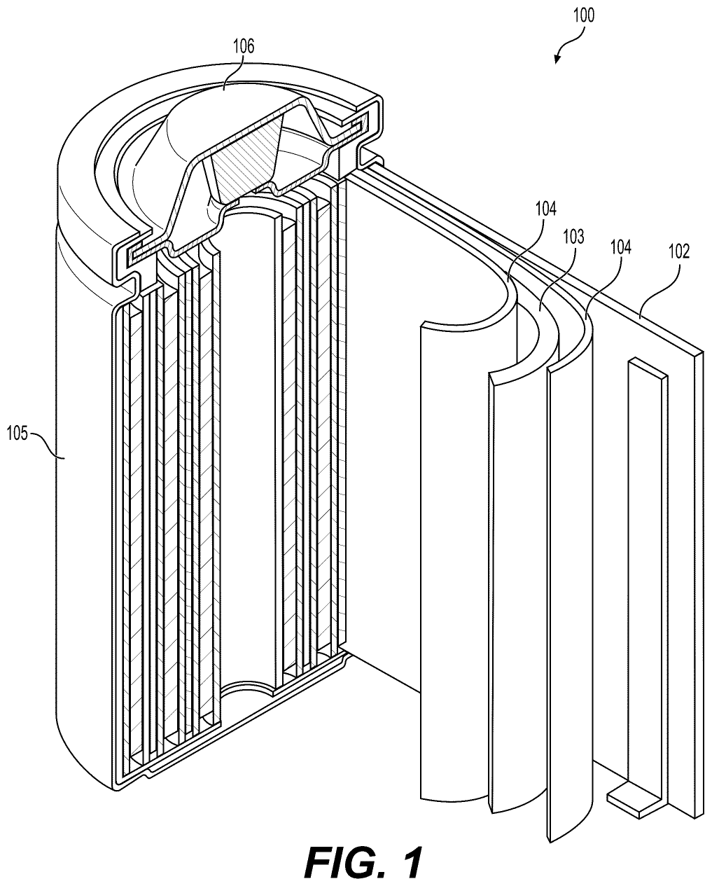

FIG. 1 illustrates an example metal-ion (e.g., Li-ion) battery in which the electrode particles, components, materials, processes, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative electrode (anode electrode or anode) 102, a positive electrode (cathode electrode or cathode) 103, a separator 104 interposed between the anode 102 and the cathode 103, an electrolyte (shown implicitly) impregnating the separator 104, a battery case 105, and a sealing member 106 sealing the battery case 105. The electrolyte ionically couples the anode (negative electrode) and the cathode (positive electrode). The electrolyte is interposed between the anode electrode and the cathode electrode. In some implementations, battery 100 also includes an anode current collector and a cathode current collector. The anode is disposed on and/or in the anode current collector and the cathode is disposed on and/or in the cathode current collector.

An aspect is directed to new binder materials that enhance mechanical strength, reduce the amount of binder needed for the fabrication of electrodes and improve one or more of Li-ion battery performance characteristics (e.g., rate, stability, energy density, specific energy, direct-current resistance, etc.).

It is typically desirable to minimize the mass and volume fraction of the binder(s) within the electrodes to enhance volumetric and gravimetric energy densities, lower electrode impedance, and improve rate capability. It may be particularly advantageous, for example, for the electrode to comprise less than about 25-30 vol. % binder relative to the combined volume of the binder, conductive and other additives and active material particles (not counting the volume of the pores left within the electrode during or after its fabrication and also excluding the current collector) (e.g., less than about 25 vol. %; less than about 20 vol. %; in other designs, less than about 16 vol. %; less than about 12 vol. %; less than about 8 vol. %; or less than about 6 vol. %). It may also be advantageous for the electrode to comprise less than about 14-16 wt. % binder relatively to the combined weight of the binder, conductive and other additives, and active material particles (e.g., less than about 14 wt. %; less than about 12 wt. %; less than about 10 wt. %; less than about 8 wt. %; less than about 6 wt. %; less than about 5 wt. %; less than about 4 wt. %; or, less than about 3 wt. %).

Previously, blends of styrene-butadiene rubbers (SBR) with carboxymethyl cellulose (CMC) as a thickener were proposed to be used as aqueous binders for lithium-ion batteries. SBR is an attractive component for the binder due to its relatively low cost combined with a good water-dispersibility. However, while such binders demonstrated a good adhesion between various active components of the battery and current collectors, these binders exhibited low mechanical stability and relatively low swelling resistance to an electrolyte solvent(s). Furthermore. SBR binders demonstrated decreasing charge-discharge cycle characteristics of a lithium-ion secondary battery when used at high temperatures. Other binders, such as polyvinylidene fluoride (PVDF), polyacrylic acid (PAA) and its derivatives (such as lithium polyacrylate, abbreviated as LiPAA), sodium carboxymethyl cellulose (CMC-Na), and their combinations, were also proposed to be used in lithium-ion batteries. However. these binders also lack the desired mechanical, physical, and electrical properties for some advanced lithium-ion battery applications in which: (1) the anode comprises high-capacity nanocomposite particles (e.g., Si—C nanocomposite particles) that exhibit moderately high volume changes (e.g., about 8-180 vol. %) during one or more charge-discharge cycles; and (2) the areal capacity loading of the anode is quite high (e.g., in some cases, about 2 mAh/cm² to about 4 mAh/cm², or in some other cases, about 4 mAh/cm² to about 8 mAh/cm², or in yet some other cases, about 8 mAh/cm² to about 16 mAh/cm²). Accordingly. there is still a need for new, improved binders. This need is also addressed by this disclosure.

An aspect is directed to polymer binder properties used in electrode processing. In some designs, the primary function of a polymer binder is to hold the active battery materials (e.g., cathode or anode) together and provide mechanical stability and stable operation of a battery cell. This typically requires one or more of the following characteristics, numbered (i) through (vi): (i) Good adhesion between active materials particles and between the particles and the current collector (e.g., copper foil for anode and aluminum foil for cathode). Adhesion strength or “peel strength” is a measure of how strongly the coated materials are adhered to the substrate (e.g., aluminum or copper foil) and is measured by estimating the force (common unit is Newton (N)) acting across the width of the coated surface when peeled at a constant velocity. In some designs, the peel strength of the coatings formed upon polymerization should preferably range between about 0.001 N/cm to about 10 N/cm. (ii) No significant chemical or electrochemical degradation of the binder at the applied voltages in the presence of electrolytes. This is typically ensured by having strong chemical bonds having bond energy in the range from about 60 kcal/mol to about 250 kcal/mol, in some designs. The constituent elements of such bonds may preferably include but are not limited to: carbon, nitrogen, fluorine, phosphorus, oxygen, sulfur, chlorine, bromine, and silicon, to name a few. These chemical bonds may be single bonds, double bonds, and/or triple bonds, or in some cases, may comprise aromatic moieties, including but not limited to heteroaromatic moieties, such as pyridine, pyrimidine, triazine, triazole, tetrazole, furan, pyrrole, thiophene, and their higher homologs, to name a few. In some designs, these rather stringent requirements may preferably be maintained during battery cycling, including elevated temperature operations. This is particularly important in some designs for high-capacity electrodes (e.g., conversion cathodes and anodes) that undergo large volume changes during charge-discharge cycles. Furthermore, in some designs, the polymeric binder may preferably (iii) not dissolve in the employed electrolyte and may swell to only a relatively small degree (in some designs, below about 100 vol. %, on average; in other designs, below about 90 vol. %; in other designs, below about 80 vol. %; in other designs, below about 70 vol. %; in yet other designs, below about 60 vol. %) that allows or enhances ion transportation through the binder to reduce or prevent its adhesion properties from being significantly degraded to the extent that the polymeric binder cannot maintain mechanical stability, which may cause capacity fade over time. Other key preferences for the binder in some designs may include (iv) good thermal stability (especially suitable thermal expansion coefficient in the range about 0.01 to about 40 K⁻¹) to allow stable operation of different batteries at different temperatures (e.g., about −10 to about 50° C.), (v) low outgassing (binder should not contribute to outgassing, which is primarily contributed by electrolyte and the solid electrolyte interphase (SEI) formed therefrom), and (vi) low fatigue (for example, less than about 10% after about 2000 cycle life) over time; fatigue refers to loss of a physical property upon cyclic operation for a long time. In general, binder fatigue is most commonly related to mechanical properties, but in the case of electrochemical testing, binder fatigue can be related to other polymer properties as well, such as swelling (e.g., deleterious increase in swelling), adhesion and cohesion properties, ion-conduction ability, among others. In some designs, it is desirable that the polymers maintain their original properties, and if fatigue is inevitable, then the loss of the above properties are not more than about 10% over a period of about 2000 cycles.

An aspect is directed to an electrode fabricated using a casting technique (e.g., tape casting, etc.) or its variation or combination of casting with other methods. For high-precision electrode thickness control and uniformity, a doctor blade system may be applied. In some implementations, an electrode slurry (e.g., solvents, active material particles, conductive and other functional additives, binder(s), etc.) is poured from a reservoir onto a moving current collector (e.g., a metal foil, etc.). The gap between the bottom of the reservoir (defined by the position of the doctor blade) and the substrate (i.e., current collector) determines the initial thickness (prior to thickness changes caused by densification and/or solvent evaporation) and areal mass loading of the electrode. The thickness is also controlled by the movement speed, electrode mass viscosity, the particular composition of the electrode mass, and other factors.

In some designs, an ultrasound treatment, a vibration treatment and/or continuous stirring (e.g., at high rates) may be applied during the casting procedure to break-up agglomerates and reduce slurry viscosity when a small volume fraction of the binder is used in the electrode slurries (e.g., below about 20-25 vol. %).

In some designs, the use of solid lubricants (e.g., carbon or graphite-based particles) may also be highly advantageous for electrode casting since these may reduce viscosity, agglomeration, and inter-particle friction.

An aspect is directed to suitable properties of graphite particles that may be advantageously used in electrode processing. In some designs, graphite particles with suitable properties may work effectively as solid lubricant(s) or as active material(s) (e.g., within the anode) that also function as solid lubricant(s). Such graphite particles may enhance various properties (e.g., volumetric capacity, rate performance, stability, etc.) of electrodes.

In some designs, it may be advantageous for the suitable graphite to constitute from about 0.1 wt. % to about 95 wt. % of the total weight of the electrode (including active material particles, conductive and other functional additives, binder, surfactant, etc.; but not counting the weight of the current collector or tabs)—e.g., about 0.1-10 wt. %; about 10-25 wt. %; or about 25-95 wt. %. In case of electrode processing of anodes for use in Li-ion batteries, the other components of electrodes may include, but are not limited to various Si-comprising particles (e.g., nanocomposite silicon, silicon-carbon composite, silicon-graphite composite, silicon oxide including carbon-coated silicon oxide, silicon oxide—carbon composite; silicon nitride—carbon composite, silicon oxynitride—carbon composites, etc.), other graphite particles, metal oxide particles, among others.

In some aspects, a suitable binder may comprise a copolymer, which may comprise a copolymer of styrene (e.g., at a mass fraction of about 33 to about 75 wt. % of the copolymer) and (meth)acrylates (e.g., at a mass fraction of about 20 to about 66 wt. % of the copolymer). In some designs, a suitable binder may comprise other suitable components including a suitable amount of a surfactant composition. In certain implementations, a suitable binder may be free from epoxide groups, hydroxyl groups, and Si-containing groups.

In certain implementations, the binder is an aqueous emulsion having a volatile content in a range of about 35 to about 95 wt. % (e.g., about 35-50 wt. %, about 50-65 wt. %, about 65-80 wt. %, or about 80-95 wt. %). In certain implementations, the binder is an aqueous emulsion having a non-volatile content in a range of about 5 to about 65 wt. % (e.g., about 5-20 wt. %, about 20-35 wt. %, about 35-50 wt. %, or about 50-65 wt. %). In some implementations, the binder may have a viscosity in a range of about 10 to about 3000 cP (e.g., about 10-30 cP, about 30-100 cP, about 100-300 cP, about 300-1000 cP, or about 1000-3000 cP). One centipoise (cP) is equivalent to 1 mPa-s. In some implementations the binder can have a pH in a range of about 6 to about 8, or in a range of about 6 to about 7, or in a range of about 7 to about 8.

In certain implementations, the binder can include a copolymer, for example a random copolymer. In certain implementations, the binder is a random copolymer obtained by emulsion polymerization. In some aspects, disclosed herein are methods of making the binders useful for making and operating Li batteries.

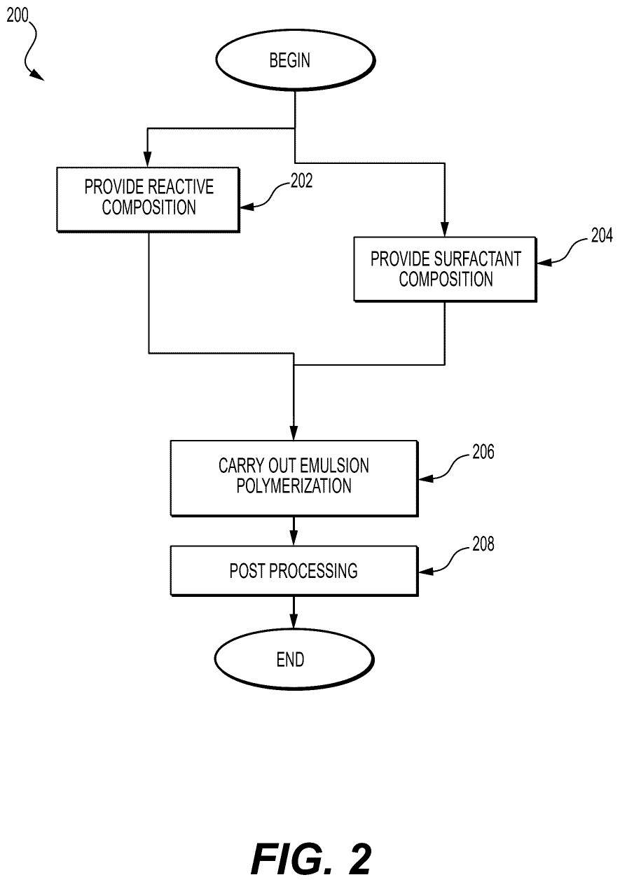

In certain aspects, disclosed herein is a method of making a binder material. The method may comprise carrying out emulsion polymerization of a reactive composition. A general schematic of emulsion polymerization is shown in FIG. 2. The principles of the emulsion polymerization are based on forming an emulsion comprising water, the reactive monomers, and surfactants. In certain aspects, the method 200 comprises providing a reactive composition 202 and providing a surfactant composition 204, and a solvent (not shown) to form an emulsion. The emulsion polymerization 206 is carried out to form the desired polymers that then are isolated, or otherwise processed as needed (208) for the final use. The details of the emulsion polymerization and the compositions formed by such polymerizations are disclosed below.

In certain aspects, disclosed herein is an emulsion polymerization of a reactive composition in the presence of a surfactant composition.

In some aspects, the reactive composition can comprise one or more ethylenically unsaturated compounds. As described in detail above, the ethylenically unsaturated compounds are employed in a broad sense and is intended to encompass any compounds containing a reactive carbon-carbon double-bonded group (>C═C<group).

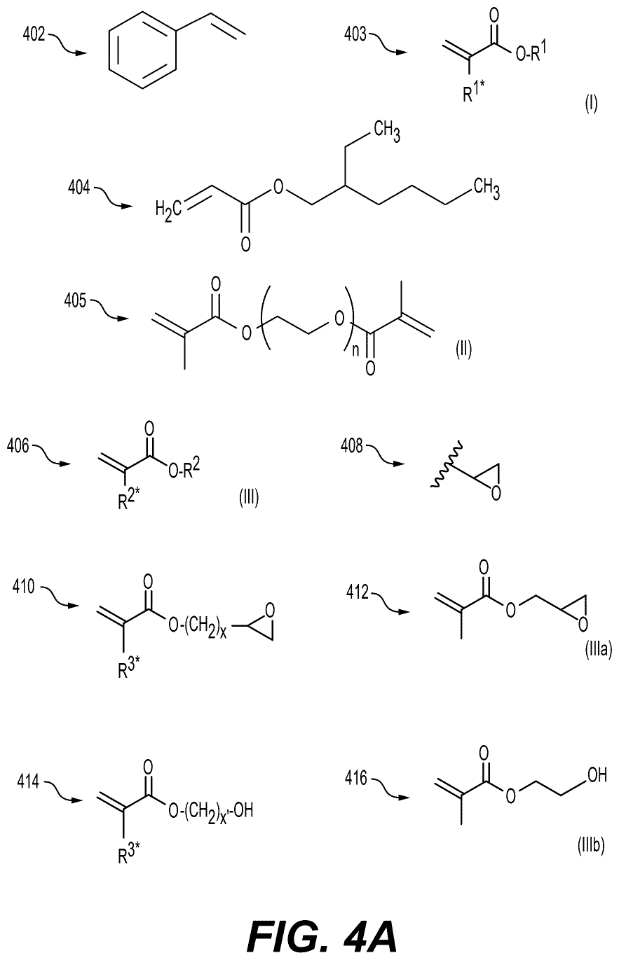

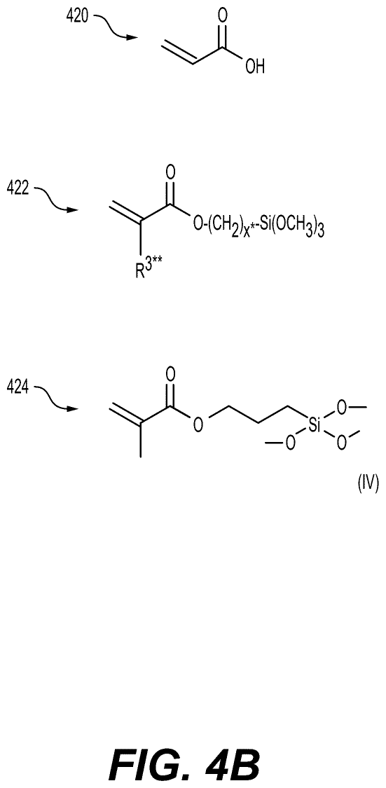

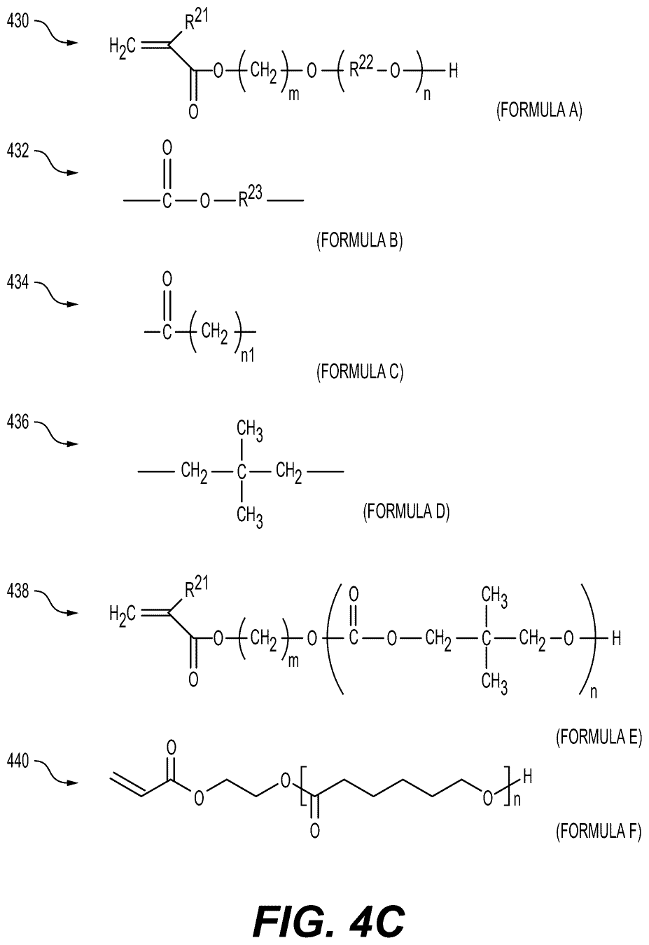

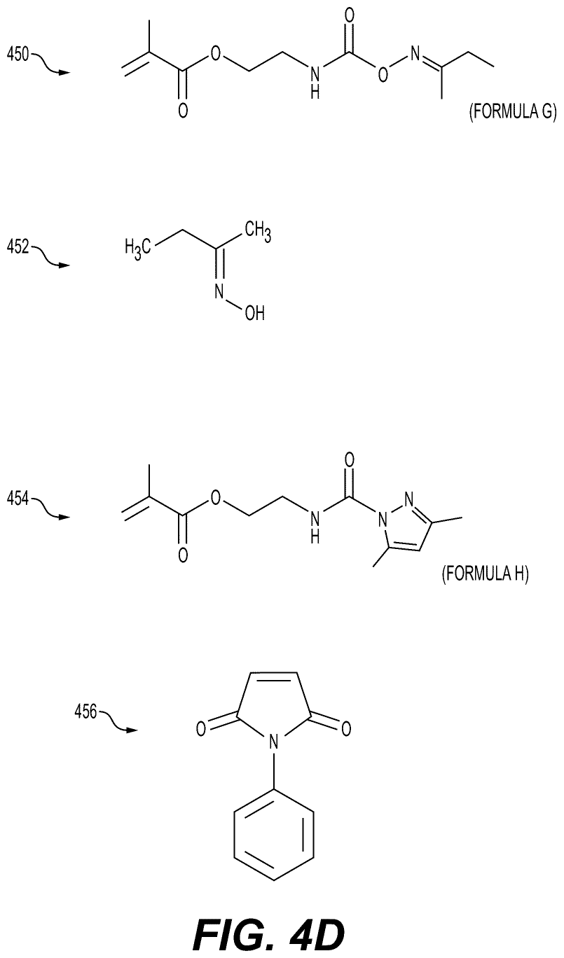

In certain aspects, the reactive composition comprises a styrene (shown as 402 in FIG. 4A). In yet further aspects, the reactive composition can further comprise a primary ethylenically unsaturated carboxylic acid ester. In aspects disclosed herein, the primary ethylenically unsaturated carboxylic acid ester is primary (meth)acrylate. In certain aspects, the primary (meth)acrylate is a monofunctional (meth)acrylate. As used herein, a monofunctional (meth)acrylate refers to an acrylic ester or a methacrylic ester in which the ester group is a saturated hydrocarbon having from 1-16 carbons, or unsubstituted aromatic ring. In certain implementations the saturated hydrocarbon is a linear hydrocarbon, for example ethyl, n-propyl, n-butyl, n-pentyl, n-hexyl. In some implementations the saturated hydrocarbon is a branched hydrocarbon, for example isopropyl, tert-butyl, 2-ethylhexyl. In certain implementations the saturated hydrocarbon can include a cyclic group, for example cyclohexyl, 1-methylcyclohexyl, or 2-isopropyl-5-methylcyclohexyl. In certain implementations the monofunctional (meth)acrylate is benzyl (meth)acrylate. In some implementations, the monofunctional (meth)acrylate has a generic Formula I, shown as 403 in FIG. 4A, wherein R¹* is selected from H and CH₃, and R¹ is C₁₋₁₂ alkyl or C₃₋₁₂ cycloalkyl. In certain implementations R¹ is a C₁₋₈ alkyl group, a C₂₋₈ alkyl group, a C₄₋₈ alkyl group, a C₆₋₈ alkyl group, or a C₆₋₁₀ alkyl group. In certain implementations R¹ is methyl, ethyl, n-butyl, 2-ethylhexyl, cyclohexyl, isobutyl, isoamyl, 2,2,2-trifluoroethyl, tert-butyl, 2-methoxyethyl, or 1-methylcyclopentyl.

In some aspects, the monofunctional (meth)acrylate can have an average molecular weight of at most about 200, but can also include (meth)acrylates having an average molecular weight (MW) of less than about 200, for example, an average molecular weight of about 198, about 184, about 170, about 168, about 156, about 154, about 142, about 128, about 114, about 100, or about 86. An average molecular weight may be within a range of any two of the foregoing values. In some aspects, the (meth)acrylates can have an average molecular weight of about 86 or greater. Examples of monofunctional (meth)acrylates are (MW is shown after each compound): methyl acrylate (86), ethyl acrylate (100), n-propyl acrylate (114), isopropyl acrylate (114), n-butyl acrylate (128), isobutyl acrylate (128), tertbutyl acrylate (128), n-pentyl acrylate (142), isopentyl acrylate (142), n-hexyl acrylate (156), cyclohexyl acrylate (154), 2-ethylhexyl acrylate (184), methyl methacrylate (100), ethyl methacrylate (114), n-propyl methacrylate (128), isopropyl methacrylate (128), n-butyl methacrylate (142), isobutyl methacrylate (142), tertbutyl methacrylate (142), n-pentyl methacrylate (156), isopentyl methacrylate (156), n-hexyl methacrylate (170), cyclohexyl methacrylate (168), 2-ethylhexyl methacrylate (198), and combinations of any of the foregoing. In some implementations, the monofunctional (meth)acrylate comprises a C₁₋₁₆ (e.g., C₁₋₁₂, C₁₋₁₀, C₁₋₈) alkyl saturated hydrocarbon group.

In yet further aspects, the monofunctional (meth)acrylate may comprise 2-ethylhexyl acrylate (2EH) (MW 184), as shown at 404 in FIG. 4A. In some aspects, the monofunctional (meth)acrylate may comprise methyl methacrylate (MMA) (MW 100). In some designs, the reactive composition can include one or more monofunctional (meth)acrylates. In some implementations, the monofunctional (meth)acrylate can comprise 2EH and MMA. In certain implementations, the reactive composition includes a single type of monofunctional (meth)acrylate. In some implementations, the single monofunctional (meth)acrylate is 2-ethylhexyl acrylate (2EH).

In still further aspects, R¹ (of Formula I) is not substituted by a silicon-comprising group (e.g., Si(Oalkyl)₃), a hydroxyl, an epoxide, or an isocyanate. In still further aspects, the monofunctional (meth)acrylate has an average molecular weight of at most about 200, and includes no silicon-comprising group (e.g., Si(Oalkyl)₃), no epoxide group, no hydroxyl group, and no isocyanate group. In still further aspects, a mass fraction of a sum of the styrene and the monofunctional (meth)acrylate in the reactive composition is in a range of about 74 to about 98.9 wt. % (e.g., about 74-91 wt. %, about 74-77 wt. %, about 77-80 wt. %, about 80-84 wt. %, about 84-88 wt. %, about 88-91 wt. %, about 91-95 wt. %, about 95-98.9 wt. %, about 84.9-91.1 wt. %, about 80-91.5 wt. %, and so on). All wt. % disclosed herein are calculated based on the total weight of the reactive monomers in the reactive composition.

In still further aspects, the styrene may be present in the reactive composition in any desirable mass fraction. In certain aspects, the mass fraction of the styrene is in a range of about 33 to about 75 wt. % (e.g., about 33-60 wt. %, about 33-50 wt. %, about 50-75 wt. %, about 33-42 wt. %, or about 38-42 wt. %).

In certain aspects, the mass fraction of the monofunctional (meth)acrylate in the reactive composition can be in a range of about 13 to about 60 wt. % (e.g., about 13-40 wt. %, about 40-55 wt. %, about 40-45 wt. %, about 45-50 wt. %, about 50-55 wt. %, or about 55-60 wt. %).

Also disclosed are methods of making a binder material. In such aspects, the method comprises carrying out emulsion polymerization of a reactive composition. In some designs, the reactive composition comprises (a) styrene, and (b) a monofunctional (meth)acrylate as defined herein. In further aspects, disclosed herein is a binder material that is made according to such a method. In yet further aspects, disclosed herein is a binder material. In some aspects, the binder material comprises a polymer comprising a polyolefin chain and pendant phenyl groups and pendant carboxylic acid ester groups attached thereto. In certain implementations, the polymer comprises no silicon, comprises no epoxide group, and comprises no hydroxyl group. In some aspects, the binder material comprises a copolymer comprising a structural unit derived from (a) a styrene monomer, and (b) an ethylenically unsaturated carboxylic acid ester monomer comprising no silicon group, comprising no epoxide group, and comprising no hydroxyl group.

In some implementations, the binder can include a copolymer of styrene and one or more monofunctional (meth)acrylates. Herein, “a copolymer of styrene and one or more monofunctional (meth)acrylates” includes monomeric units derived from styrene (e.g., units obtained upon polymerization of the styrene) and monomeric units derived from the one or more monofunctional (meth)acrylates. In some designs, these one or more monofunctional (meth)acrylates may include the monofunctional (meth)acrylates as described herein. In addition, “a copolymer of styrene and one or more monofunctional (meth)acrylates” may include monomeric units other than those derived from the styrene and the one or more monofunctional (meth)acrylates. For example, such a copolymer may include monomeric units derived from multifunctional (meth)acrylates, as described herein. For example, such a copolymer may include units derived from other components of a reactive composition (e.g., as employed in emulsion polymerization) and/or units derived from components of a surfactant composition (e.g., as employed in emulsion polymerization). Ordinarily, the copolymer of the binder is present in an aqueous dispersion.

In some implementations, the binder can include monomeric units derived from styrene (styrene units) and monomeric units derived from one or more (meth)acrylates. In some implementations, the mass fraction of the styrene monomeric units, as a fraction of the mass of the binder excluding the mass of any portion of the binder attributable to a surfactant composition (e.g., a surfactant composition employed with a reactive composition in an emulsion polymerization process to synthesize the binder), can be in a range of about 33 to about 75 wt. % (e.g., about 33-60 wt. %, about 33-50 wt. %, about 50-75 wt. %, about 33-42 wt. %, or about 38-42 wt. %).

In some designs, the binder can include monomeric units derived from one or more (meth)acrylates. In some implementations, the binder can include monomeric units derived from one or more monofunctional (meth)acrylates. The monofunctional (meth)acrylates are as described herein with respect to the reactive composition.

In some implementations, the mass fraction of the monofunctional (meth)acrylate monomeric units, as a fraction of the mass of the binder excluding the mass of any portion of the binder attributable to a surfactant composition (e.g., a surfactant composition employed with a reactive composition in an emulsion polymerization process to synthesize the binder), can be in a range of about 13 to about 60 wt. % (e.g., about 13-40 wt. %, about 40-55 wt. %, about 40-45 wt. %, about 45-50 wt. %, about 50-55 wt. %, or about 55-60 wt. %).

In some implementations the mass fraction of a sum of the styrene monomeric units and monofunctional (meth)acrylate monomeric units, as a fraction of the mass of the binder excluding the mass of any portion of the binder attributable to a surfactant composition (e.g., a surfactant composition employed with a reactive composition in an emulsion polymerization process to synthesize the binder), is in a range of about 74 to about 98.9 wt. %.

In still further aspects, the reactive composition may comprise a macromolecule comprising oxyethylene groups and one or more (meth)acrylate groups. In other aspects, the reactive composition may comprise no such macromolecule. In certain implementations, the macromolecule is a polyethylene glycol mono(meth)acrylate or polyethylene glycol di(meth)acrylate. Polyethylene glycol mono(meth)acrylate and polyethylene glycol di(meth)acrylate are examples of (meth)acrylate-functionalized polyethylene glycol. In some implementations, polyethylene glycol mono(meth)acrylate contains a free hydroxyl group at the non-(meth)acrylate terminus. In other implementations, the polyethylene glycol mono(meth)acrylate is substituted at the non-(meth)acrylate terminus, for instance, with a methyl group. In some implementations, the macromolecule is a 3-arm polyethylene glycol (meth)acrylate, a 4-arm polyethylene glycol (meth)acrylate, or higher order multi-armed polyethylene glycol (meth)acrylate. In some implementations, each available hydroxyl group in the multi-armed polyethylene glycol is substituted by a (meth)acrylate. In some implementations, only 1 terminus or 2 termini in the multi-armed polyethylene glycol are substituted by a (meth)acrylate and the other termini are unsubstituted or substituted by alkyl. In such aspects, the macromolecule may have an average molecular weight in a range of about 400 to about 1250 (e.g., about 400-500, about 500-1220, about 1220-1250, about 500-700, about 700-1000, about 1000-1220, or about 1220-1250). In still further aspects, an average number of the oxyethylene groups in the macromolecule is in a range of about 6 to about 24 (e.g., about 6-8, about 8-24, about 8-12, about 12-19, or about 19-24). The macromolecule may have any number of oxyethylene groups that fall within the foregoing values. For example, the macromolecule may comprise the average number of the oxyethylene groups in the macromolecule is in a range of about 8 to about 24.

In still further aspects, a mass fraction of the macromolecule in the reactive composition is in a range of about 1.1 to about 2.0 wt. %. For example, the mass fraction of the macromolecule in the reactive composition may be in the range of about 1.2 to about 1.8 wt. %, or about 1.4 to about 1.8 wt. %, or about 1.1 to about 1.2 wt. %, or about 1.8 to about 2.0 wt. %, and so on.

In still further aspects, the macromolecule described herein may comprise two methacrylate groups. An exemplary macromolecule used in the reactive composition can be polyethylene glycol dimethacrylate (PEGDMA) (Formula II), shown as 405 in FIG. 4A, wherein n is an average number of repeat units and may be from about 1 to about 25 (e.g., about 1-6, about 6-8, about 8-24, about 8-12, about 12-19, about 19-24, or about 24-25). In still further aspects, the PEGDMA can be selected from compounds under the trade name NK Ester and sold by Shin-Nakamura Chemical Co., Ltd. For example, a PEGDMA such as NK Ester 14G can be utilized. NK Ester 14G is described as a “polyethylene glycol #600 dimethacrylate” with a value of n being about 14.

In some implementations, the binder can also include a macromolecule component derived from a macromolecule. The macromolecule can comprise oxyethylene groups and one or more (meth)acrylate groups, as described herein. The macromolecule can comprise (meth)acrylate-functionalized polyethylene glycol, as described herein. The macromolecules, from which the macromolecule component is derived, are described herein with respect to the reactive composition.

In certain implementations, the mass fraction of the macromolecule component, as a fraction of the mass of the binder excluding the mass of any portion of the binder attributable to a surfactant composition (e.g., a surfactant composition employed with a reactive composition in an emulsion polymerization process to synthesize the binder), can be in a range of about 1.1 to about 2.0 wt. %.

In still further aspects, the reactive composition may comprise one or more secondary (meth)acrylates. In certain aspects, a secondary (meth)acrylate is a multifunctional (meth)acrylate. As used herein, a multifunctional (meth)acrylate refers to an acrylic ester or a methacrylic ester in which the ester group includes at least one functional group other than C—H and C—C single bonds. In some implementations, the multifunctional (meth)acrylate includes one or more hydroxyl groups, epoxide groups, isocyanate groups, amine groups (including primary, secondary, tertiary, and quaternary amine groups), carboxylate groups, thiol groups, silicon-comprising groups, azide groups, alkyne groups, or combinations thereof. In some implementations, the multifunctional (meth)acrylates are of molecular weights of less than about 400. In some implementations, a multifunctional (meth)acrylate comprises at least one of the following: (1) an epoxide group, (2) a hydroxyl group, and (3) an isocyanate group. In some aspects, the one or more multifunctional (meth)acrylates may have a generic formula (Formula III), shown as 406 in FIG. 4A, wherein R²* is H or CH₃, and R² is selected from C₁-C₁₀ alkyl, C₁-C₁₀ alkoxy, C₃-C₁₀ cycloalkyl, C₆-C₁₅ aryl, C₁-C₁₃ heteroaryl, C₃-C₁₅ heterocycloalkyl, or C₁-C₁₅ heteroalkyl, and wherein R² includes at least one epoxide group. In some implementations R² is a C₆ alkyl group and R² includes a terminal epoxide group having the formula shown as 408 in FIG. 4A.

In certain implementations the multifunctional (meth)acrylate comprising an epoxide group can have the formula shown as 410 in FIG. 4A, wherein R³* is selected from H and CH₃, and x is from 1 to 8, preferably 1-6, 1-2, 2-4, 1, 2, or 3. In some implementations, x is 1.

An exemplary compound of a multifunctional (meth)acrylate comprising an epoxide group may be glycidyl methacrylate (GMA) (Formula IIIa) which is shown as 412 in FIG. 4A.

In some implementations, R² (of generic Formula III, 406) can be substituted by at least one hydroxyl group, preferably a terminal hydroxyl group. In certain implementations R² can have a formula —(CH₂)_{x′}OH, wherein x′ is from 2 to 8.

In still further aspects, the multifunctional (meth)acrylate comprises a (meth)acrylate comprising a hydroxyl group. In certain implementations the multifunctional (meth)acrylate comprising a hydroxyl group can have the formula shown as 414 in FIG. 4A, wherein R³*′ is selected from H and CH₃, and x′ is from 2 to 8, preferably 2-6, 2-4, 2, or 3. In some implementations, x′ is 2.

In certain implementations, an exemplary compound of the multifunctional (meth)acrylate comprising a hydroxyl group may be hydroxyethylmethacrylate (HEMA) (molecular weight of about 130) (Formula IIIb) shown as compound 416 in FIG. 4A.

In some aspects, a multifunctional (meth)acrylate comprises a hydroxyl group and has a Formula A (shown as 430 in FIG. 4C), wherein R²¹ is selected from CH₃ and H, R²² is a divalent organic group, m is in a range of 1 to 4 (e.g., 1-2, 2, or 2-4), and n is in a range of 0 to 20 (e.g., 0-1, 1, 1-20, 1-10, 1-6, 1-4, 1-3, or 1-2). Examples of R²² include: (1) an alkylene group, (2) a cycloalkylene group, (3) a group of Formula B (shown as 432 in FIG. 4C), and (4) a group of Formula C (shown as 434 in FIG. 4C), wherein R²³ is an alkylene group having 1 to 10 (e.g., 1-8, 1-6, 1-5, or 1-4) carbon atoms, and n1 is in a range of 1 to 20 (e.g., 1-10, 1-6, 1-5, or 1-4). An alkylene group (e.g., of R²² or of R²³) may be a straight-chain or be branched. If there are multiple divalent organic groups (R²²), they may be different from each other or be the same.

In some example compounds, R²² is represented by Formula B and R²³ is an alkylene group represented by Formula D (436 in FIG. 4C). Accordingly, such example compounds may also be represented by Formula E (438 in FIG. 4C). A compound of Formula E in which R²¹ is CH₃, m is 2, and n is 1 is sold by DAICEL Corporation under the trade name PLACCEL HEMAC1 (MW of about 260, sometimes referred to herein as HEMAC1). HEMAC1 was employed in some of the examples described herein.

In some example compounds, R² is represented by Formula C, m is 2, and n1 is 5. Some of such example compounds are sold by DAICEL Corporation under the trade names PLACCEL FA and PLACCEL FM. In the PLACCEL FA series of compounds, R²¹ is H; these are caprolactone-modified hydroxyalkyl acrylates. In the PLACCEL FM series of compounds, R²¹ is CH₃; these are caprolactone-modified hydroxyalkyl methacrylates. The PLACCEL FA series of compounds are represented by Formula F (shown as 440 in FIG. 4C).

In some of the examples described herein, PLACCEL FA2D, a compound in the PLACCEL FA series and sometimes referred to herein as FA2D, was employed. The molecular weight of FA2D is about 344 (the average value of n for FA2D is about 2).

In some aspects, a multifunctional (meth)acrylate comprises an isocyanate group. In some implementations, the isocyanate group may be a blocked isocyanate group. An example compound is 2-(O-[1′-Methylpropylideneamino]carboxyamino) ethyl methacrylate, represented by Formula G (shown as 450 in FIG. 4D). This blocked isocyanate compound represented by Formula G is sold by RESONAC Corporation under the trade name KARENZ MOI-BM (MW of about 242.27, sometimes referred to herein as MOI-BM). MOI-BM was employed in some of the examples described herein. The blocked isocyanate group in MOI-BM is blocked by methyl ethyl ketone oxime (shown as 452 in FIG. 4D). Another example compound is 2-[(3,5-dimethylpyrazolyl) carboxyamino]ethyl methacrylate, represented by Formula H (shown as 454 in FIG. 4D). This blocked isocyanate compound represented by Formula H is sold by RESONAC Corporation under the trade name KARENZ MOI-BP (MW of about 251.28, sometimes referred to herein as MOI-BP). The blocked isocyanate group in MOI-BP is blocked by a pyrazole group.

In some implementations, the mass fraction of the multifunctional (meth)acrylate(s) comprising at least one of (1) an epoxide group, (2) a hydroxyl group, and (3) an isocyanate group in the reactive composition is in a range of about 4 to about 21 wt. % (e.g., about 4-7 wt. %, about 4-13 wt. %, about 5-15 wt. %, about 7-21 wt. %). In certain implementations, the reactive composition includes a single multifunctional (meth)acrylate. In other implementations, the reactive composition includes two or more different multifunctional (meth)acrylates; examples of such combinations are (1) a multifunctional (meth)acrylate including an epoxide (e.g., GMA) and a multifunctional (meth)acrylate including a hydroxyl (e.g., HEMA, Formula A compounds such as HEMAC1 and FA2D) and (2) a multifunctional (meth)acrylate including an epoxide (e.g., GMA), and a multifunctional (meth)acrylate including an isocyanate group (e.g., a compound comprising a blocked isocyanate group such as FOI-BM and FOI-BP).

In some implementations, the reactive composition can comprise a compound comprising silicon. In some implementations, the silicon-comprising compound may be multifunctional (meth)acrylate comprising silicon. In some implementations, R² (of generic Formula III, 406) can be substituted by at least one silicon-comprising group (e.g., Si(OR^{s})₃), wherein R^{s} is a C₁₋₄ alkyl group. In some implementations, the compound is a silicon-substituted (meth)acrylate having the formula shown as 422 in FIG. 4B, wherein R³** is selected from H and CH₃, and x* is from about 2 to about 16, e.g., about 2-8, about 2-6, about 2-4, about 3-5, about 4-8, about 2, about 3, or about 4. In some implementations, x* is about 3.

For example, the silicon-comprising compound can be 3-(trimethoxysilyl)propyl methacrylate (TMSPMA) (Formula IV) (MW of about 248), shown as 424 in FIG. 4B.

In some implementations, the mass fraction of the silicon-comprising (meth)acrylate in the reactive composition is in a range of about 0.1 to about 1.0 wt. %, (e.g., about 0.1-0.5 wt. %, about 0.5-1.0 wt. %, about 0.1-0.2 wt. %, about 0.2-0.3 wt. %, about 0.25-1 wt. %, about 0.25-0.75 wt. %, about 0.25-0.5 wt. %, about 0.3-0.6 wt. %, about 0.3-0.5 wt. %, about 0.3-0.45 wt. %, about 0.4-0.5 wt. %, or about 0.35-0.5 wt. %). In some implementations, the reactive composition may be free of silicon-comprising compounds.

In some implementations, the reactive composition can comprise a compound comprising a maleimide. An exemplary compound comprising a maleimide is N-phenylmaleimide, shown as 456 in FIG. 4D. N-phenylmaleimide has a molecular weight of about 173.16 and is sold by NIPPON SHOKUBAI, Co., Ltd., under the trade name IMILEX-P. In some implementations, the mass fraction of the maleimide-comprising compound in the reactive composition is in a range of about in the reactive composition is in a range of about 4 to about 21 wt. % (e.g., about 4-10 wt. %, about 6-8 wt. %, about 10-15 wt. %, or about 15-21 wt. %).

In some implementations, the binder can include monomeric units derived from one or more multifunctional (meth)acrylates. As used herein, a multifunctional (meth)acrylate refers to an acrylic ester or a methacrylic ester in which the ester group includes at least one functional group other than C—H and C—C single bonds. Such multifunctional (meth)acrylates are described herein with respect to the reactive composition.

In certain implementations, the binder includes a monomeric unit derived from glycidyl methacrylate (Formula IIIa, 412). In certain implementations, the binder includes a monomeric unit derived from hydroxyethylmethacrylate (Formula IIIb, 416). In certain implementations, the binder includes a monomeric unit derived from HEMAC1 (Formula E, 438, provided that R^{2′} is CH₃, m is 2, and n is 1). In certain implementations, the binder includes a monomeric unit derived from FA2D (Formula F, 440, provided that the molecular weight is about 344). In certain implementations, the binder includes a monomeric unit derived from FA2D (Formula F, 440, provided that the molecular weight is about 344). The multifunctional (meth)acrylate units derived from multifunctional (meth)acrylates comprising at least one of (1) an epoxide group, (2) a hydroxyl group, and (3) an isocyanate group can be present in the binder in a mass fraction from in a range of about 4 to about 21 wt. %. This mass fraction is expressed as a fraction of the mass of the binder excluding the mass of any portion of the binder attributable to a surfactant composition (e.g., a surfactant composition employed with a reactive composition in an emulsion polymerization process to synthesize the binder).

In certain implementations, the binder includes monomeric units derived from silicon-comprising compounds, as described herein with respect to the reactive composition. In certain implementations, the binder includes monomeric units derived from multifunctional (meth)acrylates comprising silicon, as described herein with respect to the reactive composition. In certain implementations, the binder includes monomeric units derived from 3-(trimethoxysilyl)propyl methacrylate (TMSPMA) (Formula IV, 424). In some implementations, the binder includes siloxane (—Si—O—Si—) moieties.

In certain implementations, the mass fraction of the silicon-comprising (meth)acrylate units, as a fraction of the mass of the binder excluding the mass of any portion of the binder attributable to a surfactant composition (e.g., a surfactant composition employed with a reactive composition in an emulsion polymerization process to synthesize the binder), is in a range of about 0.1 to about 0.5 wt. % or in a range of about 0.1 to about 1.0 wt. %. In some implementations, the binder may be free of silicon-comprising (meth)acrylate units, or the mass fraction of silicon-comprising (meth)acrylate units may be less than about 0.1 wt. %. In some implementations, the binder may be free of silicon groups. In other implementations, the mass fraction of the silicon-comprising (meth)acrylate units, as a fraction of the mass of the binder excluding the mass of any portion of the binder attributable to a surfactant composition, may be higher than about 1.0 wt. %.

In still further aspects, the reactive composition may further comprise one or more of an ethylenically unsaturated carboxylic acid and/or an ethylenically unsaturated carboxylic acid salt. The ethylenically unsaturated carboxylic acid salt may be an alkali salt (e.g., Li, Na, K), an alkaline earth salt (e.g., Mg, Ca), an ammonium salt (NH₄), or an alkylammonium salt (NRⁿ₄), wherein Rⁿ is a C₁₋₄ alkyl group. In such aspects, the ethylenically unsaturated carboxylic acid salt may comprise an ethylenically unsaturated carboxylic acid lithium salt, an ethylenically unsaturated carboxylic acid sodium salt, an ethylenically unsaturated carboxylic acid potassium salt, and/or an ethylenically unsaturated carboxylic acid ammonium salt. In certain implementations, α,β-ethylenically unsaturated monocarboxylic or dicarboxylic acids and/or their salts may be used. In certain aspects, the ethylenically unsaturated carboxylic acid may comprise acrylic acid (AA), methacrylic acid, fumaric acid, maleic acid, or any combination thereof. In still further aspects, the ethylenically unsaturated carboxylic acid may comprise acrylic acid (AA). Acrylic acid (AA) is shown as 420 in FIG. 4B.

In still further aspects, one or more of the ethylenically unsaturated carboxylic acid and their salts (such as, for example, the ethylenically unsaturated carboxylic acid lithium salt, the ethylenically unsaturated carboxylic acid sodium salt) may advantageously be present in the reactive composition in a mass fraction in a range of about 0.1 to about 4.9 wt. % (e.g., about 0.5-4.9 wt. %, about 1-4.9 wt. %, about 2-4.9 wt. %, about 3-4.9 wt. %, about 4-4.9 wt. %, about 2-4 wt. %, about 3-4 wt. %, about 2-3 wt. %, about 0.2-1.8 wt. %, about 2.5-4.8 wt. %, or about 3.0-4.8 wt. %).

In still further aspects, the binder may further comprise monomeric units derived from one or more of an ethylenically unsaturated carboxylic acid and an ethylenically unsaturated carboxylic acid salt. The ethylenically unsaturated carboxylic acids and the ethylenically unsaturated carboxylic acid salts are as described herein with respect to the reactive composition.

In some implementations, the mass fraction of the monomeric units derived from one or more of the ethylenically unsaturated carboxylic acids and their salts, as a fraction of the mass of the binder excluding the mass of any portion of the binder attributable to a surfactant composition (e.g., a surfactant composition employed with a reactive composition in an emulsion polymerization process to synthesize the binder), is in a range of about 0.1 to about 4.9 wt. % (e.g., about 0.2-1.8 wt. %, about 2.5-4.8 wt. %, about 3.0-4.8 wt. %).

In still further aspects, the emulsion polymerization is carried out in the presence of a surfactant composition. In such aspects, the surfactant composition may comprise reactive and nonreactive surfactants. Surfactants may be anionic, cationic, zwitterionic, nonionic or any combination thereof. In aspects disclosed herein, a mass of the surfactant composition is in a range of about 1.0 to about 6.0% of a total mass of the reactive composition (e.g., about 1.0-5.0%, about 1.0-3.0%, about 2.0-5.0%, about 3.0-5.0%, about 4.0-5.0%, about 2.0-3.0%, about 2.0-4.0%, about 3.0-5.0%, about 5.0-6.0%, or about 3.0-4.0%). In some implementations, the mass of the surfactant composition (relative to the total mass of the reactive composition) is in a range from about 0.25 to about 2.0% (e.g., about 0.5-2.0%, about 0.5-1.5%, about 0.75-1.25%, about 0.75-1.5%, about 0.5-1.0%, about 1.0-1.5%, about 1.5-2.0%, or about 1.0-2.0%). For the purposes of the present disclosure, the surfactant composition (whether it includes a reactive surfactant or a nonreactive surfactant) is not counted in the total mass of the reactive components in the reactive composition.

In certain aspects, the surfactant composition may comprise one or more surfactants. In such aspects, at least one of the surfactants present in the surfactant composition is a nonreactive surfactant. The term “nonreactive” can be understood as a surfactant that does not participate in the polymerization but is present as a reaction media. In such aspects, the at least one nonreactive surfactant comprises an anionic nonreactive surfactant and/or a nonionic nonreactive surfactant.

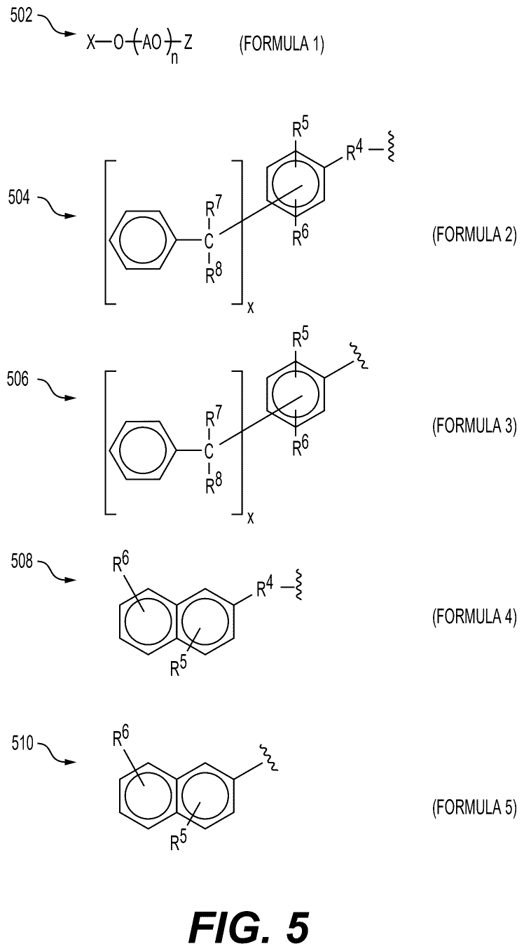

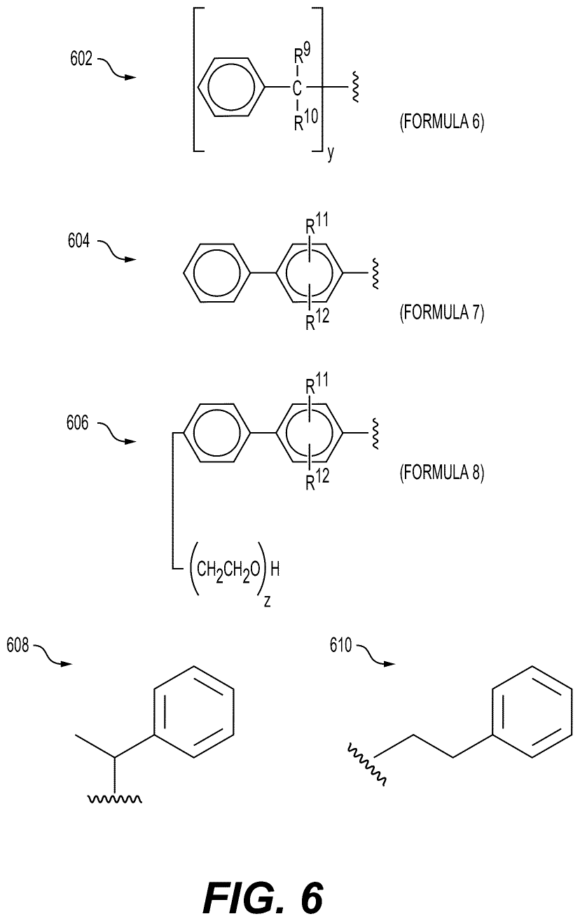

Examples of nonreactive surfactants are shown in FIGS. 5 and 6. In certain aspects, the nonreactive surfactants comprise a compound of Formula 1 (502 in FIG. 5), wherein X is a hydrocarbyl group comprising two or more aryl groups, wherein the two or more aryl groups are linked through at least one carbon or are fused; wherein AO is a C₂-C₅ alkyleneoxy group; Z is SO₃M or H; M is selected from H, an alkali metal, an alkaline earth metal, ammonium, or an alkylammonium (alkyl-substituted ammonium); and wherein n represents an average number of the alkyleneoxy groups, n is in a range of about 3 to about 120 (e.g., about 3-100, about 5-100, about 3-50, about 3-40, about 40-80, about 80-120, or about 4-14).

In still further aspects, X can be selected from chemical groups of Formulas 2 (504, FIG. 5), 3 (506, FIG. 5), 4 (508, FIG. 5), and 5 (510, FIG. 5), wherein R⁴ is a linear hydrocarbon group of 1 to 3 carbon atoms; wherein each of R⁷ and R⁸ is, independently, H or a linear hydrocarbon group of 1 to 3 carbon atoms; wherein x is 1, 2, or 3; and wherein each of R⁵ and R⁶ is, independently, H, a linear hydrocarbon group of 1 to 3 carbon atoms, or a group represented by Formula 6 (602, FIG. 6), wherein each of R⁹ and R¹⁰ is, independently, H or a linear hydrocarbon group of 1 to 3 carbon atoms; and wherein y is 1, 2, or 3.

In still further aspects, X can be selected from Formulas 7 (604, FIG. 6) and 8 (606, FIG. 6), wherein each of R¹¹ and R¹² is, independently, H or a linear hydrocarbon group of 1 to 3 carbon atoms; and wherein z is an integer greater than or equal to 2.

In yet still further aspects, X may be selected from a styrenated phenyl group, a styrenated methylphenyl group, a distyrenated phenyl group, a distyrenated methylphenyl group, and a tristyrenated phenyl group. A group is “styrenated” when it is substituted with a group having the formula shown as 608 (FIG. 6) or the formula shown as 610 (FIG. 6) or a combination thereof. A “distyrenated” group includes two of the above substituents, and a “tristyrenated” group includes three of the above substituents.

In still further aspects, the nonreactive surfactant may be selected from surfactants known by the tradename of NEWCOL® and sold by Nippon Nyukazai Co. Ltd. For example, nonreactive surfactants such as NEWCOL® 707-SF, NEWCOL® 740, NEWCOL® 704, NEWCOL® 714, and NEWCOL® CMP-11 may be effectively utilized. NEWCOL® 740, NEWCOL® 704, NEWCOL® 714, and NEWCOL® CMP-11 are examples of nonionic nonreactive surfactants. NEWCOL® 707-SF is an example of an anionic nonreactive surfactant. NEWCOL® CMP-11 comprises a compound of Formula 1, wherein AO is a CH₂CH₂O group, Z is H, and X is a group of Formula 3 in which x is 1, each of R⁵ and R⁶ is H, and each of R⁷ and R⁸ is CH₃. The hydrophilic-lipophilic balance (HLB) value of NEWCOL® CMP-11 is reported to be about 13.9. Each of NEWCOL® 740, NEWCOL® 723, NEWCOL® 714, and NEWCOL® 704 comprises a compound of Formula 1, wherein AO is a CH₂CH₂O group, Z is H, and X comprises two or more phenyl groups (e.g., X may comprise Formula 2, Formula 3, Formula 4, Formula 5, Formula 7, or Formula 8). The HLB values of NEWCOL® 740, NEWCOL® 723, NEWCOL® 714, and NEWCOL® 704 are reported to be 17.9, 16.6, 15.0, and 9.2, respectively. NEWCOL® 707-SF comprises a compound of Formula 1, wherein AO is a CH₂CH₂O group, Z is SO₃M, M is Na or NH₄, and X comprises two or more phenyl groups (e.g., X may comprise Formula 2, Formula 3, Formula 4, Formula 5, Formula 7, or Formula 8). In some implementations, the HLB values of nonionic nonreactive surfactants may be chosen to be in a range of about 8 to about 18 (e.g., about 8-11, about 9-11, about 11-13, about 13-15, about 15-17, or about 15-18).

In still further aspects, the nonreactive surfactant may be selected from surfactants known by the tradenames of HITENOL® and NOIGEN® and sold by DKS Co. Ltd. (Daiichi Kogyo Seiyaku). For example, nonreactive surfactants such as HITENOL® NF-08, HITENOL® NF-13, NOIGEN® EA-87, NOIGEN® EA-167, NOIGEN® EA-177, and NOIGEN® EA-197D may be effectively utilized. NOIGEN® EA-87, NOIGEN® EA-167, NOIGEN® EA-177, and NOIGEN® EA-197D are examples of nonionic nonreactive surfactants. HITENOL® NF-08 and HITENOL® NF-13 are examples of anionic nonreactive surfactants. Each of NOIGEN® EA-87, NOIGEN® EA-167, NOIGEN® EA-177, and NOIGEN® EA-197D comprises a compound of Formula 1, wherein AO is a CH₂CH₂O group, Z is H, n is in a range of 5 to 100, and X comprises a styrenated phenyl group. The HLB values of NOIGEN® EA-87, NOIGEN® EA-167, NOIGEN® EA-177 and NOIGEN® EA-197D are reported to be 10.6, 14.8, 15.6, and 17.5, respectively. Each of HITENOL® NF-08 and HITENOL® NF-13 comprises a compound of Formula 1, wherein AO is a CH₂CH₂O group, Z is SO₃M, M is NH₄, and X comprises a styrenated phenyl group.

A surfactant composition may comprise a single surfactant or two or more surfactants in combination. In some implementations of surfactant compositions for use in emulsion polymerization, the use of an anionic surfactant and a nonionic surfactant in combination may be preferable. Both anionic and nonreactive surfactants may contribute to stabilizing an emulsion. For example, an anionic surfactant may contribute to stabilization of an emulsion through ionic repulsion of the particles, and a nonionic surfactant may contribute to stabilization of an emulsion through formation of a hydrophilic layer. In some cases, the stabilization effect of an anionic surfactant may be quite significant. In some cases, a surfactant composition may comprise anionic surfactant(s) and no nonionic surfactant(s). However, there may be some disadvantages to anionic surfactants if used singly in a surfactant composition: for example, the particle sizes may be too small, the viscosity may be too high, and the emulsion may be readily affected by pH or cationic species. Accordingly, in some implementations, it may be preferable to employ anionic and nonionic surfactants in combination. In some instances of such a combination, the mass ratio of the anionic surfactant(s) to the nonionic surfactant(s) may be in a range of about 1:3.5 to about 3.5:1 (e.g., about 1:3-3:1, about 1:2.5-2.5:1, about 1:2-2:1, about 1:1.5-1.5:1, about 1:1.2-1.2:1, or about 1:1.1-1.1:1). In some instances of such a combination, the mass ratio of the anionic surfactant(s) to the nonionic surfactant(s) may be in a range of about 1:3.5 to about 1:3 (e.g., about 1:3-1:2.5, about 1:2.5-1:2, about 1:2-1:1.5, about 1:1.5-1:1.2, about 1:1.2-1:1.1, or about 1:1.1-1:1. In certain implementations, the anionic surfactant(s) and nonionic surfactant(s) are present in approximately equal mass amounts. In certain implementations, the surfactant composition can comprise ionic nonreactive surfactant(s) (e.g., NEWCOL® 707-SF, HITENOL® NF-08, HITENOL® NF-13) and nonionic nonreactive surfactant(s) (e.g., NEWCOL® 707-SF, NEWCOL® 740, NEWCOL® 704, NEWCOL® 714, NEWCOL® CMP-11, NOIGEN® EA-87, NOIGEN® EA-167, NOIGEN® EA-177, NOIGEN® EA-197D).

In certain implementations, the surfactant composition includes one or more nonreactive surfactants and does not include a reactive surfactant (as defined herein). In other implementations, the surfactant composition includes one or more nonreactive surfactants, and one or more reactive surfactants.

In still further aspects, the surfactant composition can include a reactive surfactant, which includes at least one reactive functional group. Illustrative examples of such reactive polymeric surfactants include but are not limited to: (i) non-ionics, such as vinyl polyalkylene glycol ether, dodecyl polyethylene oxide maleate, alkenyl carboxy functional hydrophobe, polyalkylene glycol methacrylate, methoxy polyalkylene glycol methacrylate, among others; and (ii) ionics, such as allyl-alkyl sulfate, hexadecyl maleic hemiester, methacryloyloxyethyl maleate, methacryloyloxyethyl succinate, among others.

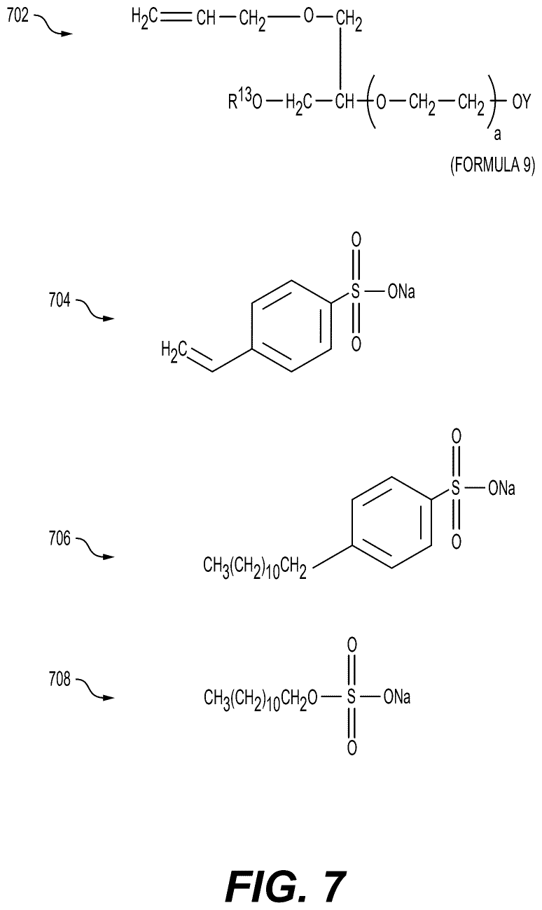

In yet still further aspects, the surfactants disclosed herein may comprise at least one reactive surfactant. In such aspects, the at least one reactive surfactant may be a compound of Formula 9 (shown as 702 in FIG. 7), wherein R¹³ is an alkyl group, Y is H or SO₃M′, wherein M′ is selected from H, an alkali metal, alkaline earth metal, ammonium ion, or an alkyl-substituted ammonium ion and a is in a range of about 10 to about 40, including exemplary values of about 15, about 20, about 25, about 30, and about 35 (note that each of the foregoing example values may constitute an upper bound or a lower bound to a sub-range that is bounded to any of the other stated values, as explained in a preceding paragraph related to numerical ranges). In some implementations, Y is SO₃NH₄ or SO₃Na. In some implementations, R¹³ is an alkyl (e.g., C₁-C₂₀, C₁-C₁₀, C₁-C₈, C₁-C₆, C₁-C₄, C₂-C₁₀, C₂-C₆, C₄-C₈, C₆-C₁₂, C₆-C₂₀, C₈-C₂₀, or C₁₀-C₂₀) group.

In still further aspects, the reactive surfactant may be selected from surfactants known by the tradename of ADEKA REASOP® and sold by ADEKA Corporation. For example, reactive surfactants such as ADEKA REASOP® SR-20, ADEKA REASOP® SR-3090, ADEKA REASOP® ER-20, ADEKA REASOP® ER-30, and ADEKA REASOP® ER-40 can be utilized. ADEKA REASOP® SR-20 and ADEKA REASOP® SR-3090 are examples of anionic reactive surfactants. ADEKA REASOP® ER-20, ADEKA REASOP® ER-30, and ADEKA REASOP® ER-40 are examples of nonionic reactive surfactants. Each of ADEKA REASOP® SR-20 and ADEKA REASOP® SR-3090 comprises a compound of Formula 9, wherein Y is a SO₃NH₄ group. The value of a is about 20 for ADEKA REASOP® SR-20 and about 30 for ADEKA REASOP® SR-3090. Each of ADEKA REASOP® ER-20, ADEKA REASOP® ER-30, and ADEKA REASOP® ER-40 comprises a compound of Formula 9, wherein Y is H. The value of a is about 20 for ADEKA REASOP® ER-20, about 30 for ADEKA REASOP® ER-30, and about 40 for ADEKA REASOP® ER-40.

In certain implementations, the surfactant compositions comprise anionic reactive surfactant(s) and nonionic reactive surfactant(s) in combination. In certain implementations the nonionic reactive surfactant is present in a greater amount relative to the anionic reactive surfactant. In certain implementations, the anionic reactive surfactant is present (relative to the nonionic reactive surfactant) in an amount in a range of about 25-50 wt. %, about 50-100 wt. %, about 50-75 wt. %, about 75-100 wt. %, or about 60-95 wt. %.

In some aspects, the surfactant composition can include a metal salt reactive surfactant such as sulfonate salts (e.g., sulfonate salt of Na or Li) and sulfate salts (e.g., sulfate salt of Na or Li). Examples of such salts are: sodium p-styrene sulfonate (NaSS) (shown as 704 in FIG. 7), lithium p-styrene sulfonate (LiSS), sodium dodecylbenzenesulfonate (NaDDBS) (shown as 706 in FIG. 7), and sodium dodecyl sulfate (SDS) (shown as 708 in FIG. 7). In certain implementations the reactive surfactant is a combination of an anionic reactive surfactant, a nonionic reactive surfactant, and a sulfonate salt and/or a sulfate salt (e.g., NaSS, LiSS, NaDDBS, SDS). When present in such a combination, the sulfonate salt and/or the sulfate salt may be present in an amount (relative to the nonionic reactive surfactant) that is in a range from about 10 to about 60 wt. % (e.g., about 10-40 wt. %, about 10-30 wt. %, about 20-40 wt. %, about 30-50 wt. %, or about 40-60 wt. %). Alternatively, when present in such a combination, the sulfonate salt and/or the sulfate salt may be present in an amount (relative to the total reactive surfactant) that is in a range from about 5 to about 35 wt. % (e.g., about 5-20 wt. %, about 5-15 wt. %, about 10-20 wt. %, about 15-25 wt. %, or about 20-35 wt. %). Alternatively, when present in such a combination, the sulfonate salt and/or the sulfate salt may be present in an amount (relative to the total reactive composition) that is in a range from about 0.1 to about 1.3 wt. % (e.g., about 0.1-0.6 wt. %, about 0.1-0.4 wt. %, about 0.3-0.8 wt. %, about 0.5-1.0 wt. %, or about 0.7-1.3 wt. %). In some implementations, the reactive surfactant composition comprises a sulfonate salt and/or a sulfate salt (e.g., NaSS, LiSS, NaDDBS, SDS) at relatively high mass fractions (e.g., in a range of about 50 to about 100 wt. %) and the mass fractions of the anionic reactive surfactants and the nonreactive reactive surfactants may be relatively low. In some examples, the sulfonate salt and/or the sulfate salt may be the sole reactive surfactant. In some examples, the sulfonate salt and/or the sulfate salt may be present in an amount (relative to the total reactive composition) that is in a range from about 1.0 to about 3.5 wt. % (e.g., about 1.0-2.0 wt. %, about 1.5-2.5 wt. %, about 2.0-3.0 wt. %, or about 2.5-3.5 wt. %).

In certain implementations, the surfactant composition includes one or more reactive surfactants, and does not include any nonreactive surfactants.

The binder may further include one or more surfactants, including the surfactants as described herein (e.g., nonionic nonreactive surfactants, anionic nonreactive surfactants, nonionic reactive surfactants, anionic reactive surfactants, sulfonate and/or sulfate salts such as NaSS, LiSS, NaDDBS, SDS). In some implementations, the binder includes a surfactant that is covalently incorporated into the copolymer. In some implementations, the surfactant is not covalently incorporated into the copolymer but is rather associated with the binder through non-covalent interactions, for example, as an interpenetrating network or an entangled system. In aspects disclosed herein, a mass of the surfactant(s), relative to the mass of the binder excluding the mass of any portion of the binder attributable to a surfactant composition (e.g., a surfactant composition employed with a reactive composition in an emulsion polymerization process to synthesize the binder), is in a range of about 1.0 to about 6.0% (e.g., about 1.0-5.0%, about 1.0-3.0%, about 2.0-5.0%, about 3.0-5.0%, about 4.0-5.0%, about 2.0-3.0%, about 2.0-4.0%, about 3.0-5.0%, about 5.0-6.0%, or about 3.0-4.0%). In some other implementations, the mass of the surfactant(s), relative to the mass of the binder excluding the mass of any portion of the binder attributable to a surfactant composition (e.g., a surfactant composition employed with a reactive composition in an emulsion polymerization process to synthesize the binder), can be higher than about 6.0%, and in yet some other implementations, the mass of the surfactants can be lower than about 1.0%.

In certain implementations, the binder includes one or more nonreactive surfactants, as described herein with respect to the surfactant composition. Nonreactive surfactants are those which are not covalently incorporated into the copolymer. In some designs, the binder can include a cationic nonreactive surfactant, an anionic nonreactive surfactant, a nonionic nonreactive surfactant, or a combination thereof. In certain implementations, the binder includes an anionic nonreactive surfactant and nonionic nonreactive surfactant.

In certain implementations, the binder includes one or more reactive surfactants, and does not include any nonreactive surfactants.

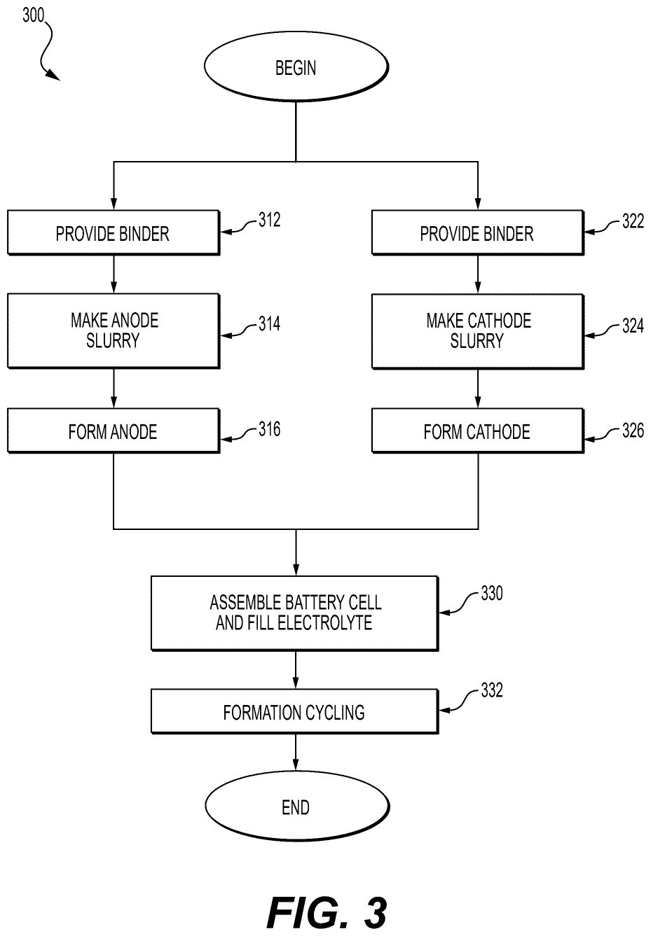

FIG. 3 illustrates an example method (300) for the formation of a Li-ion battery. This example shows the formation of both electrodes (anode and cathode). For example, the left branch relates to the formation of an anode, including stages 312, 314, and 316. On the other hand, the right branch relates to the formation of a cathode, including stages 322, 324, and 326. For each of the branches, an electrode (an anode or a cathode) may be formed by casting from a slurry onto a current collector, as described herein.

In still further aspects, the left and right branches may be carried out concurrently or sequentially as desired. In addition, method 300 also includes stage 330 after the production of the anode and the cathode, which includes assembling of the battery cell and filling the cell with an electrolyte. In such aspects disclosed herein, a battery electrode prepared by the methods shown in FIG. 3. The battery electrode can comprise a current collector; and an electrode material disposed on and/or in the current collector (e.g., if the current collector is porous or has a rough or porous surface). In still further aspects, the electrode material may be disposed as a coating. In still further aspects, the coating may have an average thickness in a range of about 5 μm to about 100 μm (e.g., about 5-10 μm, about 10-20 μm, about 20-40 μm, about 40-60 μm, about 60-80 μm, or about 80-100 μm). The electrode material can comprise a battery electrode composition and the binder formed by the methods disclosed herein.

In still further aspects, the battery electrode composition can comprise active materials suitable for a specific battery. In some aspects, the battery electrode composition may comprise, for example, graphite active materials, silicon oxide or silicon-comprising active materials (including composites or nanocomposites, such as Si—C nanocomposites, among others), metal oxide and other active anode materials, conductive additives, other functional additives, but may be substantially free of conventional solvents. In certain aspects, the anode active materials may be provided as particles or as core-shell particles or composite anode particles. In still further aspects, the anode active materials can comprise Si-comprising composite particles whereby Si-comprising active material is deposited within pore(s) of a particle core.

In some aspects, the battery electrode composition, as described herein, may comprise composite particles, wherein each of the composite particles can comprise carbon and silicon. It is understood that a ratio of carbon and silicon in the composite particles can be any ratio that provides the desired battery performance. Yet in still further aspects, the silicon can be present in a mass fraction in a range of about 20 wt. % to about 75 wt. % based on the total mass of the composite particles (e.g., about 20-30 wt. %, about 30-40 wt. %, about 40-50 wt. %, about 50-60 wt. %, about 60-75 wt. %, about 25-70 wt. %, about 40-60 wt. %, or about 30-57 wt. %).

In certain aspects, each or some of the composite particles may be present in a core-shell configuration. Yet in still further aspects, at least a portion of the composite particles is present in a core-shell configuration.

In a still further aspect, the electrode material can further comprise additional fillers or functional materials. For example, in some aspects, the electrode material comprises carboxymethyl cellulose (CMC).

In aspects where the electrode material comprises carboxymethyl cellulose, a mass ratio of CMC to the binder material prepared according to the methods disclosed herein can be in a range of about 1:100 to about 2:1, including exemplary values of about 1:90, about 1:80, about 1:70, about 1:60, about 1:50, about 1:40, about 1:30, about 1:20, about 1:10, about 1:5, about 1:3, about 1:2, about 1:1, about 1.1:1, about 1.2:1, about 1.5:1, and about 2:1 (note that each of the foregoing example values may constitute an upper bound or a lower bound to a sub-range that is bounded to any of the other stated values, as explained in a preceding paragraph related to numerical ranges).

In still further aspects, the suitable electrode materials may advantageously comprise conductive fillers. The terms conductive fillers and conductive additive compositions can be used interchangeably. In such aspects, the conductive fillers or conductive additive compositions may comprise one, two or more of the following: carbon, carbon black, modified carbon, modified carbon black, dendritic carbon, graphene (incl. single-layered graphene and/or multi-layered graphene with about 2 to about 40 layers, on average (e.g., about 2-10, about 10-20, about 20-30, or about 30-40, on average), graphene oxide, graphite, exfoliated graphite, carbon nanotubes, carbon nanofibers, carbon fibers, carbon nano-flakes, graphite ribbons, carboxymethyl cellulose (CMC) (note that CMC is not conductive, but may help to disperse conductive additives), or any combination thereof.

In some aspects, the electrode material comprises lower-capacity particles. In some aspects, the lower-capacity particles have a charge capacity of about 400 mAh/g or less, including exemplary values of about 380 mAh/g or less, about 372 mAh/g or less, or 350 mAh/g or less. In still further aspects, the lower-capacity particles can comprise graphite-based active material particles. In some aspects, such graphite-based active material may comprise natural, artificial or a mixture of natural and artificial graphites. In some aspects, at least some of the graphite-based active material particles exhibit a specific capacity in a range of about 320 mAh/g to about 372 mAh/g. Graphite-based active material that may be useful in various aspects include various soft-type synthetic graphite (or soft carbon, broadly), various hard-type synthetic graphite (or hard carbon, broadly), and various natural graphite (which may, for example, be pitch carbon coated, among others); including but not limited to those which exhibit discharge capacity from about 320 to about 372 mAh/g (e.g., about 320-350 mAh/g; about 350-362 mAh/g; or about 362-372 mAh/g).

In still further aspects, the composite particles and lower-capacity particles can be present in any ratio that provides for desired battery performance. In some aspects, a mass ratio of the composite particles to the lower-capacity particles is in a range of about 10:90 to about 99:1, including exemplary values of about 15:85, about 20:80; about 30:70, 40 about:60, about 50:50, about 60:40, about 70:30, about 80:20, about 90:10, and about 95:5 (note that each of the foregoing example values may constitute an upper bound or a lower bound to a sub-range that is bounded to any of the other stated values, as explained in a preceding paragraph related to numerical ranges).

While the description below may describe certain examples of suitable intercalation-type graphites to be used in combination with Si—C nanocomposite (e.g., particles) in a blend, it will be appreciated that various aspects of this disclosure may be applicable to soft-type synthetic graphite (or soft carbon, broadly), hard-type synthetic graphite (or hard carbon, broadly), and natural graphite (which may, for example, be pitch carbon coated); including but not limited to those which exhibit discharge capacity from about 320 to about 372 mAh/g (e.g., about 320-350 mAh/g; about 350-362 mAh/g; or about 362-372 mAh/g); including but not limited to those which exhibit low, moderate and high swelling; including but not limited to those which exhibit good and poor compression, including but not limited to those which exhibit Brunauer-Emmett-Teller (BET) specific surface area of about 0.5 to about 8 m²/g (about 0.5-2 m²/g; about 2-4 m²/g; or about 4-8 m²/g); including but not limited to those which exhibit lithiation efficiency of about 90% and more; including but not limited to those which exhibit average particle sizes from about 8 μm to about 18 μm; including but not limited to those which exhibit true densities ranging from about 1.5 g/cm³ to about 2.3 g/cm³ (e.g., about 1.5-1.8 g/cm³, or about 1.8 to about 2.3 g/cm³); including but not limited to those which exhibit poor, moderate, or good cycle life when used in Li-ion battery anodes on their own (e.g., without Si—C composites or other active particles); including but not limited to those which are coated and comprise coatings with coating thickness to appreciably improve compression and springing during cycling.

Referring back to FIG. 3, the method of forming the electrode first comprises providing a binder (stages 312 and 322). The binder for the anode and the cathode can be the same or different. Yet in still further aspects, the binder provided for the anode is the binder formed by the methods disclosed herein. In still further aspects, the method comprises a stage 314 of making an anode slurry.

In certain aspects, the conductive fillers or additives disclosed above may be mixed with the electrode active material to form a slurry. In still further aspects, the conductive additive compositions present in the slurry (or in the blend that is used to form a slurry) comprise carbon black and/or carbon nanotubes. In still further aspects, the conductive additive composition can further comprise an additional CMC. In such aspects, this additional CMC can be present relative to the conductive additive composition (e.g., carbon black and/or carbon nanotubes) in a mass ratio in a range of about 2:1 to about 1:10, including exemplary values of about 1:1, about 1:2, about 1:3, about 1:4, about 1:5, about 1:6, about 1:7, about 1:8, and about 1:9 (note that each of the foregoing example values may constitute an upper bound or a lower bound to a sub-range that is bounded to any of the other stated values, as explained in a preceding paragraph related to numerical ranges).

In still further aspects, a suitable anode material composition is mixed with the formed binder to form the slurry. In certain aspects, the slurry can comprise a solvent, one or more surfactants, or other functional additives if needed. The functional additives can comprise, for example, flame retardant or flame resistant agents, antifoaming agents, biocide agents, or any combination thereof.

In still further aspects, the slurry can be formed by any known in the art methods. For example, the slurry can comprise a solvent composition. In some aspects, the solvent composition comprises water. In some aspects, the solvent composition comprises N-methylpyrrolidone (NMP). In some aspects, the solvent composition comprises 2,5,7,10-Tetraoxaundecane (TOU), 4,8-dimethyl-2,5,7,10-tetraoxaundecane (Elcosol DM), 1,3-Dioxolane, triethyl phosphate (TEP), or another NMP alternative. In some aspects, the solvent composition comprises an alcohol.

Similarly, the cathode slurry can be formed by mixing a suitable cathode active material with a binder, a solvent, and any other functional additives at a stage 324. Any suitable cathode active materials known in the art and disclosed herein can be used to form a cathode electrode at stage 326. The cathode electrode coating and/or the cathode slurry can also comprise conductive fillers, as disclosed above.

In still further aspects, the electrodes (either anode or cathode) are formed on the current collectors at stages 316 and 326, respectively, by casting the respective slurry onto and/or into a current collector. In certain aspects, the current collector can comprise a metal foil, metal wire, metal mesh, or any combination thereof. In certain aspects, the current collector can comprise Cu or Cu-alloy foil for most anodes and Al or Al-alloy foil for most cathodes.

In still further aspects, at stages 316 and 326, the casted compositions (either an anode-forming composition or a cathode-forming composition) is dried to completely evaporate the solvent. In still further aspects, at stages 316 and 326, the casted compositions undergo a calendering process (compaction), which may be carried out after the drying (solvent evaporation) process.

The current collector can be present in any known form depending on the desired application. The current collector can be a metal mesh, metal foam or a very rough metal foil (e.g., comprising metal nanowires or metal nanosheets on its surface). Such current collectors can be used if higher areal capacity loadings or faster charge are desired. The current collector can comprise a metal coated with a thin polymer. Such current collectors can be provided as sheets. Such a design of the current collector may improve safety or lower current collector weight, etc. Other examples of current collectors include a porous metal foil or composite (e.g., nanocomposite) metal foils (e.g., which may be used in some designs for improved properties, lower weight, etc.).

In still further aspects, disclosed herein is a battery. In some aspects, the battery is a lithium-ion battery comprising a battery electrode prepared by the method disclosed herein and configured to be an anode. Still further, the battery comprises another battery electrode configured as a cathode and an electrolyte. Referencing back to the FIG. 3, at stage 330, the lithium battery cell is assembled from at least the anode electrode and the cathode electrode with an electrolyte interposed between the anode electrode and the cathode electrode (as shown in FIG. 1). The electrolyte provides ionic conduction between the anode and the cathode. The electrolyte ionically couples the anode and the cathode. The electrolyte may comprise a liquid electrolyte or a solid electrolyte (or a mixture of liquid and solid electrolyte) at battery operating temperatures (e.g., in some designs, the solid electrolyte may be molten or semi-molten during melt-infiltration and may subsequently solidify). In some implementations, e.g., implementations in which a liquid electrolyte is used, a separator may be used to maintain a space between the anode and the cathode electrodes. In such an implementation, the liquid electrolyte may infiltrate the separator.

In still further aspects, the step of assembling the battery can comprise positioning a suitable separator that can comprise polymer and/or ceramic components between the cathode and anode electrodes. Packaging the battery into a desired configuration (e.g., a cylindrical cell configuration, a prismatic cell configuration, a pouch cell configuration), carrying out electrochemical formation (for example, in stage 332), degassing, sealing and aging processes, among others, are employed to produce a superior battery cell for use in a battery system for energy storage in transportation, electronic devices, electrical grid, and many other important applications.

Some embodiments of the present disclosure on Li-ion batteries may benefit from the use of certain electrolyte compositions in battery cell fabrication to attain superior characteristics. In some designs, suitable electrolyte composition may comprise (i) one, two, three or more Li salts with the total concentration in the range from about 0.8 M to about 2.0 M (e.g., about 0.8-1.0 M; about 1-1.1 M; about 1.1-1.2 M; about 1.2-1.3 M; about 1.3-1.4 M; about 1.4-1.5 M; about 1.5-1.6 M; about 1.6-1.7 M; about 1.7-1.8 M; or about 1.8-2.0 M); (ii) one, two or more cyclic carbonates (in some designs, comprising vinylene carbonate (VC); in some designs, comprising ethylene carbonate (EC); in some designs, fluorinated cyclic carbonates, such as fluoroethylene carbonate (FEC), among others), (iii) zero, one, two, three or more nitrogen-comprising co-solvents (in some designs, at least some of the nitrogen comprising co-solvents may advantageously comprise two or three or more nitrogen atoms per molecules), (iv) zero, one, two, three or more sulfur comprising co-solvents, (v) zero, one, two, three or more phosphorous comprising co-solvents (note that some co-solvents may advantageously comprise both phosphorus and sulfur), (vi) zero, one, two, three or more linear or branched esters as co-solvents, (vii) zero, one, two, or more linear carbonates as co-solvents, (viii) zero, one, two, three or more additional electrolyte co-solvents or additives. In some designs, the volume fraction of linear esters (as a fraction of all co-solvents in the electrolyte) may range from about 20 vol. % to about 85 vol. % (e.g., about 20-40 vol. %; about 40-60 vol. %; or about 60-85 vol. %). In some designs, the volume fraction of branched esters (as a fraction of all co-solvents in the electrolyte) may range from about 10 vol. % to about 80 vol. % (e.g., about 10-30 vol. %; about 30-60 vol. %; or about 60-80 vol. %). In some designs, the volume fraction of cyclic carbonates (as a fraction of all co-solvents in the electrolyte) may range from about 5 vol. % to about 40 vol. % (e.g., about 5-10 vol. %; about 10-20 vol. %; or about 20-40 vol. %). In some designs, the volume fraction of fluorinated cyclic carbonates (as a fraction of all co-solvents in the electrolyte) may range from about 1 vol. % to about 20 vol. % (e.g., about 1-4 vol. %; about 4-6 vol. %; about 6-12 vol. %; or about 12-20 vol. %). In some designs, the volume fraction of VC (as a fraction of all co-solvents in the electrolyte) may range from about 0.25 vol. % to about 6 vol. % (e.g., about 0.25-0.5 vol. %; about 0.5-1 vol. %; about 1-2 vol. %; or about 2-6 vol. %). In some designs, 50 vol. % or more of the co-solvents may advantageously exhibit a melting point below about minus (−) 60° C. (in some designs, below about—70° C.; in other designs, below about—80° C.). In some designs utilizing two or more salts (e.g., two salts or three salts or four salts or five salts, etc.), it may be advantageous for the two or more salts to comprise LiPF₆. In some designs, the incorporation of such salts may enhance battery performance properties (cycle stability, resistance, thermal stability, performance at high or low temperatures, etc.), enhance properties of the cathode-electrolyte interphase (CEI) or of the anode's solid-electrolyte interphase (SEI), or provide other performance advantages. In some designs utilizing two or more salts (e.g., the first salt being LiPF₆), it may be additionally advantageous for at least one other salt to also be a salt of Li. Examples of some of such suitable additional salts include but are not limited to, lithium bis(fluorosulfonyl) imide (LiFSI), lithium bis(trifluoromethanesulfonyl)imide (LiTFSI), lithium Bis(pentafluoroethanesulfonyl)imide (LiBETI) (and other Li imide salts), lithium bis(oxalato)borate (LiBOB), lithium difluoro(oxalato)borate (LiDFOB), lithium 4,5-dicyano-2-(trifluoromethyl)imidazole (LiTDi), lithium 4,5-dicyano-2-(pentailuoroethyl) imidazolide (LiPDi), lithium difluorophosphate (LiDFP), and lithium nitrate (LiNO₃).

In still further aspects, the battery disclosed herein can exhibit a so-called direct-current (internal) resistance (DCR) of 0.14 Ω·Ah or less, including exemplary values of 0.13 Ω·Ah or less, 0.12 Ω·Ah or less, 0.11 Ω·Ah or less, 0.10 Ω·Ah or less, 0.09 Ω·Ah or less, 0.08 Ω·Ah or less, 0.07 Ω·Ah or less, 0.06 Ω·Ah or less, or 0.05 Ω·Ah or less. Note that the DCR is expressed in the units of [ΩAh], where the battery capacity expressed in the units of [Ah] is multiplied by the battery resistance expressed in the units of [Ω](Ohm).

Battery cell modules or battery cell packs may advantageously comprise cells with anode electrodes, cathode electrodes, separators and/or electrolyte compositions provided in this disclosure. Such cell modules or packs may offer improved performance characteristics, simplified designs, better safety features, and/or lower cost.

By way of example, the disclosed herein batteries can be used in hand-held and/or wearable electronic devices, such as a phone, watch, or laptop computer; in stationary electronic devices, such as a desktop or mainframe computer; in an electric tool, such as a power drill; in an electric or hybrid land, water, or air-based vehicle, such as a boat, submarine, bus, train, truck, car, motorcycle, moped, powered bicycle, airplane, air taxi, drone, other flying vehicle, or toy versions thereof; for other toys; for energy storage, such as in storing electric power from wind, solar, wave, hydropower, or nuclear energy and/or in grid storage, or as a stationary power store for small-scale use, such as for a home, business, or hospital.

In addition, batteries, according to the present disclosure, may be multi-cell batteries containing at least about 10, at least about 100, at least about 500 batteries of the present disclosure. Batteries in multi-cell batteries may be arranged in parallel or in series.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees c. or is at ambient temperature, and pressure is at or near atmospheric.

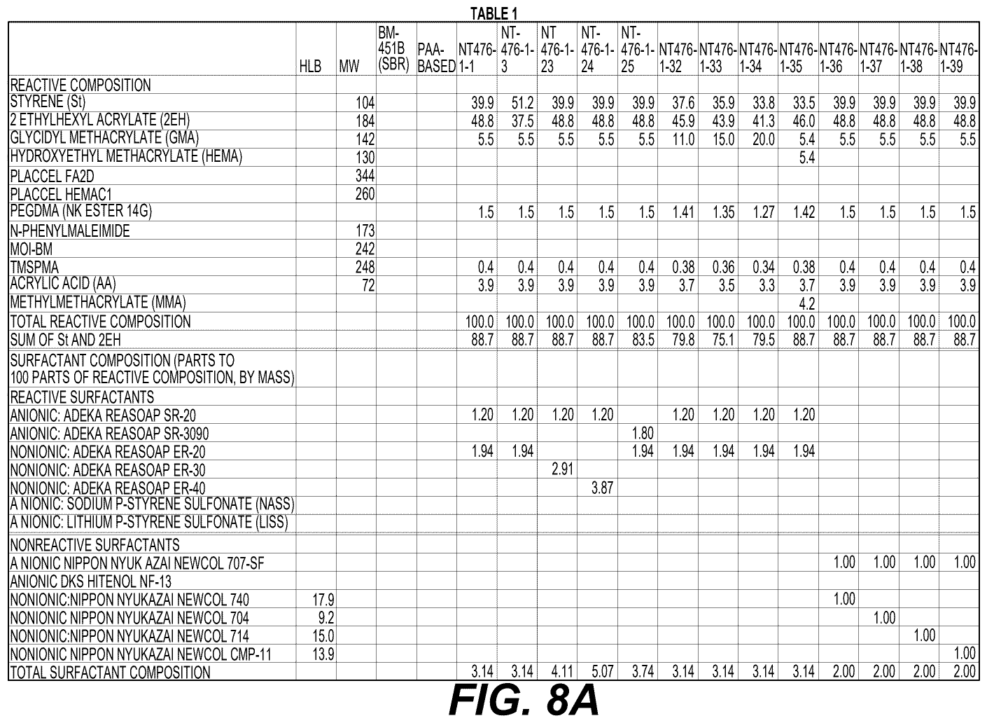

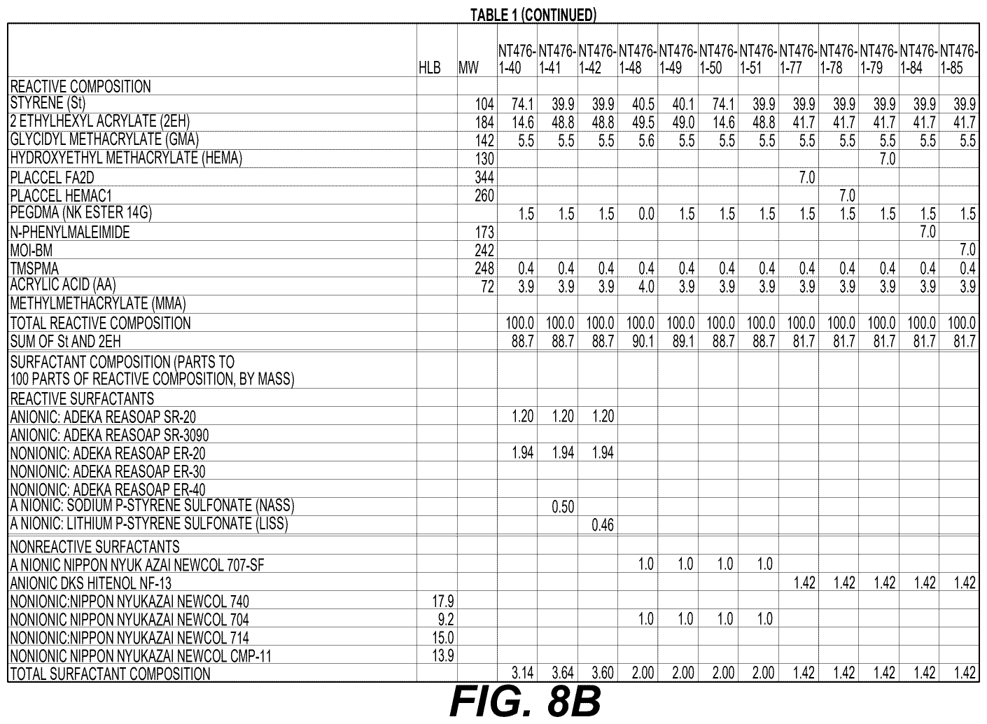

FIGS. 8A and 8B show Table 1, which summarizes example compositions of reactive compositions and surfactant compositions employed in the emulsion polymerization of binder materials disclosed herein. In Table 1, samples NT476-1-1, NT476-1-23, NT476-1-24, NT476-1-25, NT476-1-36, NT476-1-37, NT476-1-38, NT476-1-39, NT476-1-41, NT476-1-42, and NT476-1-51 (Group 1 samples) have an approximately identical reactive composition (about 39.9 wt. % of styrene, about 48.8 wt. % of 2-ethylhexyl acrylate (2EH), styrene to 2EH mass ratio of about 0.82, and approximately the same amounts of other components: glycidyl methacrylate (GMA), PEGDMA, TMSPMA, and acrylic acid (AA)), with various compositions of reactive or nonreactive surfactants. GMA is an example of a multifunctional (meth)acrylate comprising at least one of (1) an epoxide group, (2) a hydroxyl group, and (3) an isocyanate group. In particular, GMA comprises an epoxide group. Samples NT476-1-3, NT476-1-40, and NT476-1-50 have approximately the same total mass of styrene and 2-ethylhexyl acrylate (2EH) as the above samples (Group 1 samples), but with a higher styrene presence in the reactive composition (the reactive compositions of NT476-1-3, NT476-1-40, and NT476-1-50 comprise about 51.2 wt. %, about 74.1%, and about 74.1 wt. % of styrene, respectively). Samples NT476-1-32, NT476-1-33, NT476-1-34, and NT476-1-35 have reactive compositions comprising styrene, 2EH, GMA, PEGDMA, TMSPMA, and AA at respective mass fractions, but have surfactant compositions comprising approximately the same amount of reactive surfactant without the presence of a nonreactive surfactant. The reactive compositions of samples NT476-1-35 and NT476-1-79 comprise hydroxyethylmethacrylate (HEMA) in addition to GMA. HEMA is another example of a multifunctional (meth)acrylate comprising at least one of (1) an epoxide group, (2) a hydroxyl group, and (3) an isocyanate group. In particular, HEMA comprises a hydroxyl group. The reactive composition of sample NT476-1-35 additionally comprises methyl methacrylate (MMA). The reactive composition of sample NT476-1-77 comprises FA2D in addition to GMA. FA2D is another example of a multifunctional (meth)acrylate comprising at least one of (1) an epoxide group, (2) a hydroxyl group, and (3) an isocyanate group. In particular, FA2D comprises a hydroxyl group (Formula F, 440, provided that the molecular weight is about 344). The reactive composition of sample NT476-1-78 comprises HEMAC1 in addition to GMA. HEMAC1 is another example of a multifunctional (meth)acrylate comprising at least one of (1) an epoxide group, (2) a hydroxyl group, and (3) an isocyanate group. In particular, HEMAC1 comprises a hydroxyl group (Formula E, 438, provided that R²¹ is CH₃, m is 2, and n is 1). The reactive composition of sample NT476-1-85 comprises MOI-BM in addition to GMA. MOI-BM is another example of a multifunctional (meth)acrylate comprising at least one of (1) an epoxide group, (2) a hydroxyl group, and (3) an isocyanate group. In particular, MOI-BM comprises a blocked isocyanate group (Formula G, 450). The reactive composition of sample NT476-1-84 comprises N-phenylmaleimide (456). N-phenylmaleimide is an example of a maleimide. The reactive composition of sample NT476-1-48 is devoid of any PEGDMA. The reactive composition of NT476-1-49 is devoid of any TMSPMA. Samples NT476-1-1, NT476-1-3, NT476-1-23, NT476-1-24, NT476-1-25, NT476-1-32, NT476-1-33, NT476-1-34, NT476-1-35, NT476-1-40, NT476-1-41, and NT476-1-42 employ reactive surfactants. Samples NT476-1-36, NT476-1-37, NT476-1-38, NT476-1-39, NT476-1-48, NT476-1-49, NT476-1-50, NT476-1-51, NT476-1-77, NT476-1-78, NT476-1-79, NT476-1-84, and NT476-1-85 employ nonreactive surfactants. The reactive compositions and the surfactant compositions for NT476-1-37 and NT476-1-51 are approximately the same; however, the NT476-1-37 sample was prepared as a sample of about 100 g and the NT476-1-51 sample was prepared as a sample of about 1 kg.

An example emulsion polymerization process is as follows. Prepare a reactive (monomer) emulsion containing styrene, 2-ethylhexyl acrylate (2EH), glycidyl methacrylate (GMA), hydroxyethylmethacrylate (HEMA) (if any), PEGDMA, TMSPMA, and acrylic acid (AA)), with respective compositions of surfactants in ion-exchanged water. In a separable flask equipped with a cooling pipe, a thermometer, a stirrer, and a dropping funnel, ion-exchanged water and 0.36 part of sodium bicarbonate are charged and heated to 85° C. The monomer emulsion is added dropwise over a period of 4 hours. Simultaneously, dissolve 0.22 part of potassium persulfate in ion-exchanged water as a polymerization initiator and dissolve 0.22 part of bisulfite soda in ion-changed water as a catalyst. Subsequently, the resulting solutions are separately added dropwise over 4 hours at 85° C. After completion of the dropwise addition, allow for a 2-hour maturation period at 65° C. with 0.13 part of a peroxide material and 0.06 part of catalyst. Then, add ammonia water to obtain an aqueous emulsion followed by filtration step with mesh #200. The non-volatile content of the resulting aqueous emulsion is 48 wt. %, with a viscosity of 100 cP, and a pH of 6.5.

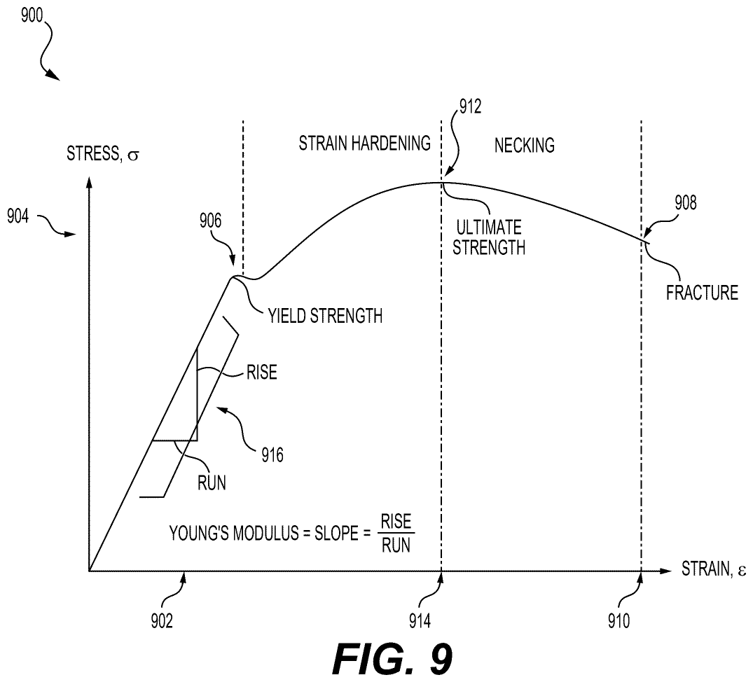

FIG. 9 shows a graphical plot 900 illustrating a typical relationship between stress and strain in a ductile material (e.g., steel). The X-axis 902 represents the strain in the ductile material, and the Y-axis 904 represents the stress in the ductile material. The yield strength (shown at 906) is the stress corresponding to the yield point at which the ductile material begins to deform plastically. The fracture (also referred to as the break) of the ductile material is shown at 908. The strain at break (sometimes also referred to as the total elongation at break, total elongation at fracture) is shown at 910 along the X-axis 902. Furthermore, the ultimate tensile strength (UTS) (also sometimes referred to as tensile strength), shown at 912, is the maximum stress that the material can withstand. The strain at the UTS is shown at 914 along the X-axis 902. Young's modulus (also sometimes referred to as modulus of elasticity or elastic modulus) is the tensile stress divided by the axial strain in the linear elastic region (e.g., the region indicated by 916) of the ductile material.

In some designs, it may be advantageous for the total elongation at break (% GL, or percentage of the gauge length of the sample) of the suitable binders to be in the range from about 50% to about 600% (e.g., about 50-150%; about 70-150%; about 150-250%; about 250-310%; about 70-310%; about 250-400%; or about 400-600%). In some designs, it may be advantageous for the Young's modulus of suitable binders to be in the range from about 0.8 to about 300 MPa (e.g., about 0.8-1 MPa, about 1-2 MPa, about 0.8-2 MPa, about 2-5 MPa, about 5-50 MPa, about 50-100 MPa, or about 100-300 MPa).

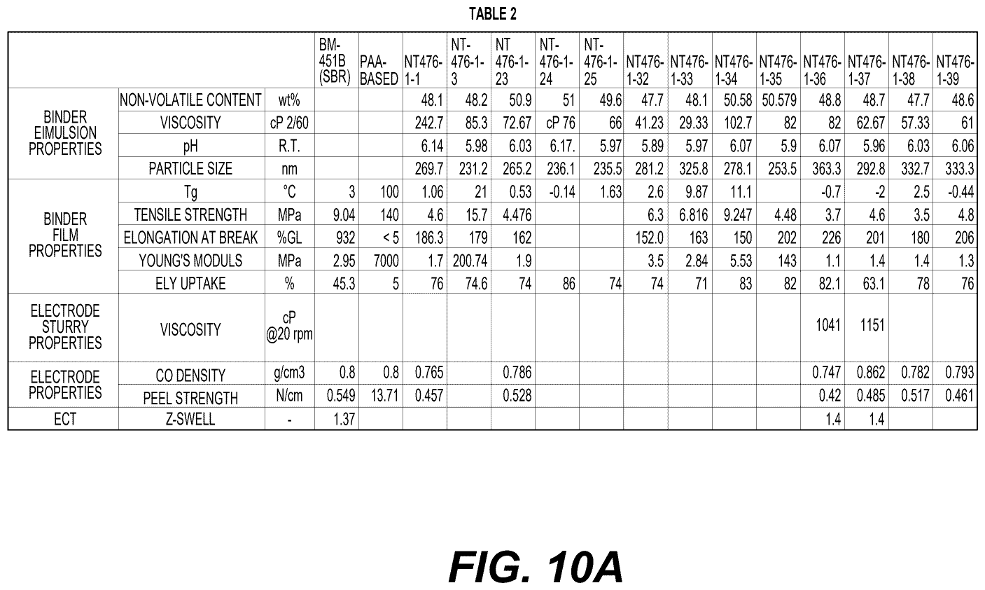

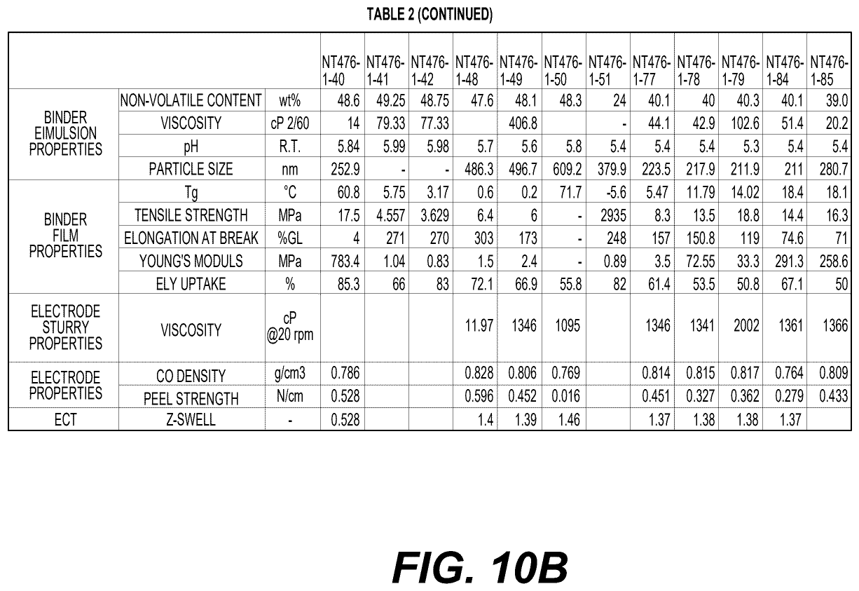

Table 2 (FIGS. 10A and 10B) shows selected properties of some of the binder compositions from Table 1. The measured data are grouped into the following categories: binder emulsion properties (data measured on the binder emulsions that are formed according to the processes outlined herein), binder film properties (data measured on films that are cast from the binder emulsions), electrode slurry properties (data measured on electrode slurries comprising electrode active materials (e.g., Si—C composite particles, graphite particles (if any)), binder materials, additives, and solvents), electrode properties (data measured on electrode coatings formed by casting the electrode slurry on a substrate), and electrochemical testing (ECT) data. The ECT data are measured on battery test cells that employ the electrode as an anode, and the sole ECT data reported in Table 2 are z-swell data, as explained herein.

The binder emulsion properties category includes the following measured data: non-volatile content, viscosity, pH, and average particle size. The non-volatile content is measured as follows. An emulsion sample is weighted followed by drying at 105° C. for 2 hours. The non-volatile content is calculated by dividing the weight of the residue by the initial weight of the emulsion sample. The viscosity is measured using a B-type viscometer (TVB-IV, TOKI SANGYO) equipped with a Brookfield spindle LV-2 (60 rpm) at 25° C. The notation of 2/60 in Table 2 indicates that this viscosity was measured using a Brookfield spindle #2 at 60 rpm. The pH is measured at room temperature using a pH meter (D-52, HORIBA) equipped with a HORIBA 9615S-10D Standard Glass pH electrode. The average particle size is measured by dynamic light scattering (Nanotrac WaveII, MicrotracBEL) and expressed as the mean diameter in the volume distribution (volume-weighted mean diameter). In dynamic light scattering (DLS), also sometimes referred to as quasi-elastic light scattering (QLES), the light scattered by particles (typically in a range of about 1 to about 1000 nm in size) as they undergo Brownian motion in a solvent is measured to determine the size of the particles.

The binder film properties category includes the following measured data: glass transition temperature (T_{g}), tensile strength (UTS), elongation at break (expressed as a percentage of the gauge length of the sample), Young's modulus (elastic modulus), and electrolyte (ELY) uptake (also referred to as a swell ratio). The glass transition temperature T_{g} was determined by the differential scanning calorimeter (DSC) curve in the second heating at the heating rate of 20° C./min. The Young's modulus was averaged from five different measurements. The UTS and total elongation at break values were averaged from five different measurements. For ELY uptake (swell ratio after soaking in an electrolyte), an electrolyte comprising ethyl methyl carbonate/ethylene carbonate/dimethyl carbonate (EMC/EC/DMC) in a ratio of 1:1.3:16.2 (on a mass basis) was used. The ELY uptake (swell ratio) is calculated by dividing the mass of the binder sample (binder film) after soaking the binder sample in the liquid electrolyte for 24 hours (hence, the mass of the binder sample includes the mass of the electrolyte taken up by the binder), by the volume of the same binder sample before the soaking.

A commercially available SBR binder and a commercially available PAA-based binder exhibited glass transition temperatures T_{g} of about 3.0° C. and about 100° C., respectively. For the experimental results reported herein, an SBR binder BM-451B available from Zeon Corporation was used. Some of the example binders (NT476-1-x, wherein x is 1, 23, 24, 25, 32, 36, 37, 38, 39, 48, 49, and 51) exhibited glass transition temperatures of less than 3.0° C. (lower than that of the commercially available SBR. One of the example binders (NT476-1-51) exhibited a glass transition temperature in a range of −6 to −4° C. Some of the example binders (NT476-1-x wherein x is 1, 23, 24, 25, 35, 36, 37, 39, 48, and 49) exhibited glass transition temperatures in a range of −4 to +2° C. Some of the example binders (NT476-1-x wherein x is 1, 23, 24, 25, 36, 37, 38, 39, 48, and 49) exhibited glass transition temperatures in a range of −2 to +2.5° C. Some of the example binders (NT476-1-x wherein x is 38, 41, 42, and 77) exhibited glass transition temperatures in a range of 2 to 8° C. Some of the example binders (NT476-1-x wherein x is 33, 34, and 78) exhibited glass transition temperatures in a range of 8 to 14° C. Some of the example binders (NT476-1-x wherein x is 79, 84, and 85) exhibited glass transition temperatures in a range of 14 to 20° C. Example binders that employed FA2D (NT476-1-77), HEMAC1 (NT476-1-78), HEMA (NT476-1-79), N-Phenylmaleimide (NT476-1-84), and MOI-BM (NT476-1-85) in the reactive composition (e.g., in addition to the GMA) exhibited relatively high glass temperatures of 5.47° C., 11.79° C., 14.02° C., 18.4° C., and 18.1° C., respectively. The high-styrene content example binders (NT476-1-3, NT476-1-40, NT476-1-50) exhibited yet higher T_{g} values (about 21° C., 60.8° C., 71.7° C.) that were lower than that of the commercially available PAA-based binder (100° C.).

In some designs, it may be advantageous for the glass transition temperature T_{g} of suitable binders to be in the range from about minus (−) 6° C. to about +20° C. (e.g., in a range of about −6 to about −4° C., in a range of about −4 to about +2° C., in a range of about 2 to about 8° C., in a range of about 8 to about 14° C., or in a range of about 14 to about 20° C.).

Among the samples considered in Table 2, the PAA-based binder exhibited the greatest UTS (tensile strength) of about 140 MPa. The SBR exhibited a UTS value of about 9.040 MPa. One of the example binders (NT476-1-51) exhibited a tensile strength of 2.935 MPa, less than the UTS of 3 MPa observed in the SBR. Some of the example binders (NT476-1-x, wherein x is 1, 23, 32, 33, 35, 36, 37, 38, 39, 41, 42, 48, 49, 77) exhibited tensile strengths in a range of 3 to 9 MPa, lower than that of SBR. Some of the example binders (NT471-1-x, wherein x is 3, 34, 40, 78, 79, 84, and 85) exhibited relatively high tensile strengths in a range of 9 to 20 MPa, in between those of SBR and the PAA-based binder. Among these relatively high-tensile strength example binders, NT476-1-3 and NT476-1-40 have relatively high styrene content (51.2 wt. % and 74.1 wt. %) in the reactive composition, NT476-1-34 has a relatively high GMA content (20.0 wt. %) in the reactive composition, NT476-1-78 has HEMAC1 (7.0 wt. %) in addition to the GMA (5.5 wt. %) in the reactive composition, NT476-1-79 has HEMA (7.0 wt. %) in addition to the GMA (5.5 wt. %) in the reactive composition, NT476-1-84 has N-phenylmaleimide (7.0 wt. %) in addition to the GMA (5.5 wt. %) in the reactive composition, and NT476-1-85 has MOI-BM (7.0 wt. %) in addition to the GMA (5.5 wt. %) in the reactive composition.

In some designs, it may be advantageous for the UTS of the suitable binders to be in the range from about 0.5 to about 20 MPa (e.g., about 0.5-8 MPa, about 0.5-3 MPa; about 3-6 MPa; about 6-8 MPa; about 3-9 MPa; about 8-20 MPa; about 9-20 MPa; or about 3-20 MPa).

Among the samples considered in Table 2, the SBR binder exhibited the greatest total elongation at break (also referred to as elongation at break) of about 932% (expressed as a percentage of a gauge length thereof, or % GL). On the other hand, the PAA-based binder and the high-styrene example binder (NT476-1-40) exhibited total elongation at break values of <5% and about 4%, respectively. The example binders shown in Table 2 exhibited total elongation at break values in between these extrema. Some example binders (NT476-1-x, wherein x is 34, 79, 84, and 85) exhibited total elongation at break values in a range of 70 to 150% GL. Some example binders (NT476-1-x, wherein x is 1, 3, 23, 32, 33, 34, 35, 36, 37, 38, 39, 49, 51, 77, and 78) exhibited total elongation at break values in a range of 150 to 250% GL. Some example binders (NT476-1-x, wherein x is 41, 42, and 48) exhibited total elongation at break values in a range of 250 to 310% GL.

In some designs, it may be advantageous for the total elongation at break (% GL, or percentage of the gauge length of the sample) of the suitable binders to be in the range from about 50% to about 600% (e.g., about 50-150%; about 70-150%; about 150-250%; about 250-310%; about 70-310%; about 100-300%; about 190-300%; about 190-230%; about 250-400%; or about 400-600%).

A commercially available SBR binder and a commercially available PAA-based binder exhibited Young's modulus values of about 2.95 MPa and about 7000 MPa, respectively. For the experimental results reported herein, an SBR binder BM-451B available from Zeon Corporation was used. Some of the example binders (NT476-1-x, wherein x is 1, 23, 35, 36, 37, 38, 39, 41, 42, 48, 49, and 51) exhibited Young's modulus values in a range of 0.8 to 2.5 MPa, lower than that of commercially available SBR (2.95 MPa). Some of the example binders (NT476-1-x, wherein x is 32, 33, 34, 77, and 79) exhibited somewhat higher Young's modulus values in a range of 2.5 to 50 MPa. Among these example binders with somewhat higher Young's modulus values, NT476-1-32, 33, and 34 had higher GMA content in the reactive compositions (11.0 wt. %, 15.0 wt. %, and 20.0 wt. %, respectively, compared to 5.5 wt. % for some other example binders), NT476-1-77 had FA2D in addition to GMA in its reactive composition, and NT476-1-79 had HEMA in addition to GMA in its reactive composition. Some of the example binders (NT471-1-x, wherein x is 3, 40, 78, 84, and 85) exhibited higher Young's modulus values in a range of 50 to 300 MPa. Among these example binders with higher Young's modulus values, NT476-1-3 had a higher styrene content (51.2 wt. %, compared to 39.9 wt. % of some other example binders), NT476-1-78 had HEMAC1 in addition to GMA in its reactive composition, NT476-1-84 had N-phenylmaleimide in its reactive composition, and NT476-1-85 had MOI-BM in addition to GMA in its reactive composition. NT476-1-40, with a styrene content of 74.1 wt. % in its reactive composition, exhibited a Young's modulus of 783.4 MPa. In some implementations, a preferred binder material exhibits a Young's modulus in a range of about 0.8 to about 300 MPa (e.g., about 0.8-2.5 MPa, about 2.5-50 MPa, about 50-300 MPa, about 0.9-1.6 MPa, about 0.9-1.5 MPa, about 50-150 MPa, or about 150-300 MPa).

Among the samples considered in Table 2 (FIGS. 10A, 10B), the commercially available PAA-based binder exhibited the lowest ELY uptake (swell ratio) of about 5.0%. The commercially available SBR binder sample exhibited the second lowest ELY uptake (swell ratio) of about 45.3%. Some of the example binders (NT476-1-x, wherein x is 37, 50, 77, 78, 79, and 85) exhibited moderate ELY uptake values in a range of 45 to 65%. Among these example binders exhibiting moderate ELY uptake, NT476-1-50 had a higher styrene content (74.1 wt. %) in its reactive composition, NT476-1-77 had FA2D in addition to GMA in its reactive composition, NT476-1-78 had HEMAC1 in addition to GMA in its reactive composition, NT476-1-79 had HEMA in addition to GMA in its reactive composition, and NT476-1-85 had MOI-BM in addition to GMA in its reactive composition. Some of the example binders (NT476-1-x, wherein x is 1, 3, 23, 24, 25, 32, 33, 34, 35, 36, 38, 39, 40, 41, 42, 48, 49, 51, and 84) exhibited higher ELY uptake values in a range of 65 to 86%. Even though the two high-styrene binder materials (NT476-1-3, NT476-1-40) exhibited relatively high Young's modulus values (about 200.7 MPa, about 783.39 MPa, respectively) compared to SBR (2.95 MPa), their swell ratios (about 74.6% for NT476-1-3, about 85.3% for NT476-1-40) are higher than for SBR (about 45.3%). Moreover, the Young's modulus of the binder material (e.g., SBR, NT476-1-x) is not the sole determinant of the Young's modulus of the respective CMC/binder mixture. For example, a CMC/SBR composite exhibited a Young's modulus of about 146.3 MPa, more than 49 times greater than SBR's Young's modulus of about 2.95 MPa, while a CMC/NT476-1-37 composite exhibited a Young's modulus of about 12.4 MPa, only about 9 times greater than NT476-1-37's Young's modulus of about 1.4 MPa, and a CMC/NT476-1-1 composite exhibited a Young's modulus of about 15.6 MPa, only about 9 times greater than NT476-1-1's Young's modulus of about 1.7 MPa. The CMC/SBR binder composite is likely an example in which the compatibility between the CMC and the binder is relatively high. On the other hand, the CMC/NT476-1-1 and CMC/NT476-1-37 binder composites are likely examples in which the compatibility between the CMC and the respective binder is relatively low, at least compared to the CMC/SBR composite. In some implementations, it may be preferable to further improve the compatibility between CMC and the binder material, which may lead to beneficial effects such as: reduced swelling of the anode or of the cell and higher volumetric charge density (VQD) and/or volumetric energy density (VED).

The electrode slurry properties category of Table 2 includes the viscosity of the electrode slurry, measured using an E-type viscometer (TV-25, TOKI SANGYO) equipped with a cone rotor (3°×R9.7) at a predetermined number of revolutions per minute (rpm) (e.g., 20 rpm) at 25° C. The slurries contained about 86 to about 90 wt. % active material (in the examples shown, Si—C(nano)composite particles), about 10 to about 13 wt. % binder or binder mixture (e.g., CMC and SBR, CMC and example binder (NT series)), and about 0.1 to about 0.4 wt. % conductive additives. For each slurry, CMC and a respective binder were mixed in a mass ratio of 1:5 (CMC:binder).

The electrode properties category of Table 2 includes the following measured data: coating (CO) density and peel strength. The coating density was averaged from three different measurements. For each binder coating, a peel strength was obtained by averaging from three separate measurements. The peel strength value is measured by peeling a coating of the electrode cast on a copper foil substrate. The test conditions for peel strength testing were as follows: the peel test width: 2.5 cm, speed: 10 cm/min from 10 to 100 mm. The negative electrode was cut into a rectangular shape measuring 150 mm in length and 25 mm in width to prepare a test piece. One side of double-sided tape, manufactured by NICHIBAN CO., LTD, was affixed to the surface of the electrode, followed by crimping it with a 2 kg rubber roller. This measurement was repeated three times, and the average of the measurement results was calculated.

The commercially available SBR and PAA-based binder samples exhibited coating density values of about 0.8 g/cm³. Some of the example binders (NT476-1-x, wherein x is 37, 40, 48, 49, 77, 78, 79, and 85) exhibited coating densities in a range of 0.8 to 0.9 g/cm³. Other example binders (NT476-1-x, wherein x is 1, 23, 36, 38, 39, 50, and 84) exhibited coating densities in a range of 0.7 to 0.8 g/cm³.

Among the samples considered in Table 2, the commercially available PAA-based binder exhibited the highest peel strength of about 13.71 N/cm. The commercially available SBR binder sample exhibited a peel strength of about 0.549 N/cm. Some of the example binders (NT476-1-x, wherein x is 1, 23, 36, 37, 38, 39, 48, 49, 77, and 85) exhibited peel strengths in a range of about 0.4 to 0.6 N/cm. Some example binders (NT476-1-40, 50) comprising relatively high mass fractions of styrene (74.1 wt. %, 74.1 wt. %, respectively) in the respective reactive compositions exhibited lower peel strengths of less than 0.1 N/cm.

The electrochemical testing (ECT) category of Table 2 shows z-swell data during cycling, which refers to the change in coating thickness in the z-direction (the z-direction is perpendicular to the plane of the electrode). The z-swell is calculated by dividing the coating thickness of the anode in the charged state at the end of cycle 3 with the coating thickness of the as-prepared anode. The coating thickness is measured, using a high-accuracy digital contact sensor (with approximately 0.1 μm resolution), on test cells after undergoing three charge/discharge cycles. The z-swell values for the example binders (NT series) ranged between 1.37 and 1.46, while that of the SBR is 1.37, indicating that monomer composition of the example binders (NT series) can be effective in controlling the swelling force of the electrode in the z-direction. The differential values of z-swells for different example binders (NT series) also implies that the swelling force along the xy-plane (the plane of the electrode) can be also effectively modulated.

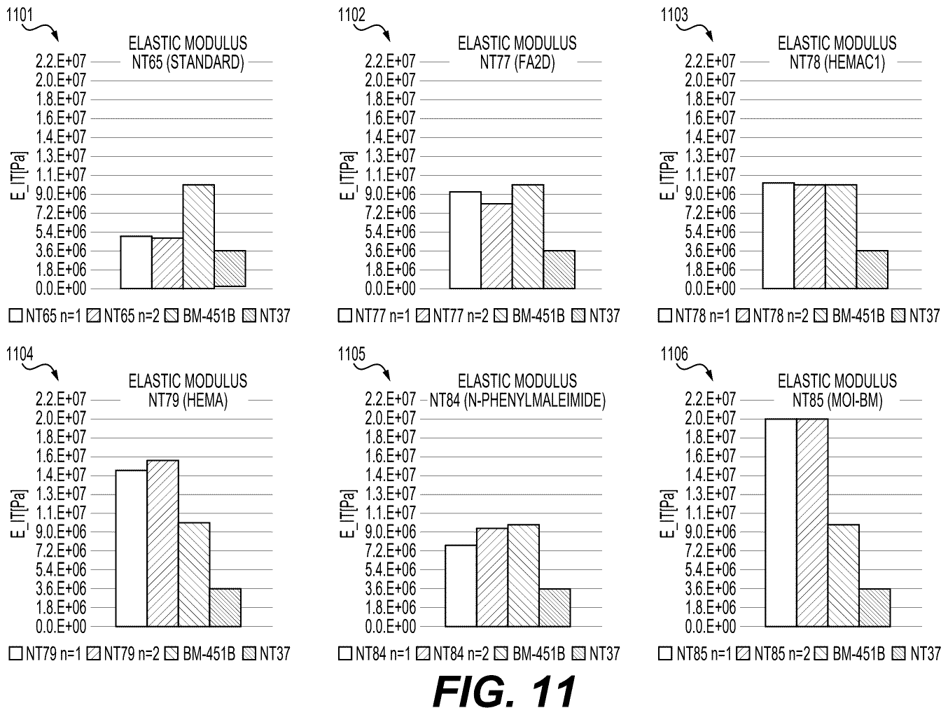

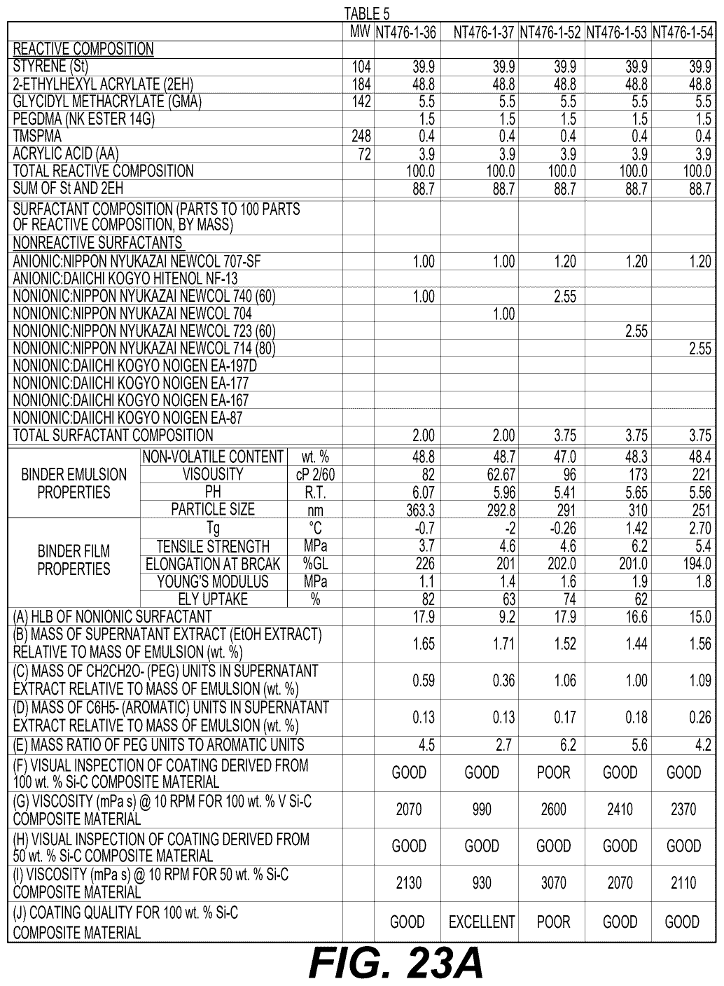

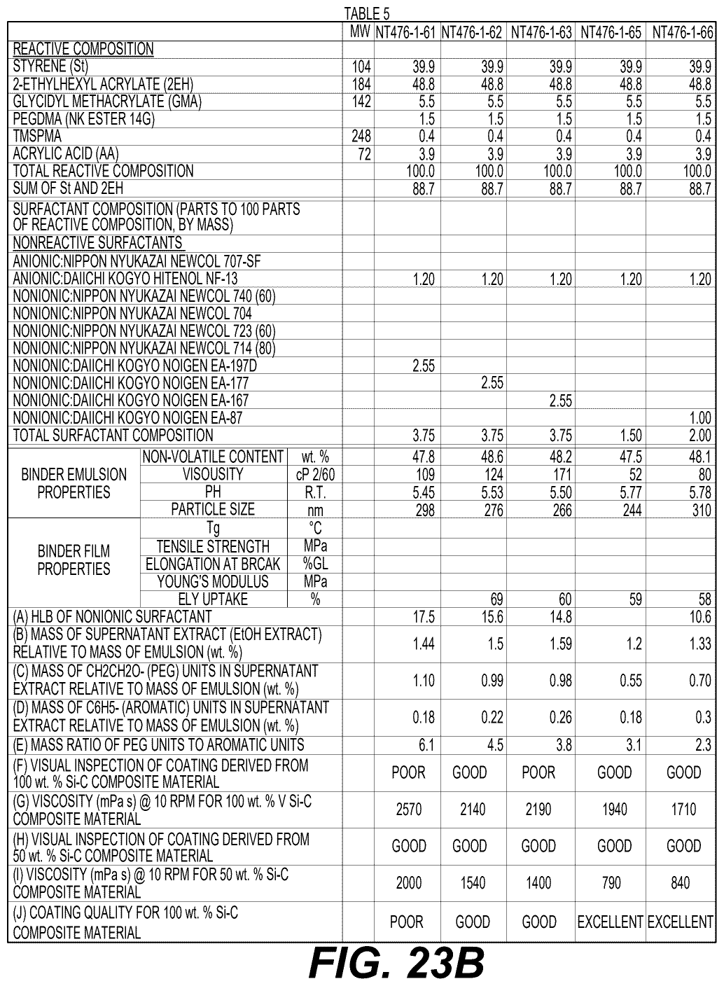

FIG. 11 shows graphical plots (1101, 1102, 1103, 1104, 1105, 1106), with each graphical plot showing the Young's modulus (elastic modulus) values of four binder samples, measured after soaking in an electrolyte. The electrolyte soaking procedure is identical to that provided for the ELY (electrolyte) uptake measurement reported in Table 2. Each graphical plot shows the elastic modulus, after soaking in electrolyte, of (1) two instances of a respective binder (NT476-1-65, abbreviated as NT65, for 1101; NT476-1-77, abbreviated as NT77, for 1102; NT476-1-78, abbreviated as NT78, for 1103; NT476-1-79, abbreviated as NT79, for 1104; NT476-1-84, abbreviated as NT84, for 1105; NT476-1-85, abbreviated as NT85, for 1106), (2) a commercially available SBR binder (BM-451B), and (3) an example binder NT476-1-37 (abbreviated as NT37). The Young's modulus values of NT476-1-79 (comprising HEMA in its reactive composition) (about 15 MPa) and NT476-1-85 (comprising MOI-BM) (about 20 MPs) were higher than that of the SBR binder (about 9.5 MPa). Composition information for NT476-1-65 is reported in Table 5 (FIGS. 23A, 23B). Composition information for the other example binders is reported in Table 2.

### Example 1

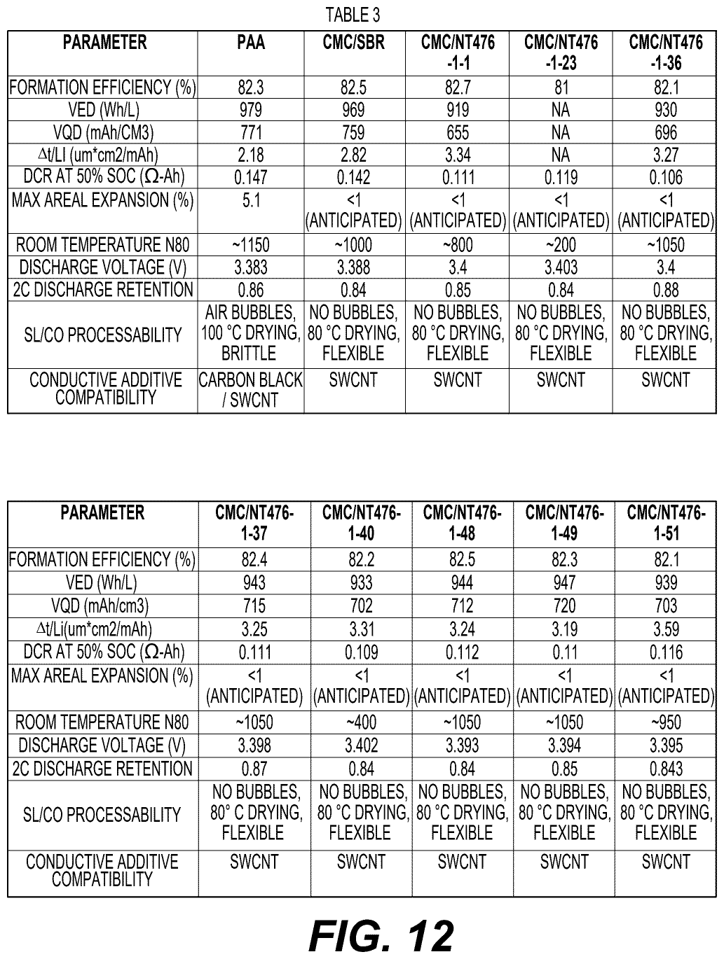

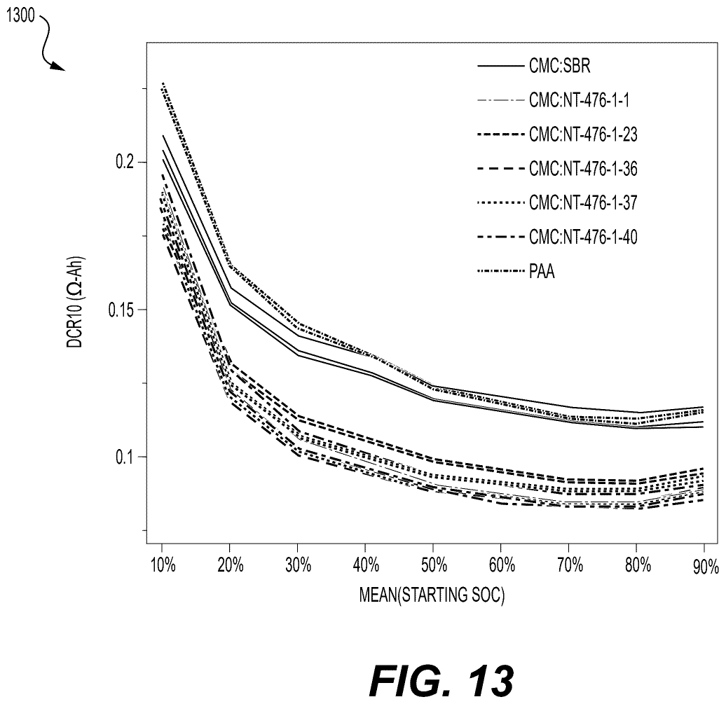

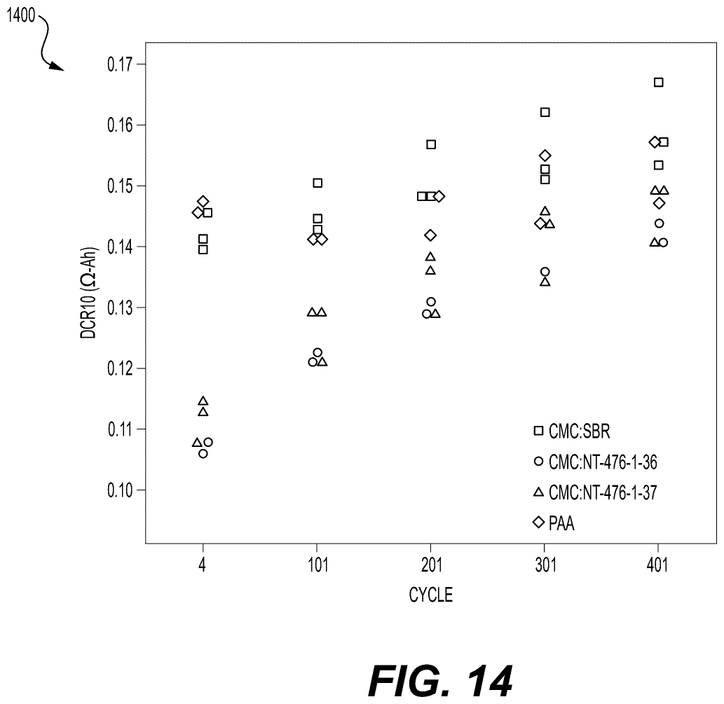

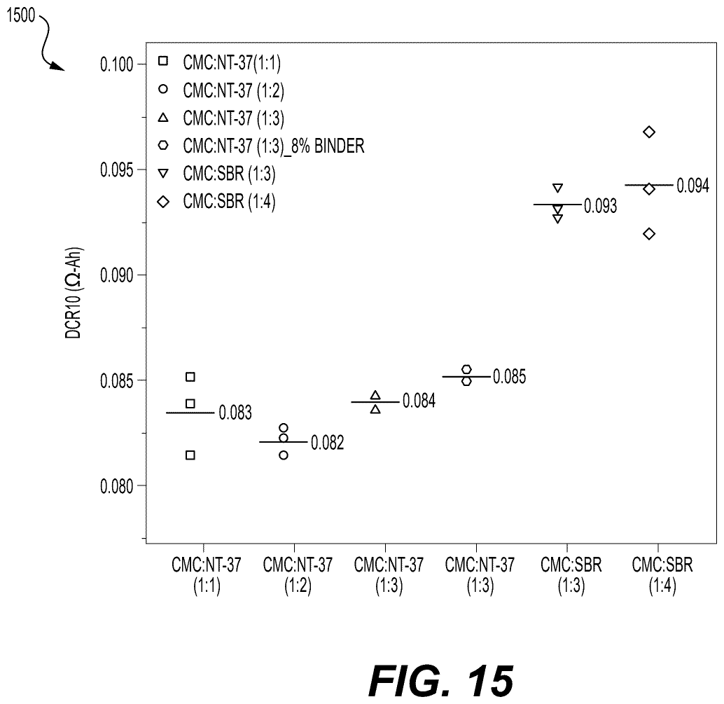

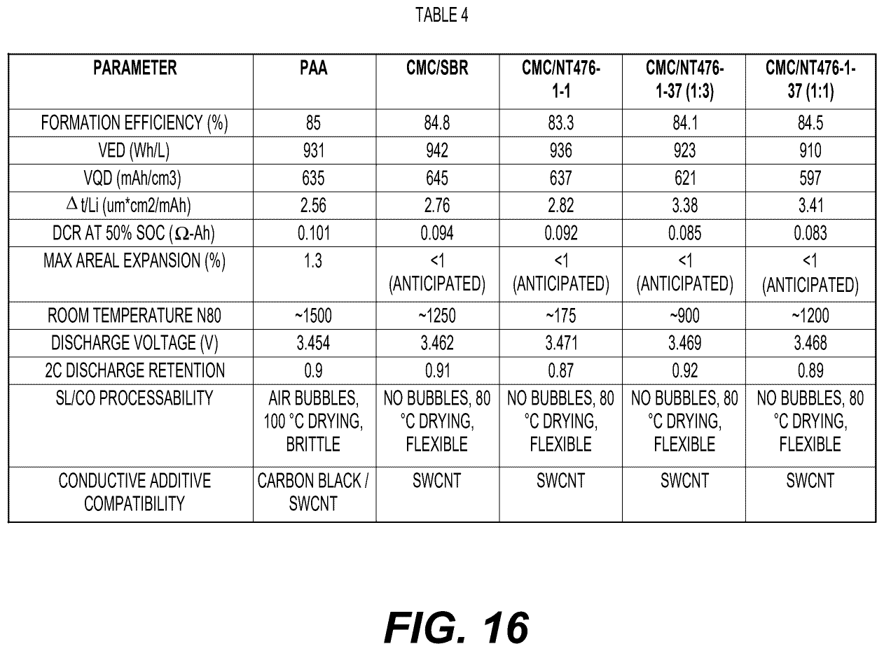

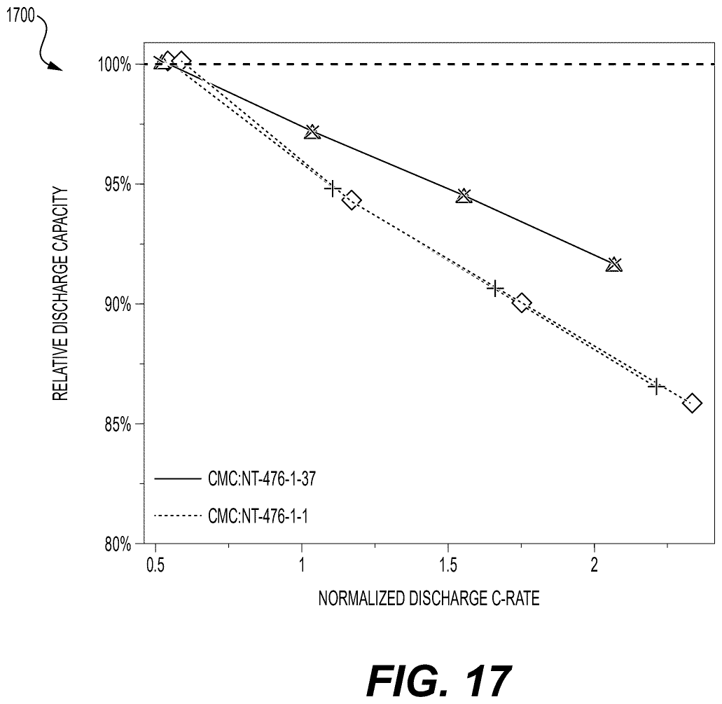

Test cells were fabricated for the battery test results reported herein. Si—C nanocomposite particles (with specific reversible capacity of about 1600 mAh/g to about 2200 mAh/g, normalized by the weight of the respective Si—C nanocomposite particles) were employed in the anode coating. The anode coating was formed by casting an aqueous suspension (slurry) comprising active material particles (e.g., Si—C nanocomposite active material particles, graphite particles), a respective binder composition or binder mixture, and respective conductive additives (single-wall carbon nanotubes (SWCNT) or carbon black) on a Cu current collector foil. The binder composition or binder mixture was selected from the following: (1) a commercially available polyacrylic acid (PAA)-based binder, (2) a mixture of commercially available CMC and SBR, and (3) a mixture of commercially available CMC and an example binder referenced as NT476-1-x, wherein x is 1, 3, 23, 24, 25, 32, 33, 34, 35, 36, 37, 38, 39, 40, 41, 42, 48, 49, 50, and 51. In the test cell results reported in Table 3 (FIG. 12), FIG. 13, FIG. 14, the Si—C nanocomposite particles were the sole active material in the anode coating. In the test cell results reported in FIG. 15, Table 4 (FIG. 16), and FIG. 17, a mixture of Si—C nanocomposite particles and graphite particles (the mixture contained about 50 wt. % of Si—C nanocomposite particles and about 50 wt. % of graphite particles) was the active material in the anode coating. In the examples herein, carbon-containing nanocomposite particles containing silicon nanoparticles were used as the Si-based nanocomposite active material. In the test cell examples reported herein, the anode coating comprised the binder composition (e.g., PAA-based binder) or binder mixture (e.g., CMC/SBR mixture, CMC-NT476-1-x example binder mixture) at a mass fraction in a range of about 5.5 to about 13 wt. %. For test cell examples in which the anode active material comprised a mixture of about 50 wt. % of Si—C nanocomposite particles and about 50 wt. % of graphite particles, the anode coating comprised conductive additives (e.g., carbon black, SWCNT) at a mass fraction in a range of 0.1 wt. % to 0.4 wt. %. In the test cell examples in which the anode active material comprised Si—C nanocomposite particles at 100 wt. %, the anode coating comprised conductive additives (e.g., carbon black, SWCNT) at a mass fraction of about 0.4 wt. %. In both types of test cells ((1) anode active material comprised Si—C nanocomposite particles at 100 wt. %, and (2) anode active material comprised a mixture of about 50 wt. % of Si—C nanocomposite particles and about 50 wt. % of graphite particles), the areal capacity loading of the anode was about 5.40 mAh/cm². The anode coating comprises anode active material, binder composition or binder mixture, and conductive additives, as well as other functional additives, if any. Unless otherwise indicated, the mass ratio of CMC to SBR binder was about 1:9.8. Unless otherwise indicated, the mass ratio of CMC to a respective NT476-1-x example binder was about 1:5.

For the test cells reported herein, the cathode coating included high-voltage NMC811 (with an approximate composition of LiNi_{0.8}Co_{0.1}Mn_{0.1}O₂) active material (with specific reversible capacity of ˜200 mAh/g when normalized by the weight of active materials in the cathode) casted on Al current collector foil from an organic solvent suspension including a polyvinylidene fluoride (PVDF)-based binder and a carbon black conductive additive. The anode:cathode areal capacity ratio (N:P ratio) was in a range of about 1.08:1 to about 1.17:1 and the charge voltage was about 4.2 V. A polymer-ceramic separator was interposed between the anode coating and the cathode coating. An electrolyte was infiltrated in between the anode coating and the cathode coating. In the test cell examples in which the anode active material comprised Si—C nanocomposite particles at 100 wt. %, an electrolyte of the following approximate composition was used: 12.4 wt. % LiPF₆ (as primary lithium salt), 3.1 wt. % LiFSI (lithium bis(fluorosulfonyl)imide, as lithium salt additive), 5.4 wt. % PC (propylene carbonate, a cyclic carbonate), 14.2 wt. % FEC (fluoroethylene carbonate, a fluorinated cyclic carbonate), 10.8 wt. % EC (ethylene carbonate, a cyclic carbonate), 7.9 wt. % DEC (diethyl carbonate, a linear carbonate), 41.7 wt. % EP (a linear ester), 3.3 wt. % VC (vinylene carbonate, a cyclic carbonate), 0.4 wt. % ADN (adiponitrile, a nitrogen-comprising additive, comprising two nitrile groups), 0.4 wt. % HTCN (1,3,6-hexanetricarbonitrile, a nitrogen-comprising additive, comprising three nitrile groups), and 0.4 wt. % LFO (lithium difluorophosphate or LiDFP, as another lithium salt additive). In the test cell examples in which the anode active material comprised a mixture of about 50 wt. % of Si—C nanocomposite particles and about 50 wt. % of graphite particles, an electrolyte of the following approximate composition was used: 13.92 wt. % LiPF₆, 13.33 wt. % FEC, 5.04 wt. % EC, 3.85 wt. % EMC (ethyl methyl carbonate, a linear carbonate), 62.49 wt. % DMC (dimethyl carbonate, a linear carbonate), 0.52 wt. % VC, and 0.85 wt. % LFO. In the test cell examples reported herein, the median cathode thickness was about 75 μm, and the median cathode loading was about 23 mg/cm². In the test cell examples in which the anode active material comprised Si—C nanocomposite particles at 100 wt. %, the median anode loading was about 3.5 mg/cm², and the anode coating thickness was in a range of about 30 to 35 μm. In the test cell examples in which the anode active material comprised a mixture of about 50 wt. % of Si—C nanocomposite particles and about 50 wt. % of graphite particles, the median anode loading was about 6.0 mg/cm², and the anode coating thickness was in a range of about 50 to 60 μm.

Table 3 (FIG. 12) shows selected performance data for test cells of respective binder compositions (PAA-based binder, SBR in combination with CMC, or a respective example binder NT476-1-x in combination with CMC). In the test cells reported in Table 3, Si—C nanocomposite particles were the sole active material in the anode coating. The performance data reported in Table 3 include formation efficiency, volumetric energy density, volumetric charge density, normalized coating thickness change, the direct-current resistance, the estimated number of cycles to reach 80% of the cycling-start capacity, the maximum areal expansion, the discharge voltage, and capacity retention at 2 C discharge. The normalized capacity is defined as the charge capacity obtained for a given charge rate (e.g., 2 C rate in this case) (expressed in mAh) normalized to cycling start capacity (capacity upon completion of cycle 3) (expressed in mAh). Formation efficiency is defined as cycling start discharge capacity (discharge capacity upon completion of cycle 3) divided by the first cycle charge capacity. Among the test cells considered in Table 3, the formation efficiencies were in a range of about 81.0% to about 82.7%. The volumetric energy density (abbreviated as VED) is defined as the cell energy (after the fourth cycle) (expressed in Wh) divided by the cell's external volume (expressed in liters). The VED values were in a range of about 930 to about 979 Wh/liter. Among the test cells comprising an example binder (NT476-1-x) in the anode, the test cell comprising NT476-1-49 (surfactant composition comprises anionic nonreactive surfactant and nonionic nonreactive surfactant exhibiting an HLB value of about 9.2, reactive composition is free of TMSPMA) exhibited the highest VED value of 947 Wh/l, and the test cell comprising NT476-1-48 (surfactant composition comprises anionic nonreactive surfactant and nonionic nonreactive surfactant exhibiting an HLB value of about 9.2, free of PEGDMA) exhibited the second highest VED value of 944 Wh/l. The volumetric charge density (abbreviated as VQD) is defined as the anode capacity (after the fourth cycle) (expressed in mAh) divided by anode volume (expressed in cm³). The VQD values were in a range of about 655 to about 771 mAh/cm³. Among the test cells comprising an example binder (NT476-1-x) in the anode, the test cell comprising NT476-1-49 (surfactant composition comprises anionic nonreactive surfactant and nonionic nonreactive surfactant exhibiting an HLB value of about 9.2, free of TMSPMA) exhibited the highest VQD value of 720 mAh/cm³, the test cell comprising NT476-1-37 (surfactant composition comprises anionic nonreactive surfactant and nonionic nonreactive surfactant exhibiting an HLB value of about 9.2) exhibited the second highest VQD value of 720 mAh/cm³, and the test cell comprising NT476-1-48 (surfactant composition comprises anionic nonreactive surfactant and nonionic nonreactive surfactant exhibiting an HLB value of about 9.2, reactive composition is free of PEGDMA) exhibited the third highest VQD value of 712 mAh/cm³. Accordingly, in some implementations, it may be preferable to employ nonreactive surfactant(s) in a surfactant composition for emulsion polymerization of a binder polymer. In some implementations, it may be preferable for the nonreactive surfactant(s) to exhibit an HLB value in a range of about 8 to about 11 or in a range of about 9 to about 10 or in a range of about 9 to about 9.5. In some implementations, it may be preferable to employ a reactive composition that is free of silicon-comprising compounds or silicon-substituted (meth)acrylates or TMSPMA. In some implementations, it may be preferable to employ a reactive composition that is free of macromolecules comprising oxyethylene groups and comprising one or more (meth)acrylate groups. In some implementations, it may be preferable to employ a reactive composition that is free of PEGDMA.

The normalized coating thickness change (abbreviated as Δt/Li) is defined as the coating thickness change (expressed in μm), divided by the quantity of lithium ions per unit area of electrode inserted into the electrode (anode) in going from the discharged state to the charged state (expressed in mAh/cm²). The coating thickness change is the difference in coating thickness between the charged state at cycle 4 and the as-prepared electrode coating. The coating thickness is measured, using a high-accuracy digital contact sensor (with approximately 0.1 μm resolution), on test cells after undergoing four charge/discharge cycles. The normalized coating thickness change may be regarded as a quantitative measurement of the degree of swell of an electrode coating, particularly the degree of swell in the thickness direction. The normalized thickness change values were in a range of about 2.18 to about 3.59 μm cm²/mAh.

The internal direct-current (DC) resistance of a cell is sometimes referred to as DC resistance or DCR. DC resistance is determined as follows: A series of millisecond-long current pulses are applied to the cell at a predetermined state-of-charge (e.g., 10% state-of-charge, 50% state-of-charge, etc.), and the resulting voltages are measured. An average voltage is determined by averaging over the respective voltages that are measured for each of the current pulses. The DCR is the average voltage divided by the normalized applied current. The normalized applied current is expressed as the applied current (expressed in A) divided by the cell's capacity (the capacity is expressed in Ah). For the test cells considered in Table 3, the DCR values were measured at a 50% state-of-charge. The test cells with the PAA-based binder and the CMC/SBR binder exhibited DCR values of 0147 Ω·Ah and 0.142 Ω·Ah, respectively. On the other hand, the test cells with the respective example binders (NT476-1-x) in combination with CMC exhibited significantly lower DCR values, such as 0.111 Ω·Ah for NT476-1-1, 0.119 Ω·Ah for NT476-1-23, 0.106 Ω·Ah for NT476-1-36, 0.111 Ω·Ah for NT476-1-37, 0.109 Ω·Ah for NT476-1-40, 0.112 Ω·Ah for NT476-1-48, 0.110 Ω·Ah for NT476-1-49, and 0.116 Ω·Ah for NT476-1-51.

The estimated number of cycles to reach 80% of the cycling-start capacity, during room temperature cycling, is abbreviated as N80. For the test cells considered in Table 3, the test cells with the PAA-based binder and the CMC/SBR binder exhibited N80 values of about 1150 cycles and about 1000 cycles, respectively. Among the test cells with example binders (NT476-1-x), the test cells with example binders incorporating nonreactive surfactants (NT476-1-36, NT476-1-37, NT476-1-48, NT476-1-49, NT476-1-51) exhibited N80 values in a range of about 950 to about 1050 cycles. In contrast, the test cells with example binders incorporating reactive surfactants (NT476-1-1, NT476-1-23, NT476-1-40) exhibited significantly lower N80 values of about 800, about 200, and about 400 cycles, respectively. Compared to the NT476-1-1-based test cell, the NT476-1-23-based test cell includes a larger amount of reactive surfactant (reactive surfactant increased from 3.11 parts to 4.11 parts of reactive surfactant relative to 100 parts of reactive composition) and a greater average number of moles of CH₂CH₂O groups in the nonionic nonreactive surfactant (average number of moles increased from about 20 moles to about 30 moles). The N80 value decreased from about 800 cycles (NT476-1-1) to about 200 cycles (NT476-1-23). Compared to the NT476-1-1-based test cell, the NT476-1-40-based test cell includes a larger amount of styrene (styrene mass fraction increased from 39.9 wt. % to 74.1 wt. %), resulting in a stiffer binder. The N80 value decreased from about 800 cycles (NT476-1-1) to about 400 cycles (NT476-1-23). In some implementations, it may be beneficial to consider the DCR and N80 characteristics in combination. Accordingly, among the test cells considered in Table 3, the test cells incorporating the nonreactive surfactants (NT476-1-36, NT476-1-37, NT476-1-48, NT476-1-49, NT476-1-51) exhibited the best combination of lower DCR and greater cycle life (N80).

As a test cell undergoes multiple charging and discharging cycles, the anode of the cell exhibits areal expansion and contraction. Areal expansion may be observed during each lithiation (charging) stage and areal contraction may be observed during each delithiation (discharging) stage. The observed areal expansion may vary from cycle to cycle. The areal expansion was calculated relative to the initial anode area before initial charging. The maximum areal expansion that was observed during the first 20 cycles was determined to be the maximum areal expansion. An imaging system is employed to capture the expansion (and contraction) of an anode of a test cell (encased in a transparent container) along two orthogonal dimensions in real time. For the test cells considered in Table 3, the anode of the PAA-based test cell exhibited a maximum areal expansion of about 5.1%. The anodes of test cells based on CMC/SBR and the respective example binders in combination with CMC are expected to show a maximum areal expansion of less than 1%.

Among the test cells considered in Table 3, the discharge voltages were in a range of 3.383 to 3.403 V. The capacity retention (also sometimes referred to as normalized capacity) is defined as the charge capacity obtained for a given charge rate (e.g., 2 C rate in this case) (expressed in mAh) normalized to cycling start capacity (capacity upon completion of cycle 3) (expressed in mAh). The cell was cycled for a minimum of 5 cycles to obtain an average capacity at a given charge rate. The capacity retention at a 2 C discharge rate was in a range of 0.84 to 0.88. Certain observations about processability of the slurry and the coating are also provided in Table 3. During coating, the PAA-based slurry had air bubbles while no air bubbles were observed for the slurries comprising CMC/SBR and the respective example binders in combination with CMC. The PAA-based coating was subject to drying at 100° C. while the other coatings (CMC/SBR and the respective example binders in combination with CMC) were subject to drying at 80° C. The PAA-based coating was observed to be brittle while the other coatings were observed to be flexible. In the case of the PAA-based slurry, compatibility of the slurry with both carbon black and single-walled carbon nanotubes (SWCNTs) was observed. In the case of slurries incorporating CMC/SBR or CMC in combination with the respective example binders, compatibility of the slurry with SWCNTs was observed.

FIG. 13 shows a graphical plot 1300 illustrating the dependence of DCR on the state-of-charge (SOC, as determined at the start of each DC resistance measurement) for test cells incorporating the PAA-based binder, CMC/SBR binder, and the respective example binder in combination with CMC. In the test cells reported in FIG. 13, Si—C nanocomposite particles were the sole active material in the anode coating. The DCR was measured for SOC values in a range of 10% to 90% (at 10%, 20%, 30%, 40%, 50%, 60%, 70%, 80%, and 90%). Notably, the test cells incorporating the PAA-based binder and CMC/SBR binder exhibited the highest DCR values over SOC values ranging between 10% and 90%. All the test cells incorporating the example binders exhibited lower DCR values than the PAA-based and CMC/SBR-based test cells over SOC values ranging between 10% and 90%. Among the test cells incorporating the example binders, the test cells incorporating NT476-1-23 (with a greater amount of reactive surfactant than NT476-1-1 and NT476-1-40) exhibited higher DCR than the test cells incorporating NT476-1-36 (containing nonreactive surfactants), NT476-1-37 (containing nonreactive surfactants), NT476-1-1 (containing reactive surfactants), and NT476-1-40 (containing reactive surfactants).

FIG. 14 shows a graphical plot 1400 illustrating the DC resistance (DCR) measured at selected cycles (at cycles 4, 101, 201, 301, and 401) for test cells incorporating the PAA-based binder, CMC/SBR binder, and the respective example binder (NT476-1-36, NT476-1-37) in combination with CMC. In the test cells reported in FIG. 14, Si—C nanocomposite particles were the sole active material in the anode coating. Note that NT476-1-36 and NT476-1-37 are example binders comprising nonreactive surfactants. At cycle 4, the test cells comprising NT476-1-36 and NT476-1-37 exhibited noticeably lower DCR values than CMC/SBR-based and PAA-based test cells. A trend of increasing DCR with increased number of cycles is observed, although the trend is not as pronounced in PAA-based test cells. It is understood, however, that as the number of cycles increases, there is a greater contribution to the DCR from the resistance of the SEI (solid-electrolyte interphase) that continues to grow with the battery cycling, resulting in a reduced difference in DC resistance between test cells comprising the CMC/SBR binder and the PAA-based binder on one hand and the NT476-1-36 and NT476-1-37 binders on the other hand.

### Example 2

FIG. 15 is a graphical plot 1500 of the DCR of battery test cells comprising: (1) a styrene-butadiene nibber (SBR) binder in combination with carboxymethyl cellulose (CMC) or (2) the NT476-1-37 binder in combination with CMC, at respective CMC to binder mass ratios. In the test cells reported in FIG. 15, a mixture of Si—C nanocomposite particles and graphite particles (the mixture contained about 50 wt. % of Si—C nanocomposite particles and about 50 wt. % of graphite particles) was the active material in the anode coating. From left to right, the anode coatings of the respective test cells comprised: (Sample A1) CMC/NT476-1-37 mixture, mass ratio of CMC:NT476-1-37 is about 1:1; (Sample A2) CMC/NT476-1-37 mixture, mass ratio of CMC:NT476-1-37 is about 1:2; (Sample A3) CMC/NT476-1-37 mixture, mass ratio of CMC:NT476-1-37 is about 1:3; (Sample A4) CMC/NT476-1-37 mixture, mass ratio of CMC:NT476-1-37 is about 1:3; (Sample A5) CMC/SBR mixture, mass ratio of CMC:SBR is about 1:3; (Sample A6) CMC/SBR mixture, mass ratio of CMC:SBR is about 1:4. In the test cells reported in FIG. 15, the binder content in the anode coating was about 6.9 wt. %, except Sample 4 for which the binder content was about 8.0 wt. %. Generally, the samples comprising NT476-1-37 (Samples A1, A2, A3) exhibited lower DCR values than the samples comprising SBR (Samples A4, A5). Samples A1 and A2, with CMC:NT476-1-37 mass ratios of 1:1 and 1:2, respectively, exhibited DCR values that are quite low, in a range of about 0.082 to about 0.083 Ω·Ah. These DCR values are lower than DCR values that are observed in samples with higher mass fractions of the binder (e.g., CMC:NT471-1-37 mass ratios of 1:3, 1:4, 1:5, or higher mass fractions of binder). Accordingly, in some implementations, it may be preferable for a mass ratio of CMC to the binder material prepared according to the methods disclosed herein (e.g., NT471-1-x such as NT471-1-37) to be in a range of about 1:5 to about 1:1 or in a range of about 1:4 to about 1:1 or in a range of about 1:3 to about 1:1 or in a range of about 1:2 to about 1:1. In some implementations, it may be preferable for a mass ratio of CMC to the binder material prepared according to the methods disclosed herein (e.g., NT471-1-x such as NT471-1-37) to be in a range of about 1:2.5 to about 2:1 including exemplary values of about 1:2.5, about 1:2, about 1:1.5, about 1:1, about 1.1:1, about 1.2:1, about 1.5:1, and about 2:1 (note that each of the foregoing example values may constitute an upper bound or a lower bound to a sub-range that is bounded to any of the other stated values, as explained in a preceding paragraph related to numerical ranges).

Table 4 (FIG. 16) shows selected performance data for test cells of respective binder compositions (PAA-based binder, SBR in combination with CMC, or a respective example binder (NT476-1-1, NT476-1-37) in combination with CMC). Table 4 shows performance parameters similar to those of Table 3. The test cells considered in Table 4 comprise anode active material of about 50 wt. % silicon-carbon nanocomposite particles as described above and about 50 wt. % graphite particles. From left to right, the anode coatings of the respective test cells comprised: (Sample B1) PAA-based binder; (Sample B2) CMC/SBR binder mixture; (Sample B3) CMC/NT476-1-1 mixture, mass ratio of CMC:NT476-1-1 is about 1:5; (Sample B4) CMC/NT476-1-37 mixture, mass ratio of CMC:NT476-1-37 is about 1:3; (Sample B5) CMC/NT476-1-37 mixture, mass ratio of CMC:NT476-1-37 is about 1:1. Among the test cells considered in Table 4, the formation efficiencies were in a range of about 83.3% to 85.0%. The VED values were in a range of about 923 to about 942 Wh/liter. The VQD values were in a range of about 597 to about 645 mAh/cm³. The normalized coating thickness change (Δt/Li) values were in a range of about 2.56 to about 3.41 μm cm²/mAh. The test cells with the PAA-based binder (Sample B1) and the CMC/SBR binder (Sample B2) exhibited DCR values of 0101 Ω·Ah and 0.094 Ω·Ah, respectively. The test cells with the respective example binders (NT476-1-1 (reactive surfactant), NT476-1-37 (nonreactive surfactant)) in combination with CMC exhibited lower DC resistance values of 0.092 Ω·Ah to 0.083 Ω·Ah. In particular, the test cells (Sample B5) comprising an example binder with a nonreactive surfactant (NT476-1-37), with a CMC:NT476-1-37 mass ratio of about 1:1, exhibited the lowest DC resistance among the test cells considered in Table 4 (0.083 Ω·Ah). The test cells with the PAA-based binder and the CMC/SBR binder exhibited N80 values of about 1500 cycles and 1250 cycles, respectively. Among the test cells with example binders, the test cells with an example binder incorporating nonreactive surfactants (NT476-1-37) exhibited N80 values of about 900 cycles (Sample B4, CMC:NT476-1-37 mass ratio of about 1:3) and about 1200 cycles (Sample B5, CMC:NT476-1-37 mass ratio of about 1:1). These examples show that the CMC:binder mass ratios (e.g., CMC:NT476-1-37 mass ratios) in the anode coatings may exert a significant effect on the cycle life (N80) of the resulting battery cells. In some implementations, it may be preferable for a mass ratio of CMC to the binder material prepared according to the methods disclosed herein (e.g., NT471-1-x such as NT471-1-37) to be in a range of about 1:2.5 to about 1:1 or in a range of about 1:2 to about 1:1. In some implementations, it may be preferable for a mass ratio of CMC to the binder material prepared according to the methods disclosed herein (e.g., NT471-1-x such as NT471-1-37) to be in a range of about 1:2.5 to about 2:1 including exemplary values of about 1:2.5, about 1:2, about 1:1.5, about 1:1, about 1.1:1, about 1.2:1, about 1.5:1, and about 2:1 (note that each of the foregoing example values may constitute an upper bound or a lower bound to a sub-range that is bounded to any of the other stated values, as explained in a preceding paragraph related to numerical ranges). The test cells (Sample B3) with an example binder incorporating reactive surfactants (NT476-1-1) exhibited significantly lower N80 values of about 175 cycles. In some implementations, it may be beneficial to consider the DC resistance and N80 characteristics in combination. Accordingly, among the test cells considered in Table 4, the test cells incorporating the nonreactive surfactants (NT476-1-37) exhibited the best combination of lower DC resistance and greater cycle life (N80).

Among the test cells considered in Table 4, the anode of the PAA-based test cell exhibited a maximum areal expansion of about 1.3%. The anodes of test cells based on CMC/SBR and the respective example binders in combination with CMC are expected to show a maximum areal expansion of less than about 1%.

Among the test cells considered in Table 4, the discharge voltages were in a range of 3.454 to 3.471 V. The capacity retention at a 2 C discharge rate was in a range of 0.87 to 0.92. Certain observations about processability of the slurry and the coating are also provided in Table 4. During coating, the PAA-based slurry had air bubbles while no air bubbles were observed for the slurries comprising CMC/SBR and the respective example binders in combination with CMC. The PAA-based coating was subject to drying at 100° C. while the other coatings (CMC/SBR and the respective example binders in combination with CMC) were subject to drying at 80° C. The PAA-based coating was observed to be brittle while the other coatings were observed to be flexible. In the case of the PAA-based slurry, compatibility of the slurry with both carbon black and single-walled carbon nanotubes (SWCNTs) was observed. In the case of slurries incorporating CMC/SBR or CMC in combination with the respective example binders, compatibility of the slurry with SWCNTs was observed.

FIG. 17 shows a graphical plot 1700 of a dependence of a normalized discharge capacity (normalized to respective discharge capacities at a normalized discharge rate of 0.5 C) on normalized discharge rate (C-rate) for two types of test cells: (1) test cells comprising NT476-1-1 (comprising reactive surfactants) in combination with CMC, and (2) test cells comprising NT476-1-37 (comprising nonreactive surfactants) in combination with CMC. For both types of test cells, a mixture of Si—C nanocomposite particles and graphite particles (the mixture contained about 50 wt. % of Si—C nanocomposite particles and about 50 wt. % of graphite particles) was the active material in the anode coating. The NT476-1-37-based test cells exhibited a smaller decay (as a percentage of normalized discharge capacity) for increasing normalized discharge rates than the NT476-1-1-based test cells. Accordingly, in some implementations in which higher discharge rates are required (e.g., about 1.5 C or higher, about 2.0 C or higher), certain of the example binders (e.g., NT476-1-37, comprising a nonreactive surfactant) may be employed.

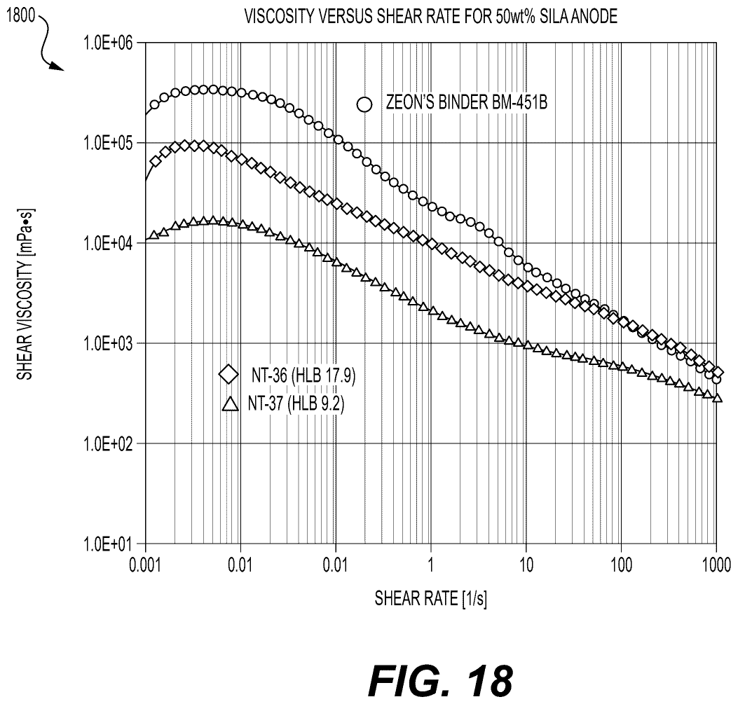

FIG. 18 shows a graphical plot 1800 depicting a dependence of the shear viscosity on the shear rate for three slurry samples: (1) a slurry comprising SBR binder in combination with CMC (data points labeled as BM-451), (2) a slurry comprising an example binder NT476-1-36 (surfactant composition comprises nonreactive surfactants, HLB value of the nonionic nonreactive surfactant is about 17.9) in combination with CMC (data points labeled as NT-36), and (3) a slurry comprising an example binder NT476-1-37 (surfactant composition comprises nonreactive surfactants, HLB value of the nonionic nonreactive surfactant is about 9.2) in combination with CMC (data points labeled as NT-37). Measurements were carried out on a rheometer. The slurry comprising CMC/SBR-binder exhibits a gel-like behavior, the slurry comprising CMC/NT476-1-37 exhibits a more liquid-like behavior, and the slurry comprising CMC/NT476-1-36 exhibits a behavior that is in between those of the two foregoing example slurries. In the examples shown, the slurries comprised anode active material of about 50 wt. % Si—C composite particles and about 50 wt. % graphite particles, the CMC:binder ratio was about 1:4, the solids content in the slurry was about 50.8 wt. %, and the binder content in the dried electrode was about 6.9 wt. %. The anode coating comprising NT476-1-37 (nonreactive surfactant with HLB of about 9.2) exhibited better coating quality (more uniform) than the anode coating comprising NT476-1-36 (nonreactive surfactant with HLB of about 17.9). The use of a less hydrophilic (lower HLB value) surfactant may result in electrode slurries exhibiting lower viscosity (e.g., more liquid-like behavior), which may in turn result in higher coating densities after drying. Accordingly, it may be preferable to employ surfactants (e.g., nonionic nonreactive surfactants) exhibiting HLB values that are no greater than about 17, about 16, about 15, about 14, about 13, about 12, 11, about 10, or about 9.5. In some implementations, the HLB values of such surfactants may be at least about 8 or about 9. For the slurries reported in FIG. 18, a mixture of Si—C nanocomposite particles and graphite particles (the mixture contained about 50 wt. % of Si—C nanocomposite particles and about 50 wt. % of graphite particles) was the active material in the slurry. The rheological properties were measured using the Anton Paar MCR301 rotational rheometer equipped with a parallel plate of 25 mm diameter. The measurements were conducted at a temperature of 25° C. over a shear rate range from 0.001/s to 1000/s.

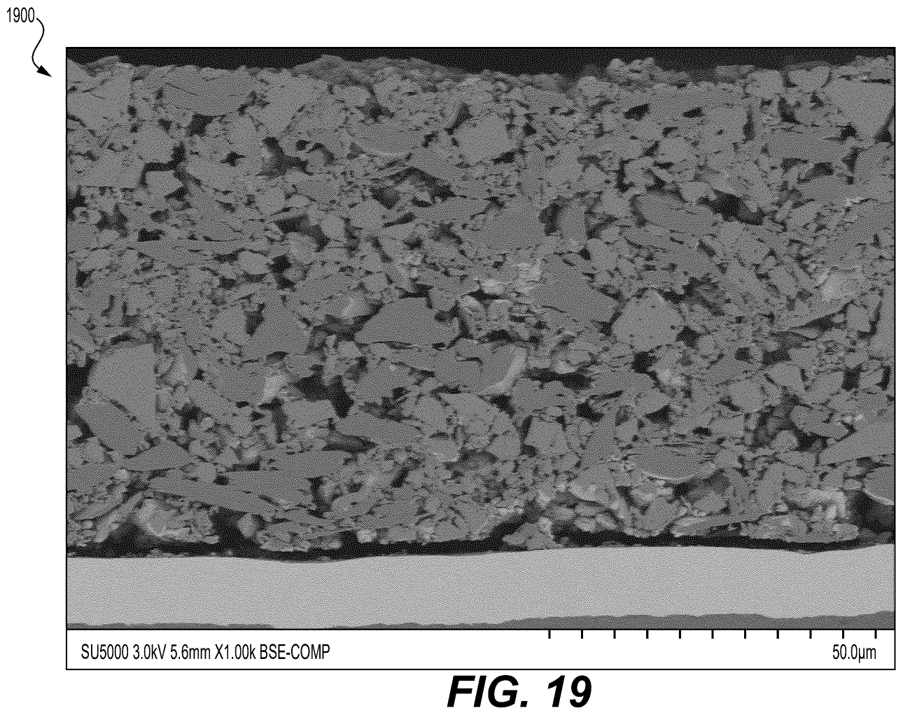

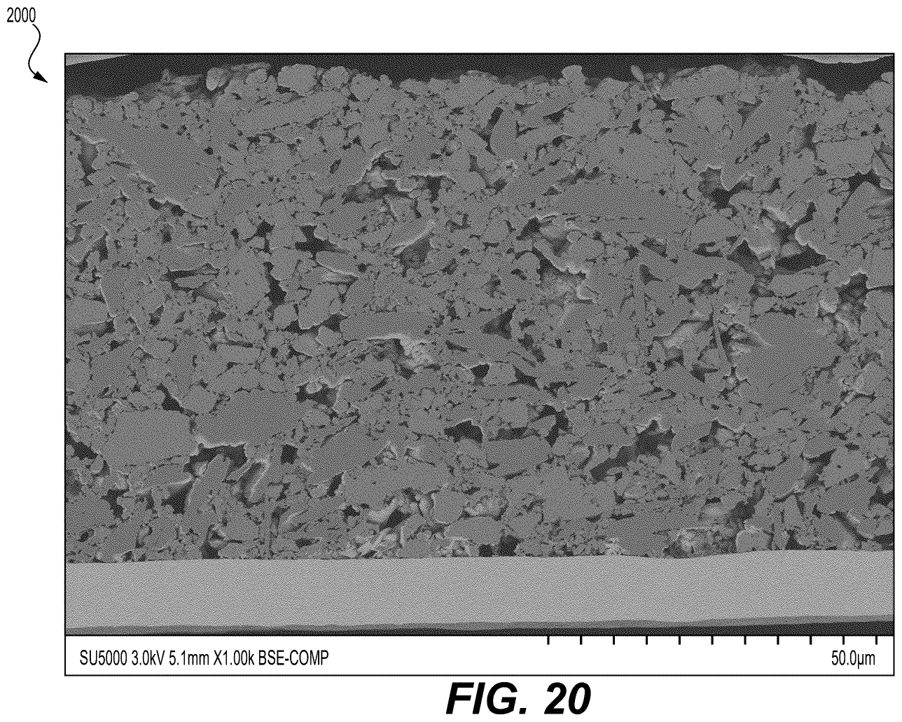

FIGS. 19 and 20 are SEM cross section images (1900, 2000) of electrode coatings formed using slurries comprising CMC/SBR binder and CMC/NT476-1-37 binder, respectively. For the electrode coatings shown in FIGS. 19 and 20, a mixture of Si—C nanocomposite particles and graphite particles (the mixture contained about 50 wt. % of Si—C nanocomposite particles and about 50 wt. % of graphite particles) was the active material in the respective electrode coating. A cross section of the electrode was prepared using an ion milling system IB-19520CCP CROSS SECTION POLISHER™ by JEOL Ltd. and SEM cross section images were observed at accelerating voltage of 5 kV using a field emission scanning electron microscope SU 5000 by Hitachi High-Tech Corp.

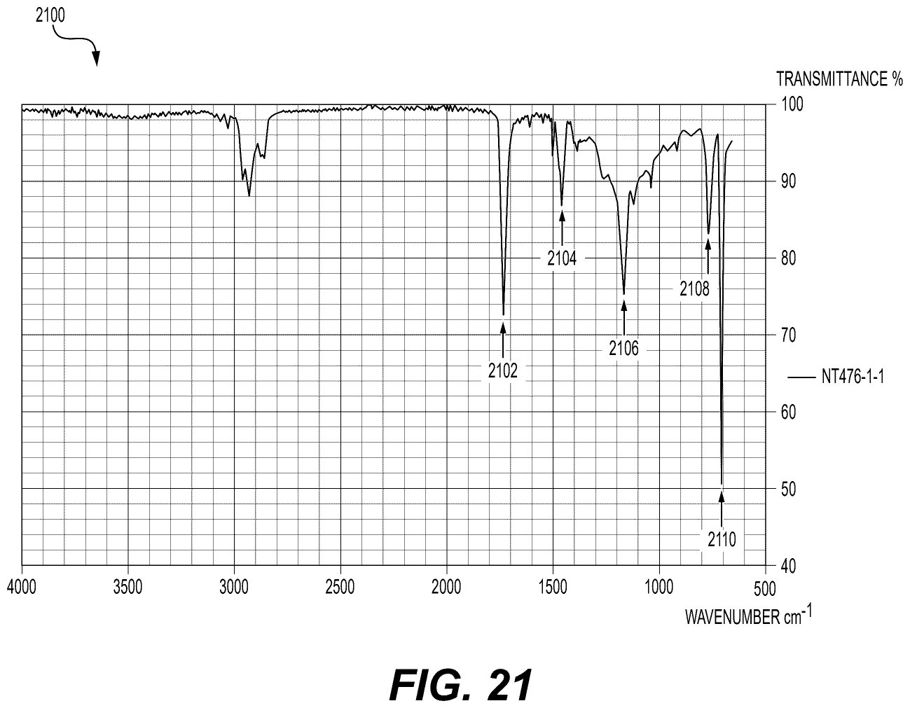

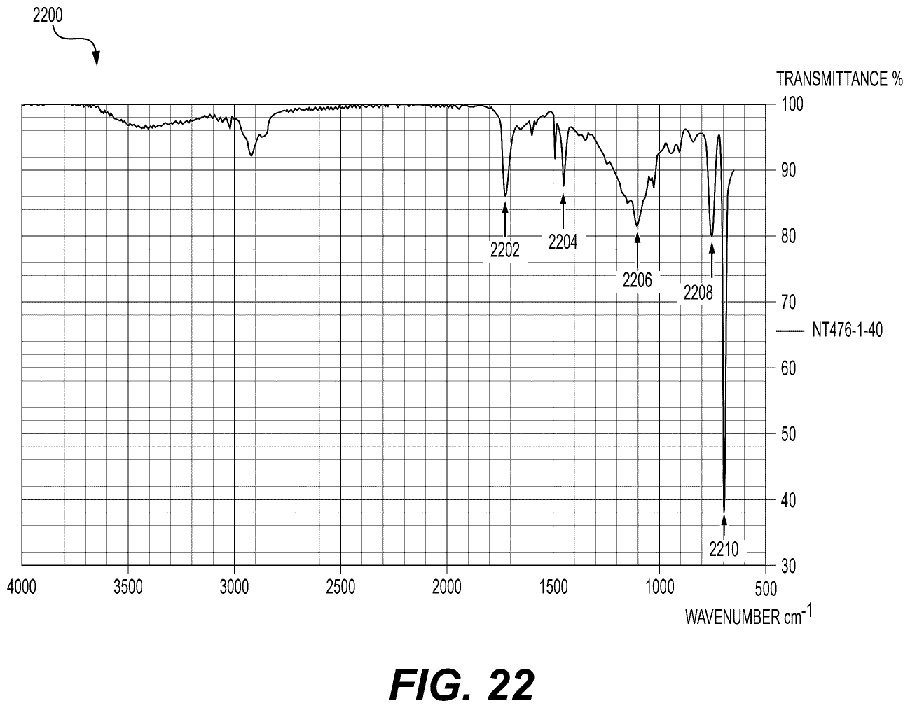

FIGS. 21 and 22 are graphical plots (2100, 2200) of FTIR spectra obtained from binder films of NT471-1-1 and NT476-1-40, respectively. The FTIR spectra for the binder films were measured in a range of 650 to 4000 cm⁻¹ at 1 cm⁻¹ resolution using a using Thermo Scientific Nicolet 6700 spectrometer in attenuated total reflectance. The reactive compositions employed in the emulsion polymerization of NT471-1-1 and NT476-1-40 binders comprised styrene and 2-ethylhexyl acrylate (2EH) at different mass fractions. The reactive composition for NT476-1-1 comprised styrene at a mass fraction of about 39.9 wt. % and 2EH at a mass fraction of about 48.8 wt. % (styrene:2EH mass ratio of about 0.82:1.00). The reactive composition for NT476-1-40 comprised styrene at a mass fraction of about 74.1 wt. % and 2EH at a mass fraction of about 14.6 wt. % (styrene:2EH mass ratio of about 5.08:1.00). Graphical plot 2100, showing the FTIR spectrum of the NT476-1-1 binder film, includes peaks 2102, 2104, 2106, 2108, and 2110. Among these peaks, peaks 2102, 2104, and 2106 are similar to peaks that are observed in FTIR spectra of poly(2-ethylhexyl acrylate) and peaks 2108 and 2110 are similar to peaks that are observed in FTIR spectra of polystyrene. Accordingly, the FTIR signatures illustrated in graphical plot 2100 are consistent with the NT476-1-1 binder being a copolymer of styrene and 2EH. Graphical plot 2200, showing the FTIR spectrum of the NT476-1-40 binder film, includes peaks 2202, 2204, 2206, 2208, and 2210. Among these peaks, peaks 2202, 2204, and 2206 are similar to peaks that are observed in FTIR spectra of poly(2-ethylhexyl acrylate) and peaks 2208 and 2210 are similar to peaks that are observed in FTIR spectra of polystyrene. Accordingly, the FTIR signatures illustrated in graphical plot 2200 are consistent with the NT476-1-40 binder being a copolymer of styrene and 2EH. A difference between graphical plots 2100 (NT476-1-1) and 2200 (NT476-1-40) is that the heights of the “polystyrene-like” peaks (2108, 2110; 2208, 2210), normalized by the respective “poly(2-ethylhexyl acrylate)-like” peaks (2102, 2104, 2106; 2202, 2204, 2206), are greater in graphical plot 2200. This is consistent with the reactive composition of NT476-1-40 comprising a greater mass fraction of styrene. In some implementations, these copolymers (e.g., copolymers in NT476-1-1 binder or NT476-1-40 binder) may additionally comprise monomeric units derived from other components of the reactive composition (e.g., for NT476-1-1 and NT476-1-40, glycidyl methacrylate (GMA), PEGDMA, TMSPA, and acrylic acid (AA)). In some implementations, the binder includes a surfactant (e.g., a reactive surfactant) that is covalently incorporated into the copolymer.

Precise control of the properties of the surfactant composition may play an important role in determining the rheological behavior of an electrode slurry. In some implementations, the use of a less hydrophilic surfactant (e.g., a nonreactive surfactant with a relatively low HLB value, such as in a range of about 8 to about 11) may result in slurries with lower viscosities and more liquid-like behavior. Such characteristics may be beneficial for obtaining good quality coatings. Nevertheless, it is not so straightforward to determine the HLB values in an emulsion slurry. Accordingly, the inventors have developed an experimental procedure that allows for quantifying a mass ratio of CH₂CH₂O— (polyethylene glycol (PEG) or oxyethylene) units in a supernatant extract to C₆H₅— (aromatic) units in the supernatant extract. In some cases, this mass ratio may be representative of the mass ratio of CH₂CH₂O— (PEG) units in the surfactant(s) of the binder emulsion to C₆H₅— (aromatic) units in the surfactant(s) of the binder emulsion. Such supernatant extract is obtained by filtering and drying a supernatant. The supernatant is obtained from a sample of an emulsion of the binder material by (a) adding sufficient ethanol to the sample to induce precipitation of at least a portion of the sample and (b) centrifugation of the sample after the precipitation. The mass ratio is calculated from (1) an estimated mass fraction of the PEG units in the supernatant extract as quantified by proton nuclear magnetic resonance (proton NMR or ¹H NMR) measurements on the supernatant extract and (2) an estimated mass fraction of the aromatic units in the supernatant extract as quantified by the ¹H NMR measurements. Note that the amount of obtained supernatant is preferably sufficient for conducting the proton NMR measurement; the preferred amounts of obtained supernatant may be, for example, 0.01 g or more, 0.03 g or more, 0.1 g or more, or 0.3 g or more. This may in turn determine the minimum amount of precipitate. Proton NMR measurements provide information about the structure of the surfactant including its hydrophilicity.

The following describes the process steps in the proton NMR measurement and quantification in greater detail.

Obtaining extracts from emulsion using EtOH(Ethanol): Approximately 10 grams of emulsion was weighted in a PTFE container. After adding 10 grams of EtOH, the container was centrifugated at 20000 rpm×10 min and the obtained supernatant was filtered through a glass filter with mesh size of 1 μm. The filtered liquid was dried using a rotary evaporator (50° C., 70 torr) with additional heat treatment under vacuum at room temperature overnight to obtain dried solid (hereinafter referred to as the EtOH extract or supernatant extract). In some cases, a mass of the EtOH extract was about 0.1 g.

The NMR measurements were carried out as follows. A portion (e.g., about 0.02 g) of the EtOH extract was used as a sample for NMR measurement (“NMR sample”): The NMR sample and TSP (sodium 3-(trimethylsilyl)-1-propanesulfonate), which is used as an internal standard, were weighted in respective sample vials. They were dissolved in deuterium oxide (D₂O) for NMR measurement. The NMR measurement conditions were as follows:
Equipment: Bruker AVANCE NEO (600 MHz)
Measurement Temperature: Room temperature (approximately 22° C.)
Measured Nucleus: ¹H

The methyl signal of TSP (0 ppm) was used as the reference to quantify the amount of PEG units that have CH₂CH₂O— with a molecular weight of 44, and aromatic units that are assumed to be monosubstituted with C₆H₅—, with a molecular weight of 77. The following calculations (Parts 1, 2, and 3) were carried out.

### Part 1 Calculation

M_{int std} is the mass of the internal standard (g).
MW_{int std} is the molecular weight of the internal standard (g/mol).
N_{int std} is the number of moles of the internal standard (moles).
N_{int std} is calculated as follows:

$${N}_{int std} = \frac{{M}_{int std}}{{MW}_{int std}} .$$

A quantity S_{int std} is calculated from the NMR integral value of the internal standard as measured by proton NMR:

$${S}_{int std} = \frac{NMR integral value of internal standard}{No . of protons in internal standard} .$$

Q₁ is the number of moles per NMR integral value (per proton).
Q₁ is calculated as follows:

$${Q}_{1} = \frac{{N}_{int std}}{{S}_{int std}} .$$

### Part 2 Calculation

In the examples shown, a structural unit is a PEG unit or an aromatic unit.

A quantity Sᵤₙᵢₜ is calculated from the NMR integral value of the respective structural unit as measured by proton NMR:

$${S}_{unit} = \frac{NMR integral value of structural unit}{No . of protons instructural unit} .$$

MWᵤₙᵢₜ is the molecular weight of the respective structural unit (g/mol).
Q₂ is the mass of the respective structural unit contained in the NMR sample.
Q₂ is calculated as follows:

$${Q}_{2} = {Q}_{1} \cdot {MW}_{unit} \cdot {S}_{unit} .$$

### Part 3 Calculation

M_{NMR sample} is the mass of the NMR sample (g).
M_{Extract} is the mass of the EtOH extract (g).
M_{Emulsion} is the mass of the emulsion sample (g).
Q₃ is the mass of the respective structural unit estimated to be contained in the EtOH extract.
Q₃ is calculated as follows:

$${Q}_{3} = \frac{{Q}_{2} \cdot {M}_{Extract}}{{M}_{NMR sample}} .$$

Q₄ is the mass of the respective structural unit estimated to be contained in the EtOH extract, relative to the mass of the emulsion.
Q₄ is calculated as follows:

$${Q}_{4} = \frac{{Q}_{3}}{{M}_{Emulsion}} .$$

Table 5 (FIGS. 23A, 23B) shows exemplary compositions (reactive compositions, surfactant compositions) employed in emulsion polymerization processes for binder materials (NT476-1-x, wherein x is 36, 37, 52, 53, 54, 61, 62, 63, 65, and 66) that were used in the proton NMR characterization. For the example polymers reported in Table 5, the surfactant composition comprised nonreactive surfactants but no reactive surfactants. In all example binders on Table 5 except NT476-1-65, anionic nonreactive surfactants and nonionic nonreactive surfactants were employed. However, for NT476-1-65, only an anionic nonreactive surfactant was used. Table 5 also shows binder emulsion properties (non-volatile content, viscosity, pH, and average particle size) and binder film properties (glass transition temperature (T_{g}), tensile strength (UTS), elongation at break (expressed as a percentage of the gauge length of the sample), Young's modulus (elastic modulus), and electrolyte (ELY) uptake (also referred to as a swell ratio) of the example binders. The details of measuring the binder emulsion properties and the binder film properties are as described with reference to Table 2. For cases in which nonionic surfactants were employed (all cases except for NT476-1-65), the HLB values of the respective nonionic surfactants are reported at row A. For each binder material, the mass of the supernatant extract (EtOH extract), relative to the mass of the mass of the emulsion, is reported at row B. For each binder material, row C reports the estimated mass of CH₂CH₂O— (PEG) units contained in the supernatant extract (EtOH extract), as quantified by the proton NMR measurements as outlined herein, relative to the mass of the emulsion (quantity Q₄). For each binder material, row D reports the estimated mass of the C₆H₅— (aromatic) units contained in the supernatant extract (EtOH extract), as quantified by the proton NMR measurements as described herein, relative to the mass of the emulsion (quantity Q₄). Row E reports the mass ratios of CH₂CH₂O— (PEG) units to C₆H₅— (aromatic) units, calculated by dividing each quantity in row C by a corresponding quantity in row D. For each binder material in Table 5, two slurries were prepared: (1) a slurry comprising the respective binder material and an anode active material comprising Si—C nanocomposite particles at 100 wt. % of the anode active material, and (2) a slurry comprising the respective binder material and an anode active material comprising a mixture of about 50 wt. % of Si—C nanocomposite particles and about 50 wt. % of graphite particles. Row F reports the results of a visual inspection of electrode coatings obtained using the 100 wt. % Si—C nanocomposite particle slurries. Row H reports the results of a visual inspection of electrode coatings obtained using the 50 wt. % Si—C nanocomposite particles, 50 wt. % graphite particles slurries. For rows F and H, a coating is reported to be “Poor” if the edges of the coated surface are discontinuous; otherwise, the coating is reported to be “Good”. Row G reports the viscosities (expressed as mPa s or centipoise) of 100 wt. % Si—C nanocomposite particles slurries measured at 10 rpm. Row I reports the viscosities (expressed as mPa s or centipoise) of 50 wt. % Si—C nanocomposite particles, 50 wt. % graphite particles slurries measured at 10 rpm. Row J reports an assessment of the coating quality for electrode coatings obtained using the 100 wt. % Si—C nanocomposite particle slurries. For row J, a coating a coating is reported to be “Poor” if the edges of the coated surface are discontinuous; otherwise, the coating that has no discontinuous edges is reported to be “Good” or “Excellent” (the “Excellent” label is used for slurries with relatively low viscosities (e.g., about 2000 cP or less).

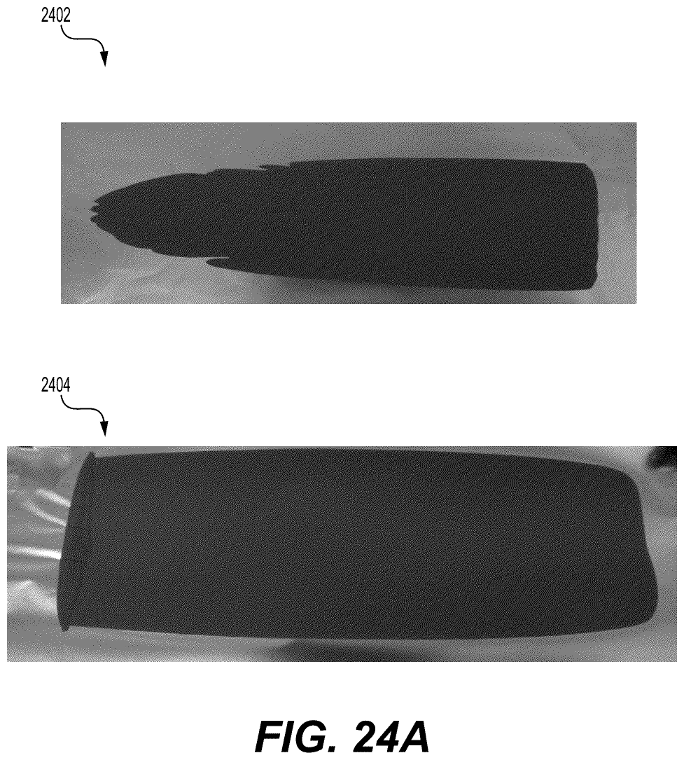

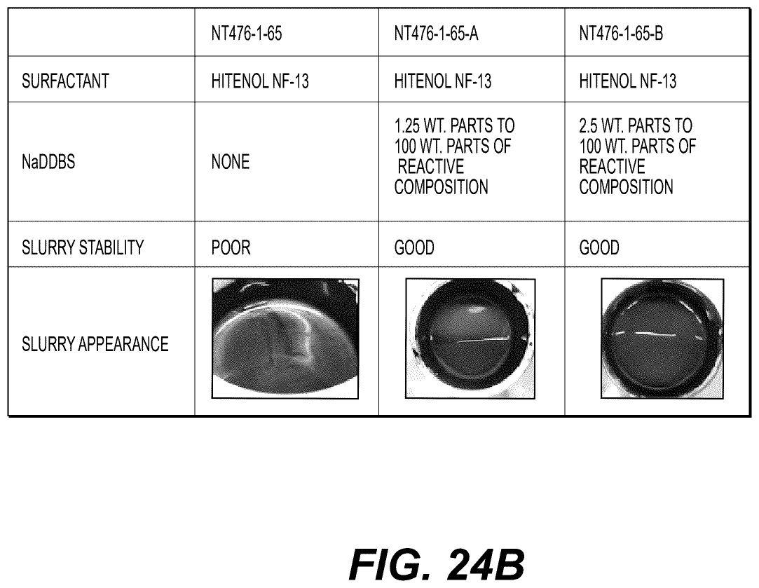

FIG. 24A shows images 2402, 2404 of anode coatings comprising respective binder materials. Image 2402 shows an electrode coating obtained using a 100 wt. % Si—C nanocomposite particle slurry comprising binder material NT476-1-61; the coating quality was determined to be “Poor”. Image 2404 shows an electrode coating obtained using a 100 wt. % Si—C nanocomposite particle slurry comprising binder material NT476-1-37; the coating quality was determined to be “Excellent”.

Electrode coatings (comprising 100 wt. % Si—C nanocomposite particles as the electrode active material) exhibited “Excellent” coating quality for binder material samples NT476-1-37, NT476-1-65, and NT476-1-66, corresponding to mass ratios of CH₂CH₂O—(PEG) units to C₆H₅— (aromatic) units of 2.7, 3.1, and 2.3. Electrode coatings (comprising 100 wt. % Si—C nanocomposite particles as the electrode active material) exhibited “Good” coating quality for binder material samples NT476-1-36, NT476-1-53, NT476-1-54, NT476-1-62, and NT476-1-63, corresponding to mass ratios of CH₂CH₂O— (PEG) units to C₆H₅— (aromatic) units of 4.5, 5.6, 4.2, 4.5, and 3.8. Electrode coatings (comprising 100 wt. % Si—C nanocomposite particles as the electrode active material) exhibited “Poor” coating quality for binder material samples NT476-1-52 and NT476-1-61, corresponding to mass ratios of CH₂CH₂O— (PEG) units to C₆H₅— (aromatic) units of 6.2 and 6.1. Accordingly, in some implementations, it may be preferable for the mass ratio of CH₂CH₂O— (PEG) units in a supernatant extract to C₆H₅— (aromatic) units in the supernatant extract to be about 6.0 or less, or about 5.0 or less, or about 4.0 or less, or about 3.5 or less, or about 3.0 or less. In some implementations, the mass ratios of CH₂CH₂O— (PEG) units in the supernatant extract to C₆H₅— (aromatic) units in the supernatant extract may also be about 0.1 or greater, or about 0.5 or greater, or about 1.0 or greater, or about 1.5 or greater, or about 2.0 or greater.

Electrode coatings (comprising 100 wt. % Si—C nanocomposite particles as the electrode active material) that exhibited “Excellent” coating quality were obtained from slurries with viscosities (measured at 10 rpm) of 990 cP (NT476-1-37), 1940 cP (NT476-1-65), and 1710 cP (NT476-1-66). Electrode coatings (comprising 100 wt. % Si—C nanocomposite particles as the electrode active material) that exhibited “Good” coating quality were obtained from slurries with viscosities (measured at 10 rpm) of 2070 cP (NT476-1-36), 2410 cP (NT476-1-53), 2370 cP (NT476-1-54), 2140 cP (NT476-1-62), and 2190 cP (NT476-1-63). Electrode coatings (comprising 100 wt. % Si—C nanocomposite particles as the electrode active material) that exhibited “Poor” coating quality were obtained from slurries with viscosities (measured at 10 rpm) of 2600 cP (NT476-1-52) and 2570 cP (NT476-1-61). Accordingly, in some implementations, it may be preferable for the viscosities (as measured at 10 rpm) of slurries comprising electrode active material and a binder material to be about 2600 cP or less, or about 2500 cP or less, or about 2400 cP or less, or about 2300 cP or less, or about 2200 cP or less, or about 2000 cP or less, or about 1800 cP or less, or about 1600 cP or less, or about 1400 cP or less, or about 1200 cP or less, or about 1000 cP or less. In some implementations, the viscosities (as measured at 10 rpm) may also be about 500 cP or greater, or about 800 cP or greater, or about 1000 cP or greater.

Electrode coatings (comprising 100 wt. % Si—C nanocomposite particles as the electrode active material) that exhibited “Excellent” coating quality were obtained from compositions comprising surfactants with HLB values of 9.2 (NT476-1-37) and 10.6 (NT476-1-66). Electrode coatings (comprising 100 wt. % Si—C nanocomposite particles as the electrode active material) that exhibited “Good” coating quality were obtained from compositions comprising surfactants with HLB values of 17.9 (NT476-1-36), 16.6 (NT476-1-53), 15.0 (NT476-1-54), 15.6 (NT476-1-62), and 14.8 (NT476-1-63). Electrode coatings (comprising 100 wt. % Si—C nanocomposite particles as the electrode active material) that exhibited “Poor” coating quality were obtained from compositions comprising surfactants with HLB values of 17.9 (NT476-1-52) and 17.5 (NT476-1-61). Accordingly, in some implementations, it may be preferable for the HLB values of surfactants (e.g., nonionic nonreactive surfactants) employed in the emulsion polymerization of a binder material to be about 18 or less, or about 17 or less, or about 16 or less, or about 15 or less, or about 14 or less, or about 13 or less, or about 12 or less, or about 11 or less, or about 10 or less, or about 9.5 or less. In some implementations, the HLB values of such surfactants may be at least about 8 or 9.

FIG. 24B compares the appearance of three slurries of Si—C composite particles and respective binder for anode formulations comprising Si—C composite particles at 50 wt. %: (1) the left photograph shows a slurry comprising NT476-1-65; (2) the middle photograph shows a slurry comprising NT476-1-65-A, a variant of NT-476-1-65 in which the surfactant composition comprises NaDDBS at 1.25 wt. parts to 100 wt. parts of the reactive composition; and (3)) the right photograph shows a slurry comprising NT476-1-65-B, a variant of NT-476-1-65 in which the surfactant composition comprises NaDDBS at 2.5 wt. parts to 100 wt. parts of the reactive composition. All three binders comprise HITENOL NF-13, an anionic nonreactive surfactant, at 1.5 wt. parts to 100 wt. parts of the reactive composition. The NT476-1-65 slurry sample (left) exhibits poor slurry stability, i.e., the color of the slurry is not uniform. The NT476-1-65-A and NT476-1-65-B slurry samples (middle and right) exhibit good slurry stability, i.e., the color of the slurry is uniform.

According to the synthesis method 200 shown in FIG. 2, emulsion polymerization of a reactive composition in the presence of a surfactant composition is carried out to form a binder material. The surfactant composition may comprise a nonreactive surfactant. Additionally, the inventors have unexpectedly found that it is also possible to obtain useful binder materials by mixing a binder polymer with one or more surfactants (e.g., a nonreactive surfactant), without employing the surfactants in an emulsion polymerization process. Such a nonreactive surfactant may be selected from any of the nonreactive surfactants described herein. Examples of nonreactive surfactants include the surfactants known by the tradename of NEWCOL® and sold by Nippon Nyukazai Co. Ltd. and surfactants known by the tradenames of HITENOL® and NOIGEN® and sold by DKS Co. Ltd. The one or more surfactants may comprise a reactive surfactant in addition to the nonreactive surfactant. Such a reactive surfactant may be selected from any of the reactive surfactants as described herein.

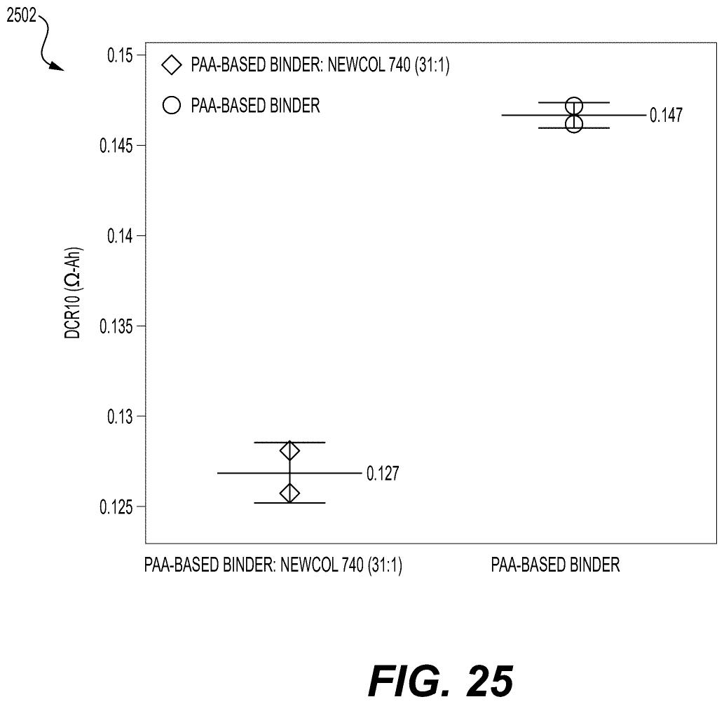

FIG. 25 shows a graphical plot 2502 comparing the internal direct-current resistance (DCR) of two types of battery test cells comprising the following respective binder compositions in the anode: (1) PAA-based binder (right side) and (2) mixture of PAA-based binder and an example nonreactive nonionic surfactant NEWCOL® 740 (left side). In both types of test cells the anode active material comprised Si—C nanocomposite particles at 100 wt. %. Except for the difference in the binder composition, the two types of cells had the same cell construction including the anode, cathode, and electrolyte. DCR was measured at an SOC of 50%. The DCR results for the test cells with the PAA-based binder are also reported in Table 3 (FIG. 12). The PAA-based binder is a commercially available binder material comprising a (co)polymer of acrylic acid or a salt thereof (e.g., Li salt, Na salt, K salt, Mg salt). The total binder content (mass fraction) in the anode coating was approximately the same in both types of test cells. In the test cells comprising the binder: nonreactive surfactant mixture, the mass ratio of the PAA-based binder to the nonreactive surfactant (in the example shown, NEWCOL® 740) was about 31:1. As shown in FIG. 25, there was a significant decrease in DCR by addition of the nonreactive surfactant to the binder material, from an average of about 0.147 Ω·Ah to about 0.127 Ω·Ah (in the example shown, a decrease of about 14%).

In the detailed description above, it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause is not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A binder material, comprising: a copolymer of styrene and (meth)acrylate; and one or more surfactants, wherein: a mass ratio of CH₂CH₂O— (PEG) units in a supernatant extract to C₆H₅— (aromatic) units in the supernatant extract is about 6.0 or less and about 0.1 or greater; the supernatant extract is obtained by filtering and drying a supernatant; the supernatant is obtained from a sample of an emulsion of the binder material by (a) adding sufficient ethanol to the sample to induce precipitation of at least a portion of the sample and (b) centrifugation of the sample after the precipitation; and the mass ratio is calculated from (1) an estimated mass of the PEG units in the supernatant extract as quantified by proton nuclear magnetic resonance (¹H NMR) measurements and (2) an estimated mass of the aromatic units in the supernatant extract as quantified by the 1H NMR measurements.

Clause 2. The binder material of clause 1, wherein: the mass ratio is about 5.0 or less and/or the mass ratio is about 0.5 or greater.

Clause 3. The binder material of any of clauses 1 to 2, wherein: the mass ratio is about 4.0 or less and/or the mass ratio is about 1.0 or greater.

Clause 4. The binder material of any of clauses 1 to 3, wherein: the mass ratio is about 3.5 or less and/or the mass ratio is about 2.0 or greater.

Clause 5. The binder material of any of clauses 1 to 4, wherein the styrene is present in the binder material, excluding the one or more surfactants, in a range of about 33 to about 75 wt. %.

Clause 6. The binder material of clause 5, wherein the styrene is present in the binder material, excluding the one or more surfactants, in a range of about 38 to about 42 wt. %.

Clause 7. The binder material of any of clauses 1 to 6, wherein: the copolymer further comprises monomeric units derived from one or more compounds comprising at least one of the following: (1) an epoxide group, (2) a hydroxyl group, and (3) an isocyanate group.

Clause 8. The binder material of any of clauses 1 to 7, wherein: the copolymer comprises monomeric units derived from one or more of an ethylenically unsaturated carboxylic acid, an ethylenically unsaturated carboxylic acid lithium salt, an ethylenically unsaturated carboxylic acid sodium salt, an ethylenically unsaturated carboxylic acid potassium salt, and an ethylenically unsaturated carboxylic acid ammonium salt.

Clause 9. The binder material of clause 8, wherein the one or more of the ethylenically unsaturated carboxylic acid, the ethylenically unsaturated carboxylic acid lithium salt, the ethylenically unsaturated carboxylic acid sodium salt, the ethylenically unsaturated carboxylic acid potassium salt, and the ethylenically unsaturated carboxylic acid ammonium salt comprise acrylic acid.

Clause 10. The binder material of any of clauses 1 to 9, wherein: a mass of the one or more surfactants is in a range of about 1.0 to about 6.0% of a total mass of the binder material, excluding the one or more surfactants.

Clause 11. The binder material of clause 10, wherein the mass of the one or more surfactants is in a range of about 1.0 to about 3.0% of the total mass of the binder material, excluding the one or more surfactants.

Clause 12. The binder material of any of clauses 1 to 11, wherein the one or more surfactants comprise at least one nonreactive surfactant.

Clause 13. The binder material of clause 12, wherein the at least one nonreactive surfactant comprises one or more anionic nonreactive surfactants and/or one or more nonionic nonreactive surfactants.

Clause 14. The binder material of clause 13, wherein the at least one nonreactive surfactant comprises the one or more nonionic nonreactive surfactants, or wherein hydrophilic-lipophilic balance (HLB) values of the one or more nonionic nonreactive surfactants are in a range of about 8 to about 18.

Clause 15. The binder material of any of clauses 1 to 14, wherein the one or more surfactants comprise at least one reactive surfactant.

Clause 16. A battery electrode, comprising: the binder material according to clause 1 and a battery electrode composition disposed on and/or in a current collector, wherein: the battery electrode composition comprises composite particles, each of the composite particles comprising carbon and silicon; and a mass fraction of the silicon in the composite particles is in a range of about 3 wt. % to about 80 wt. %.

Clause 17. The battery electrode of clause 16, wherein: the battery electrode comprises carboxymethyl cellulose (CMC); and a mass ratio of the CMC to the binder material is in a range of about 1:100 to about 2:1.

Clause 18. The battery electrode of clause 17, wherein: the battery electrode comprises carbon black and/or carbon nanotubes; and a mass ratio of the CMC to the carbon black and/or the carbon nanotubes is in a range of about 2:1 to about 1:10.

Clause 19. The battery electrode of any of clauses 16 to 18, wherein: the battery electrode composition comprises lower-capacity particles that are separate from the composite particles and exhibit a charge capacity of about 400 mAh/g or less.

Clause 20. The battery electrode of clause 19, wherein: the lower-capacity particles comprise graphite.

Clause 21. The battery electrode of clause 20, wherein: a mass ratio of the composite particles to the graphite is in a range of about 10:90 to about 99:1.

Clause 22. A lithium-ion battery, comprising: the battery electrode of Clause 16, configured as an anode; another battery electrode, configured as a cathode; and an electrolyte interposed between the anode and the cathode.

Clause 23. A method of making a binder material, the method comprising: emulsion polymerizing a reactive composition in the presence of a surfactant composition to form the binder material, wherein the reactive composition comprises: (a) styrene; a monofunctional (meth)acrylate with an average molecular weight of at most about 200, comprising no silicon, no epoxide group, no hydroxyl group, and no isocyanate group; and a macromolecule, comprising oxyethylene groups, and comprising one or more (meth)acrylate groups; wherein: the styrene and the monofunctional (meth)acrylate together are present in the reactive composition in a range of about 74 to about 98.9 wt. %; the styrene is present in the reactive composition in a range of about 33 to about 75 wt. %; an average molecular weight of the macromolecule is in a range of about 400 to about 1250; an average number of the oxyethylene groups in the macromolecule is in a range of about 6 to about 24; and the macromolecule is present in the reactive composition in a range of about 1.1 to about 2.0 wt. %.

Clause 24. The method of clause 23, wherein: the styrene and the monofunctional (meth)acrylate together are present in the reactive composition in a range of about 74 to about 91 wt. %.

Clause 25. The method of any of clauses 23 to 24, wherein the styrene is present in the reactive composition in a range of about 38 to about 42 wt. %.

Clause 26. The method of any of clauses 23 to 25, wherein the monofunctional (meth)acrylate comprises 2-ethylhexyl acrylate (2EH).

Clause 27. The method of any of clauses 23 to 26, wherein: the average molecular weight of the macromolecule is in a range of about 500 to about 1220; and/or the average number of the oxyethylene groups is in a range of about 8 to about 24.

Clause 28. The method of any of clauses 23 to 27, wherein the macromolecule comprises two of the (meth)acrylate groups.

Clause 29. The method of clause 28, wherein the macromolecule is a polyethylene glycol dimethacrylate (PEGDMA).

Clause 30. The method of any of clauses 23 to 29, wherein the macromolecule is present in the reactive composition in a range of about 1.2 to about 1.8 wt. %.

Clause 31. The method of any of clauses 23 to 30, wherein: the reactive composition comprises: (d) one or more multifunctional (meth)acrylates comprising at least one of the following: (1) an epoxide group, (2) a hydroxyl group, and (3) an isocyanate group, present in the reactive composition in a range of about 4 to about 21 wt. %; and the one or more multifunctional (meth)acrylates are of molecular weights of less than about 400.

Clause 32. The method of clause 31, wherein the one or more multifunctional (meth)acrylates are present in the reactive composition in a range of about 4 to about 13 wt. % b.

Clause 33. The method of any of clauses 31 to 32, wherein: the one or more multifunctional (meth)acrylates comprise a compound comprising the epoxide group; and the compound is glycidyl methacrylate (GMA).

Clause 34. The method of any of clauses 31 to 33, wherein: the one or more multifunctional (meth)acrylates comprise a compound comprising the hydroxyl group; and the compound is hydroxyethylmethacrylate (HEMA).

Clause 35. The method of any of clauses 31 to 34, wherein: the one or more multifunctional (meth)acrylates comprises a compound comprising the hydroxyl group, the compound being of Formula A:

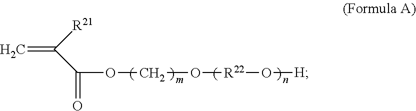

R²¹ is CH₃ or H;
R²² is (1) an alkylene group, (2) a cycloalkylene group, (3) a group of Formula B, or (4) a group of Formula C:

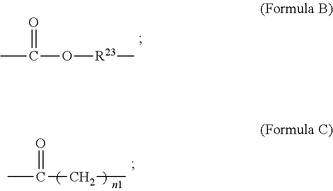

R²³ is an alkylene group having 1 to 10 carbon atoms; m is in a range of 1 to 4; n is in range of 1 to 3; and n1 is in a range of 1 to 10.

Clause 36. The method of clause 35, wherein: the R²² is the group of Formula B; and the R²³ is the alkylene group, represented by Formula D:

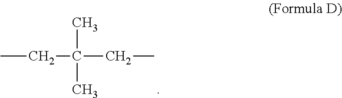

Clause 37. The method of clause 36, wherein: the R²¹ is the CH₃; m is 2; and n is 1.

Clause 38. The method of any of clauses 35 to 37, wherein: the R²¹ is the H; the R² is the group of Formula C; m is 2; n1 is 5; and an average molecular weight of the compound is about 344.

Clause 39. The method of any of clauses 23 to 38, wherein: the reactive composition further comprises: (e) one or more of an ethylenically unsaturated carboxylic acid, an ethylenically unsaturated carboxylic acid lithium salt, an ethylenically unsaturated carboxylic acid sodium salt, an ethylenically unsaturated carboxylic acid potassium salt, and an ethylenically unsaturated carboxylic acid ammonium salt, and wherein the one or more of the ethylenically unsaturated carboxylic acid, the ethylenically unsaturated carboxylic acid lithium salt, the ethylenically unsaturated carboxylic acid sodium salt, the ethylenically unsaturated carboxylic acid potassium salt, and the ethylenically unsaturated carboxylic acid ammonium salt are present in the reactive composition in a range of about 0.1 to about 4.9 wt. % b.

Clause 40. The method of clause 39, wherein the one or more of the ethylenically unsaturated carboxylic acid, the ethylenically unsaturated carboxylic acid lithium salt, the ethylenically unsaturated carboxylic acid sodium salt, the ethylenically unsaturated carboxylic acid potassium salt, and the ethylenically unsaturated carboxylic acid ammonium salt are present in the reactive composition in a range of about 3.0 wt. % to about 4.8 wt. %.

Clause 41. The method of any of clauses 39 to 40, wherein the one or more of the ethylenically unsaturated carboxylic acid, the ethylenically unsaturated carboxylic acid lithium salt, the ethylenically unsaturated carboxylic acid sodium salt, the ethylenically unsaturated carboxylic acid potassium salt, and the ethylenically unsaturated carboxylic acid ammonium salt comprise acrylic acid.

Clause 42. The method of any of clauses 23 to 41, wherein the reactive composition further comprises a compound comprising silicon.

Clause 43. The method of clause 42, wherein the compound is a silicon-substituted (meth)acrylate.

Clause 44. The method of clause 43, wherein the silicon-substituted (meth)acrylate is 3-(trimethoxysilyl)propyl methacrylate (TMSPMA).

Clause 45. The method of any of clauses 43 to 44, wherein the silicon-substituted (meth)acrylate is present in the reactive composition in a range of about 0.1 to about 0.5 wt. % b.

Clause 46. The method of any of clauses 23 to 45, wherein a mass of the surfactant composition is in a range of about 1.0 to about 6.0% of a total mass of the reactive composition.

Clause 47. The method of clause 46, wherein the mass of the surfactant composition is in a range of about 1.0 to about 3.0% of the total mass of the reactive composition.

Clause 48. The method of any of clauses 23 to 47, wherein the surfactant composition comprises at least one nonreactive surfactant.

Clause 49. The method of clause 48, wherein the at least one nonreactive surfactant comprises one or more anionic nonreactive surfactants and/or one or more nonionic nonreactive surfactants.

Clause 50. The method of clause 49, wherein hydrophilic-lipophilic balance (HLB) values of the one or more nonionic nonreactive surfactants are in a range of about 8 to about 18.

Clause 51. The method of any of clauses 48 to 50, wherein: the at least one nonreactive surfactant comprises a compound of Formula 1:

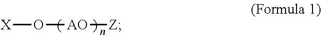

X comprises two or more aryl groups that are linked through at least one carbon or are fused; AO is a C₂-C₅ alkyleneoxy group; Z is SO₃M or H; and M is H, an alkali metal, an alkaline earth metal, ammonium, or an alkyl-substituted ammonium; and n represents an average number of the alkyleneoxy groups, n being in a range of about 3 to about 120.

Clause 52. The method of clause 51, wherein: the X is selected from Formulas 2, 3, 4, and 5:

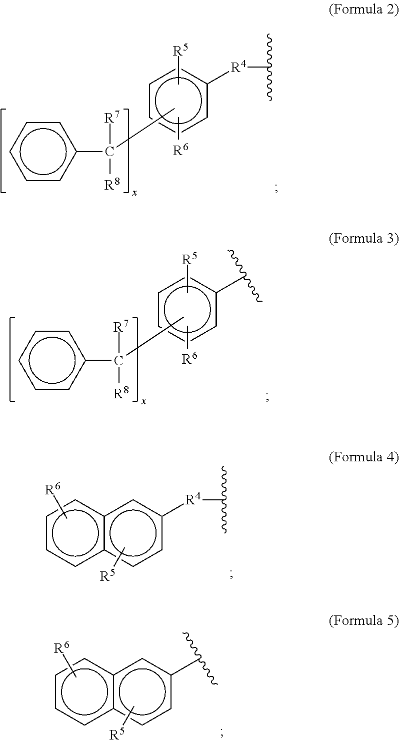

R⁴ is a linear hydrocarbon group of 1 to 3 carbon atoms; each of R⁷ and R⁸ is, independently, H or a linear hydrocarbon group of 1 to 3 carbon atoms; x is 1, 2, or 3; each of R⁵ and R⁶ is, independently, H, a linear hydrocarbon group of 1 to 3 carbon atoms, or a group represented by Formula 6:

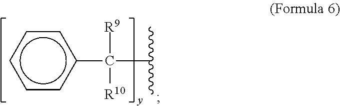

each of R⁹ and R¹⁰ is, independently, H or a linear hydrocarbon group of 1 to 3 carbon atoms; and y is 1, 2, or 3.

Clause 53. The method of any of clauses 51 to 52, wherein: the X is selected from Formulas 7 and 8:

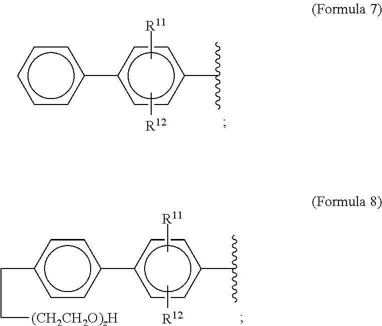

each of R¹¹ and R¹² is, independently, H or a linear hydrocarbon group of 1 to 3 carbon atoms; and z is an integer greater than or equal to 2.

Clause 54. The method of any of clauses 51 to 53, wherein: the X is selected from a styrenated phenyl group, a styrenated methylphenyl group, a distyrenated phenyl group, a distyrenated methylphenyl group, and a tristyrenated phenyl group.

Clause 55. The method of any of clauses 23 to 54, wherein the surfactant composition comprises at least one reactive surfactant.

Clause 56. The method of clause 55, wherein: the at least one reactive surfactant is a compound of Formula 9:

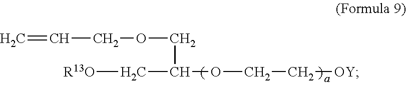

R¹³ is an alkyl group; Y is H or SO₃NH₄; and a is in a range of 10 to 40.

Clause 57. The method of any of clauses 55 to 56, wherein the at least one reactive surfactant comprises one or more of sodium p-styrene sulfonate (NaSS), lithium p-styrene sulfonate (LiSS), sodium dodecylbenzenesulfonate (NaDDBS), and sodium dodecyl sulfate (SDS).

Clause 58. The binder material made according to the method of any of clauses 23 to 57.

Clause 59. The binder material of clause 58, wherein: a mass ratio of CH₂CH₂O—-(PEG) units in a supernatant extract to C6H5- (aromatic) units in the supernatant extract is about 6.0 or less and about 0.1 or greater; the supernatant extract is obtained by filtering and drying a supernatant; the supernatant is obtained from a sample of an emulsion of the binder material by (a) adding sufficient ethanol to the sample to induce precipitation of at least a portion of the sample and (b) centrifugation of the sample after the precipitation; and the mass ratio is calculated from (1) an estimated mass of the PEG units in the supernatant extract as quantified by proton nuclear magnetic resonance (¹H NMR) measurements and (2) an estimated mass of the aromatic units in the supernatant extract as quantified by the ¹H NMR measurements.

Clause 60. The binder material of clause 59, wherein: the mass ratio is about 5.0 or less and/or the mass ratio is about 0.5 or greater.

Clause 61. The binder material of any of clauses 59 to 60, wherein: the mass ratio is about 4.0 or less and/or the mass ratio is about 1.0 or greater.

Clause 62. The binder material of any of clauses 59 to 61, wherein: the mass ratio is about 3.5 or less and/or the mass ratio is about 2.0 or greater.

Clause 63. A method of making a battery electrode, the method comprising: making the binder material according to the method of clause 23; mixing the binder material with slurry components to form a slurry, wherein the slurry components comprise a battery electrode composition and a solvent composition; and casting the slurry on and/or in a current collector to make the battery electrode, wherein: the battery electrode composition comprises composite particles, each of the composite particles comprising carbon and silicon; and a mass fraction of the silicon in the composite particles is in a range of about 3 wt. % to about 80 wt. % b.

Clause 64. The method of clause 63, wherein: the solvent composition comprises water.

Clause 65. The method of any of clauses 63 to 64, wherein: the slurry components further comprise a carboxymethyl cellulose (CMC) additive; and a mass ratio of the CMC additive to the binder material is in a range of about 1:100 to about 2:1.

Clause 66. The method of any of clauses 63 to 65, wherein: the battery electrode composition comprises lower-capacity particles with a charge capacity of about 400 mAh/g or less.

Clause 67. The method of clause 66, wherein: the lower-capacity particles comprise graphite.

Clause 68. The method of clause 67, wherein: a mass ratio of the composite particles to the graphite is in a range of about 10:90 to about 99:1.

Clause 69. The method of any of clauses 63 to 68, wherein: the slurry components comprise a conductive additive composition.

Clause 70. The method of clause 69, wherein: the conductive additive composition comprises carbon black and/or carbon nanotubes.

Clause 71. The method of clause 70, wherein: the conductive additive composition further comprises a carboxymethyl cellulose (CMC) additive.

Clause 72. The method of clause 71, wherein: a mass ratio of the CMC additive to the carbon black and/or carbon nanotubes is in a range of about 2:1 to about 1:10.

Clause 73. A battery electrode made according to the method of any of clauses 63 to 72.

Clause 74. A method of making a lithium-ion battery, the method comprising: making the battery electrode according to the method of clause 63; assembling a battery cell from at least the battery electrode and another battery electrode, wherein the battery electrode is configured as an anode and the another battery electrode is configured as a cathode; and interposing an electrolyte between the anode and the cathode to make the lithium-ion battery.

Clause 75. A lithium-ion battery made according to the method of clause 74.

This description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. A binder material, comprising:
a copolymer of styrene and (meth)acrylate; and
one or more surfactants,
wherein:
a mass ratio of CH₂CH₂O— (PEG) units in a supernatant extract to C₆H₅— (aromatic) units in the supernatant extract is about 6.0 or less and about 0.1 or greater;
the supernatant extract is obtained by filtering and drying a supernatant;
the supernatant is obtained from a sample of an emulsion of the binder material by (a) adding sufficient ethanol to the sample to induce precipitation of at least a portion of the sample and (b) centrifugation of the sample after the precipitation; and
the mass ratio is calculated from (1) an estimated mass of the PEG units in the supernatant extract as quantified by proton nuclear magnetic resonance (¹H NMR) measurements and (2) an estimated mass of the aromatic units in the supernatant extract as quantified by the ¹H NMR measurements.

2. The binder material of claim 1, wherein:
the mass ratio is about 5.0 or less and/or the mass ratio is about 0.5 or greater.

3. The binder material of claim 1, wherein:
the mass ratio is about 4.0 or less and/or the mass ratio is about 1.0 or greater.

4. The binder material of claim 1, wherein:
the mass ratio is about 3.5 or less and/or the mass ratio is about 2.0 or greater.

5. The binder material of claim 1, wherein the styrene is present in the binder material, excluding the one or more surfactants, in a range of about 33 to about 75 wt. %.

6. The binder material of claim 5, wherein the styrene is present in the binder material, excluding the one or more surfactants, in a range of about 38 to about 42 wt. %.

7. The binder material of claim 1, wherein:
the copolymer further comprises monomeric units derived from one or more compounds comprising at least one of the following: (1) an epoxide group, (2) a hydroxyl group, and (3) an isocyanate group.

8. The binder material of claim 1, wherein:
the copolymer comprises monomeric units derived from one or more of an ethylenically unsaturated carboxylic acid, an ethylenically unsaturated carboxylic acid lithium salt, an ethylenically unsaturated carboxylic acid sodium salt, an ethylenically unsaturated carboxylic acid potassium salt, and an ethylenically unsaturated carboxylic acid ammonium salt.

9. The binder material of claim 8, wherein the one or more of the ethylenically unsaturated carboxylic acid, the ethylenically unsaturated carboxylic acid lithium salt, the ethylenically unsaturated carboxylic acid sodium salt, the ethylenically unsaturated carboxylic acid potassium salt, and the ethylenically unsaturated carboxylic acid ammonium salt comprise acrylic acid.

10. The binder material of claim 1, wherein:
a mass of the one or more surfactants is in a range of about 1.0 to about 6.0% of a total mass of the binder material, excluding the one or more surfactants.

11. The binder material of claim 10, wherein the mass of the one or more surfactants is in a range of about 1.0 to about 3.0% of the total mass of the binder material, excluding the one or more surfactants.

12. The binder material of claim 1, wherein the one or more surfactants comprise at least one nonreactive surfactant.

13. The binder material of claim 12, wherein the at least one nonreactive surfactant comprises one or more anionic nonreactive surfactants and/or one or more nonionic nonreactive surfactants.

14. The binder material of claim 13,
wherein the at least one nonreactive surfactant comprises the one or more nonionic nonreactive surfactants, or
wherein hydrophilic-lipophilic balance (HLB) values of the one or more nonionic nonreactive surfactants are in a range of about 8 to about 18.

15. The binder material of claim 1, wherein the one or more surfactants comprise at least one reactive surfactant.

16. A battery electrode, comprising:
the binder material according to claim 1 and a battery electrode composition disposed on and/or in a current collector,
wherein:
the battery electrode composition comprises composite particles, each of the composite particles comprising carbon and silicon; and
a mass fraction of the silicon in the composite particles is in a range of about 3 wt. % to about 80 wt. %.

17. The battery electrode of claim 16, wherein:
the battery electrode comprises carboxymethyl cellulose (CMC); and
a mass ratio of the CMC to the binder material is in a range of about 1:100 to about 2:1.

18. The battery electrode of claim 17, wherein:
the battery electrode comprises carbon black and/or carbon nanotubes; and
a mass ratio of the CMC to the carbon black and/or the carbon nanotubes is in a range of about 2:1 to about 1:10.

19. The battery electrode of claim 16, wherein:
the battery electrode composition comprises lower-capacity particles that are separate from the composite particles and exhibit a charge capacity of about 400 mAh/g or less.

20. The battery electrode of claim 19, wherein:
the lower-capacity particles comprise graphite.

21. The battery electrode of claim 20, wherein:
a mass ratio of the composite particles to the graphite is in a range of about 10:90 to about 99:1.

22. A lithium-ion battery, comprising:
the battery electrode of claim 16, configured as an anode;
another battery electrode, configured as a cathode; and
an electrolyte interposed between the anode and the cathode.

23. A method of making a binder material, the method comprising:
emulsion polymerizing a reactive composition in the presence of a surfactant composition to form the binder material, wherein the reactive composition comprises:
(a) styrene;
(b) a monofunctional (meth)acrylate with an average molecular weight of at most about 200, comprising no silicon, no epoxide group, no hydroxyl group, and no isocyanate group; and
(c) a macromolecule, comprising oxyethylene groups, and comprising one or more (meth)acrylate groups;
wherein:
the styrene and the monofunctional (meth)acrylate together are present in the reactive composition in a range of about 74 to about 98.9 wt. %;
the styrene is present in the reactive composition in a range of about 33 to about 75 wt. %;
an average molecular weight of the macromolecule is in a range of about 400 to about 1250;
an average number of the oxyethylene groups in the macromolecule is in a range of about 6 to about 24; and
the macromolecule is present in the reactive composition in a range of about 1.1 to about 2.0 wt. %.

24.-75. (canceled)
